(19) United States
(12) Patent Application Publication
(10) Pub. No.: US 2024/0207764 A1
(43) Pub. Date: Jun. 27, 2024

(54) HIGH PERFORMANCE FILTER MEDIA

(71) Applicant: Hollingsworth & Vose Company, East Walpole, MA (US)

(72) Inventors: Siqiang Zhu, Riner, VA (US); Yu Liu, Blacksburg, VA (US); Syed Gulrez, Lancaster (GB); Gregory Wagner Farell, Radford, VA (US); Brian Swortzel, Floyd, VA (US); David T. Healey, Bellingham, MA (US)

(73) Assignee: Hollingsworth & Vose Company, East Walpole, MA (US)

(21) Appl. No.: 18/087,710

(22) Filed: Dec. 22, 2022

(51) Int. Cl. B01D 39/16; B01D 46/00; B32B 5/02; B32B 5/26; D04H 3/007; D04H 3/03; D04H 3/16

(52) U.S. Cl. CPC B01D 39/1623; B01D 46/0032; B32B 5/022; B32B 5/268; D04H 3/007; D04H 3/03; D04H 3/16; B01D 2239/025; B01D 2239/0435; B01D 2239/0618; B01D 2239/0622; B01D 2239/0654; B01D 2239/1216; B01D 2239/1233; B01D 2239/1258; B01D 2239/1266; B01D 2239/1275; B01D 2239/1291; B01D 2275/10; B32B 2250/02; B32B 2250/20; B32B 2262/0253; B32B 2262/16; B32B 2307/20; B32B 2307/546; B32B 2307/718; B32B 2307/724; B32B 2307/732; D10B 2321/022; D10B 2401/062; D10B 2505/04

(57) ABSTRACT

Filter media comprising non-woven fiber webs having high performance are generally described. For instance, in some embodiments, a non-woven fiber web described herein has a relatively high value of gamma and/or a relatively high ratio of dust holding capacity to basis weight. As another example, in some embodiments, a non-woven fiber web described herein is capable of being loaded with dust relatively uniformly throughout its depth. This latter property may assist with increasing the gamma and/or the ratio of dust holding capacity to basis weight.

### FIELD

The present invention relates generally to filter media, and, more particularly, to filter media comprising polypropylene fibers, having a high gamma, having a high dust holding capacity, and/or configured to capture dust throughout the thickness of one or more of the layers therein.

### BACKGROUND

Filter media may be employed in a variety of applications. For instance, filter media may be employed to remove contaminants from fluids. Some filter media may exhibit undesirable properties such as low dust holding capacities and/or low values of gamma.

Accordingly, improved filter media designs are needed.

### SUMMARY

Filter media, related components, and related methods are generally described.

In some embodiments, a filter media is provided. The filter media comprises a non-woven fiber web comprising fibers. Polypropylene makes up at least 75 wt % of the polymers in the non-woven fiber web. The fibers in the non-woven fiber web have an average diameter of less than or equal to 15 microns. The non-woven fiber web has a gamma of greater than or equal to 200. A ratio of the dust holding capacity of the filter media to a basis weight of the filter media is greater than or equal to 1 gsm/gsm. The non-woven fiber web has a thickness of greater than 6 mils.

In some embodiments, the filter media comprises a non-woven fiber web comprising fibers. Polypropylene makes up at least 75 wt % of the polymers in the non-woven fiber web. The fibers in the non-woven fiber web have an average diameter of less than or equal to 15 microns. The non-woven fiber web has a gamma of greater than or equal to 200. The non-woven fiber web is configured such that, after undergoing a NaCl loading process, a density of NaCl at a downstream surface of the non-woven fiber web is greater than or equal to 50% of a density of NaCl at an upstream surface of the non-woven fiber web.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows one non-limiting example of a non-woven fiber web, in accordance with some embodiments;

FIG. 2 shows one non-limiting example of a filter media comprising a non-woven fiber web and a further layer, in accordance with some embodiments;

FIG. 3 shows one non-limiting example of a layer comprising adsorptive species, in accordance with some embodiments;

FIG. 4A shows a non-limiting example of a waved configuration of a filter media, in accordance with some embodiments;

FIG. 4B shows a filter media including a cover layer, in accordance with some embodiments;

FIG. 5 shows a non-limiting example of a waved configuration of a filter media, in accordance with some embodiments;

FIG. 6 shows a non-limiting example of a filter media comprising an irregular structure, in accordance with some embodiments;

FIG. 7 shows one example of a relative surface topography, in accordance with some embodiments;

FIGS. 8A-8B show examples of sets of line data, in accordance with some embodiments;

FIGS. 9A-9B show one example of a filter media comprising a first layer that is topologically connected throughout the layer and a second layer that comprises portions that are topologically disconnected from each other, in accordance with some embodiments;

FIG. 10 shows one example of a plurality of elastically extensible fibers that form a layer, in accordance with some embodiments;

FIG. 11A shows one example of a filter media comprising a layer comprising a plurality of peaks, in accordance with some embodiments;

FIG. 11B shows one non-limiting embodiment of a filter media comprising two layers that each comprise pluralities of peaks, in accordance with some embodiments;

FIGS. 12A-12C show one method of manufacturing filter media, in accordance with some embodiments;

FIGS. 12D-12F show a schematic depiction of a process of manufacturing filter media, in accordance with some embodiments;

FIGS. 13-16 are SEM images of non-woven fiber webs, in accordance with some embodiments; and

FIG. 17 is a chart showing NaCl density as a function of thickness for two non-woven fiber webs, in accordance with some embodiments.

### DETAILED DESCRIPTION

Filter media comprising non-woven fiber webs having high performance are generally described. For instance, in some embodiments, a non-woven fiber web described herein has a relatively high value of gamma and/or a relatively high ratio of dust holding capacity to basis weight. As another example, in some embodiments, a non-woven fiber web described herein is capable of being loaded with dust relatively uniformly throughout its depth. This latter property may assist with increasing the gamma and/or the ratio of dust holding capacity to basis weight.

In some embodiments, a non-woven fiber web having high performance includes a relatively high amount of polypropylene. Polypropylene may advantageously be meltblown to form fibers that are capable of being charged. Upon charging, non-woven fiber webs comprising polypropylene may display enhanced performance in one or more ways in comparison to uncharged non-woven fiber webs, such as reduced penetration and/or enhanced trapping of charged species. In some embodiments, the polypropylene present in the non-woven fiber web may have one or more features that enhance performance. As one example, the polypropylene present in the non-woven fiber web may have a melt flow rate that is particularly beneficial. The melt flow rate of the polypropylene may be relatively similar to that of other components in the non-woven fiber web (e.g., any additives), which may enhance mixing therewith. In some embodiments, the melt flow rate of the polypropylene may facilitate the formation of fibers having a favorable average fiber diameter, such as an average fiber diameter that is large enough to hold a desirable amount of static charge and/or support a relatively high compaction resistance. The latter property may be desirable for non-woven fiber webs that are provided in rolls that apply a force that could cause compaction.

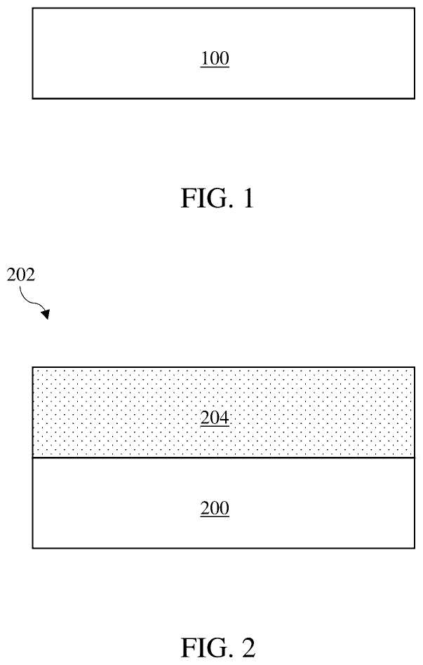

FIG. 1 shows one non-limiting example of a non-woven fiber web having high performance, such as a non-woven fiber web having one or more of the features described herein. FIG. 1 depicts a non-woven fiber web 100 having high performance.

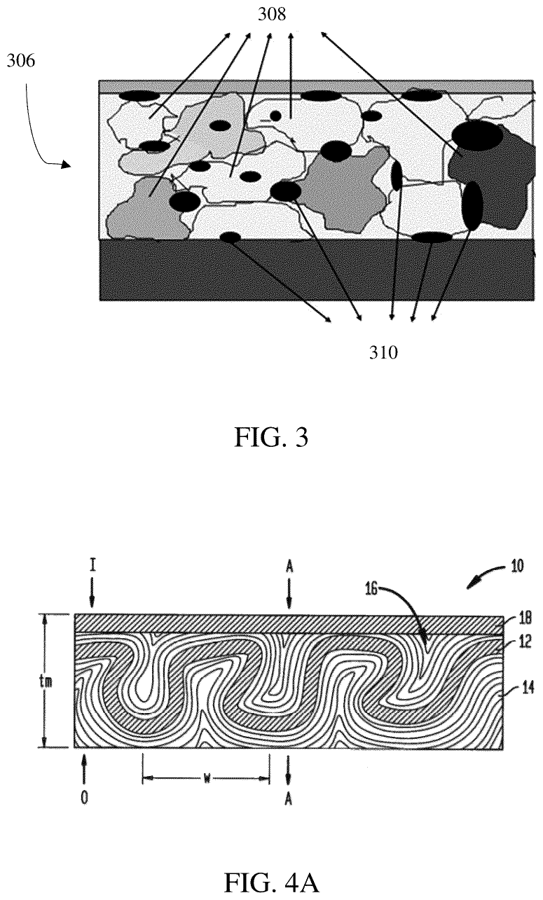

In some embodiments, a non-woven fiber web having high performance is provided as one component of a filter media. The filter media may further include other components, such as further layers (some or all of which may be other non-woven fiber webs). In such embodiments, the non-woven fiber web having high performance may be an external layer (e.g., an upstream-most layer, a downstream-most layer) or an internal layer (e.g., positioned between at least one upstream layer and one downstream layer). For instance, FIG. 2 shows one non-limiting example of a filter media 202 comprising a non-woven fiber web 200 and a layer 204. The total number of layers provided may vary (e.g., a filter media may comprise two or more, three or more, four or more, five or more, or even more layers), and some or all of the layers may be of the same type (e.g., a filter media may comprise two or more non-woven fiber webs having high performance and/or two or more other layers of the same type).

Non-limiting examples of exemplary combinations of layers include the following: adsorptive layer/charged layer comprising non-continuous fibers/non-woven fiber web having high performance/non-woven fiber web comprising nanofibers/spunbond layer; charged layer comprising non-continuous fibers/non-woven fiber web having high performance/non-woven fiber web comprising nanofibers/spunbond layer/adsorptive layer; adsorptive layer/non-woven fiber web having high performance/non-woven fiber web comprising nanofibers/spunbond layer; non-woven fiber web having high performance/non-woven fiber web comprising nanofibers/spunbond layer/adsorptive layer; non-woven fiber web having high performance/non-woven fiber web having high performance with different average fiber diameter/backer; non-woven fiber web having high performance/backer; adsorptive layer/non-woven fiber web having high performance; non-woven fiber web having high performance/spunbond layer; non-woven fiber web having high performance/mesh; non-woven fiber web having high performance/non-woven fiber web comprising nanofibers/spunbond layer/backer; and non-woven fiber web having high performance/non-woven fiber web comprising nanofibers/carded layer/spunbond layer/mesh.

It is also possible for a non-woven fiber web described herein to be provided alone or as the sole layer in a filter media.

Further detail about the various layers that may be included in filter media are provided in further detail below.

As described above, in some embodiments, a non-woven fiber web having high performance is provided. Such a non-woven fiber web may be a main filter or may be employed as a prefilter for a main filter. It is also possible for a filter media to comprise two or more non-woven fiber webs having high performance. Such non-woven fiber webs may be the same or may differ in one or more ways.

Non-woven fiber webs having high performance may have a variety of different designs. In some embodiments, a filter media comprises a non-woven fiber web having high performance that is a meltblown layer. Such meltblown layers may have a variety of fiber designs. For instance, a non-woven fiber web having high performance may comprise split meltblown fibers (e.g., as fabricated with the assistance of a high-pressure water jet) and/or multicomponent 5 meltblown fibers (e.g., bicomponent meltblown fibers, multicomponent meltblown fibers formed by extrusion). It is also possible for a non-woven fiber web having high performance to comprise cylindrical fibers, irregularly shaped fibers, fibers having elliptical cross-sections, fibers having dog bone-shaped cross-sections, ribbon-like fibers, and/or multilobal fibers (e.g., dilobal, trilobal, quadralobal, and/or pentalobal fibers).

Non-woven fiber webs having high performance may have a relatively high polypropylene content. In some embodiments, polypropylene makes up greater than or equal to 75 wt %, greater than or equal to 77.5 wt %, greater than or equal to 80 wt %, greater than or equal to 82.5 wt %, greater than or equal to 85 wt %, greater than or equal to 87.5 wt %, greater than or equal to 90 wt %, greater than or equal to 92.5 wt %, greater than or equal to 95 wt %, greater than or equal to 97.5 wt %, greater than or equal to 99 wt %, greater than or equal to 99.25 wt %, greater than or equal to 99.5 wt %, or greater than or equal to 99.75 wt % of all of the polymers in the non-woven fiber web (including those present in fibers, any additives present, and any other components present). In some embodiments, polypropylene makes up less than or equal to 99.9 wt %, less than or equal to 99.75 wt %, less than or equal to 99.5 wt %, less than or equal to 99.25 wt %, less than or equal to 99 wt %, less than or equal to 97.5 wt %, less than or equal to 95 wt %, less than or equal to 92.5 wt %, less than or equal to 90 wt %, less than or equal to 87.5 wt %, less than or equal to 85 wt %, less than or equal to 82.5 wt %, less than or equal to 80 wt %, or less than or equal to 77.5 wt % of all of the polymers in the non-woven fiber web. Combinations of the above-referenced ranges are also possible (e.g., greater than or equal to 75 wt % and less than or equal to 99.9 wt %, greater than or equal to 80 wt % and less than or equal to 99.5 wt %, or greater than or equal to 85 wt % and less than or equal to 99 wt %). Other ranges are also possible.

When a non-woven fiber web having high performance includes two or more types of polypropylene, each type of polypropylene may independently be present in one or more of the ranges described above and/or all of the polypropylene in the non-woven fiber web having high performance may together be present in one or more of the ranges described above. When a filter media comprises two or more non-woven fiber webs having high performance, the preceding may be true for each such non-woven fiber web independently.

A variety of suitable types of polypropylene may be employed in the fibers present in a non-woven web having high performance, including polypropylene resins supplied by ExxonMobil (e.g., those having a melt flow rate of 500, 925, or 1550), LyondellBasel (e.g., those having a melt flow rate of 450, 500, 800, 1100, 1200, 1500, or 1800), Total Energies (e.g., those having a melt flow rate of 100 or 1300), and/or Borealis (e.g., those having a melt flow rate of 450, 800, 1200, or 2000).

The polypropylene included in a non-woven fiber web having high performance may have a melt flow rate that is within a range that enhances performance. For instance, in some embodiments, the polypropylene included in such a non-woven fiber web has a melt flow rate of greater than or equal to 10, greater than or equal to 20, greater than or equal to 30, greater than or equal to 40, greater than or equal to 50, greater than or equal to 75, greater than or equal to 100, greater than or equal to 150, greater than or equal to 200, greater than or equal to 300, greater than or equal to 500, greater than or equal to 600, greater than or equal to 800, greater than or equal to 1000, greater than or equal to 1200, greater than or equal to 1400, greater than or equal to 1600, greater than or equal to 1800, or greater than or equal to 2000. In some embodiments, the polypropylene present in a non-woven fiber web having high performance has a melt flow rate of less than or equal to 2200, less than or equal to 2000, less than or equal to 1800, less than or equal to 1600, less than or equal to 1400, less than or equal to 1200, less than or equal to 1000, less than or equal to 800, less than or equal to 600, less than or equal to 500, less than or equal to 300, less than or equal to 200, less than or equal to 150, less than or equal to 100, less than or equal to 75, less than or equal to 50, less than or equal to 40, less than or equal to 30, or less than or equal to 20. Combinations of the above-referenced ranges are also possible (e.g., greater than or equal to 10 and less than or equal to 2200, greater than or equal to 10 and less than or equal to 2000, greater than or equal to 30 and less than or equal to 1600, or greater than or equal to 100 and less than or equal to 1200). Other ranges are also possible.

The melt flow rate of polypropylene may be determined by ASTM D1238-20, during which a load of 2.16 kg is applied to a die held at a temperature of 230° C. The flow of the polypropylene may be measured under these conditions over a period of 10 minutes.

When a non-woven fiber web having high performance includes two or more types of polypropylene, each type of polypropylene may independently have a melt flow rate in one or more of the ranges described above and/or all of the polypropylene in the non-woven fiber web having high performance may together have a melt flow rate in one or more of the ranges described above. When a filter media comprises two or more non-woven fiber webs having high performance, the preceding may be true for each such non-woven fiber web independently.

In some embodiments, a non-woven fiber web having high performance comprises one or more polymers other than polypropylene (e.g., that are also present in fibers comprising polypropylene, that are present in other fibers). As one example, in some embodiments, a non-woven fiber web having high performance further comprises another type of polyolefin (e.g., polyethylene, polymethylpentene, polybutylene, olefin copolymers).

In some embodiments, a non-woven fiber web having high performance comprises an additive, such as a charge-stabilizing additive. In some embodiments, charge-stabilizing additives make up greater than or equal to 0.1 wt %, greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.8 wt %, greater than or equal to 1 wt %, greater than or equal to 1.25 wt %, greater than or equal to 1.5 wt %, greater than or equal to 1.75 wt %, greater than or equal to 2 wt %, greater than or equal to 2.5 wt %, greater than or equal to 3 wt %, or greater than or equal to 3.5 wt % of the non-woven fiber web having high performance. In some embodiments, charge-stabilizing additives make up less than or equal to 4 wt %, less than or equal to 3.5 wt %, less than or equal to 3 wt %, less than or equal to 2.5 wt %, less than or equal to 2 wt %, less than or equal to 1.75 wt %, less than or equal to 1.5 wt %, less than or equal to 1.25 wt %, less than or equal to 1 wt %, less than or equal to 0.8 wt %, less than or equal to 0.6 wt %, less than or equal to 0.5 wt %, less than or equal to 0.4 wt %, less than or equal to 0.3 wt %, or less than or equal to 0.2 wt % of the non-woven fiber web having high performance. Combinations of the above-referenced ranges are also possible (e.g., greater than or equal to 0.1 wt % and less than or equal to 4 wt %, greater than or equal to 0.1 wt % and less than or equal to 3 wt %, greater than or equal to 0.2 wt % and less than or equal to 4 wt %, greater than or equal to 0.5 wt % and less than or equal to 3 wt %, or greater than or equal to 0.8 wt % and less than or equal to 2 wt). Other ranges are also possible.

When a non-woven fiber web having high performance includes two or more types of charge-stabilizing additives, each type of charge-stabilizing additive may independently be present in one or more of the ranges described above and/or all of the charge-stabilizing additives in the non-woven fiber web having high performance together may be present in one or more of the ranges described above. When a non-woven fiber web includes one or more components (e.g., one or more resins) comprising a charge-stabilizing additive, each such component may individually be present in one or more of the ranges described above and/or all such components together may be present in one or more of the ranges described above. When a filter media comprises two or more non-woven fiber webs having high performance, the preceding may be true for each such non-woven fiber web independently.

One example of a suitable class of charge-stabilizing additives is hindered amine light stabilizers. Without wishing to be bound by any particular theory, it is believed that hindered amine light stabilizers are capable accepting and stabilizing charged species (e.g., a positively charged species, such as a proton from water; a negatively charged species) thereon. One example of a suitable hindered amine light stabilizer is CHIMASSORB 944 FL. Further non-limiting examples of suitable charge-stabilizing additives include fused aromatic thioureas, organic triazines, UV stabilizers, phosphites, additives comprising two or more amide groups (e.g., bisamides, trisamides), stearates (e.g., magnesium stearate, calcium stearate), and stearamides (e.g., ethylene bis-stearamide). Charge-stabilizing additives may be incorporated into fibers present in the non-woven fiber web having high performance and/or may be incorporated into such a non-woven fiber web in another manner (e.g., as particles, as a coating on the fibers). One example of a manner in which charge-stabilizing additives may be incorporated into fibers is by forming a continuous fiber from a composition comprising the charge-stabilizing additive (e.g., by meltblowing such a composition).

In some embodiments, a charge-stabilizing additive is supplied as a component of a resin present in a non-woven fiber web having high performance. In such embodiments, the resin may have a melt flow rate that is relatively close to the melt flow rate of polypropylene also present in the non-woven fiber web having high performance. The melt flow rate of the charge-stabilizing additive may be greater than or equal to 10, greater than or equal to 20, greater than or equal to 30, greater than or equal to 40, greater than or equal to 50, greater than or equal to 75, greater than or equal to 100, greater than or equal to 150, greater than or equal to 200, greater than or equal to 300, greater than or equal to 500, greater than or equal to 600, greater than or equal to 800, greater than or equal to 1000, greater than or equal to 1200, greater than or equal to 1400, greater than or equal to 1600, or greater than or equal to 1800. In some embodiments, the charge-stabilizing additive has a melt flow rate of less than or equal to 2000, less than or equal to 1800, less than or equal to 1600, less than or equal to 1400, less than or equal to 1200, less than or equal to 1000, less than or equal to 800, less than or equal to 600, less than or equal to 500, less than or equal to 300, less than or equal to 200, less than or equal to 150, less than or equal to 100, less than or equal to 75, less than or equal to 50, less than or equal to 40, less than or equal to 30, or less than or equal to 20. Combinations of the above-referenced ranges are also possible (e.g., greater than or equal to 10 and less than or equal to 2000, greater than or equal to 30 and less than or equal to 1800, or greater than or equal to 50 and less than or equal to 1600). Other ranges are also possible.

The melt flow rate of a charge-stabilizing additive may be determined by the same process described elsewhere herein for determining the melt flow rate of polypropylene.

When a non-woven fiber web having high performance includes two or more types of resins comprising charge-stabilizing additives, each type of resin may independently have a melt flow rate in one or more of the ranges described above and/or all of the resins in the non-woven fiber web having high performance may together have a melt flow rate in one or more of the ranges described above. When a filter media comprises two or more non-woven fiber webs having high performance, the preceding may be true for each such non-woven fiber web independently.

In some embodiments, the difference in melt flow rates between a resin comprising a charge-stabilizing additive and polypropylene (e.g., polypropylene present in fibers) both present in a non-woven fiber web having high performance is relatively small. The absolute value of this difference may be less than or equal to 1200, less than or equal to 1000, less than or equal to 750, less than or equal to 500, less than or equal to 300, less than or equal to 200, less than or equal to 100, less than or equal to 75, less than or equal to 50, less than or equal to 30, less than or equal to 20, or less than or equal to 10. The absolute value of this difference may be greater than or equal to 0, greater than or equal to 10, greater than or equal to 20, greater than or equal to 30, greater than or equal to 50, greater than or equal to 75, greater than or equal to 100, greater than or equal to 200, greater than or equal to 300, greater than or equal to 500, greater than or equal to 750, or greater than or equal to 1000. Combinations of the above-referenced ranges are also possible (e.g., less than or equal to 1200 and greater than or equal to 0). Other ranges are also possible. In some embodiments, this difference is identically 0.

When a non-woven fiber web having high performance includes two or more types of resins comprising charge-stabilizing additives and/or two or more types of polypropylene, each pair of resin and polypropylene type may independently have a melt flow rate difference with an absolute value in one or more of the ranges described above and/or all of the resins in the non-woven fiber web having high performance may together have an absolute value of melt flow rate difference from all of the other polypropylene in the non-woven fiber web together in one or more of the ranges described above. When a filter media comprises two or more non-woven fiber webs having high performance, the preceding may be true for each such non-woven fiber web independently.

In some embodiments, a non-woven fiber web having high performance is flame-resistant and/or comprises a flame-resistant species. Flame-resistant non-woven fiber webs may pass a glow wire test according to IEC60695-2-11 (2010). Flame-resistant species may include flame-resistant fibers and/or flame-resistant additives. The former may include fibers having a flame-resistant additive distributed within and/or throughout the fiber. Such fibers may be fabricated by a method described elsewhere herein with respect to the incorporation of charge-stabilizing additives into fibers. It is also possible for a flame-resistant non-woven fiber web to comprise a flame-resistant additive positioned in a location other than the fibers therein.

The amount of flame-resistant species in a non-woven fiber web having high performance may be selected as desired. In some embodiments, flame-resistant species make up greater than or equal to 0.1 wt %, greater than or equal to 0.2 wt %, greater than or equal to 0.3 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, or greater than or equal to 35 wt % of the non-woven fiber web having high performance. In some embodiments, flame-resistant species make up less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.3 wt %, or less than or equal to 0.2 wt % of the non-woven fiber web having relatively high performance. Combinations of the above-referenced ranges are also possible (e.g., greater than or equal to 0.1 wt % and less than or equal to 40 wt %, greater than or equal to 0.2 wt % and less than or equal to 20 wt %, or greater than or equal to 0.3 wt % and less than or equal to 10 wt %). Other ranges are also possible.

When a non-woven fiber web having high performance includes two or more types of flame-resistant species, each type of flame-resistant species may independently be present in one or more of the ranges described above and/or all of the flame-resistant species in the non-woven fiber web having high performance may be present in one or more of the ranges described above. When a filter media comprises two or more non-woven fiber webs having high performance, the preceding may be true for each such non-woven fiber web independently.

A variety of suitable flame-resistant additives may be included in the non-woven fiber webs having high performance described herein (e.g., in flame-resistant fibers and/or elsewhere). For instance, such non-woven fiber webs may comprise a phosphorus-based flame-resistant additive and/or a nitrogen-based flame-resistant additive. Non-limiting examples of flame-resistant additives include phosphorous-based additives, nitrogen-based additives, mineral additives, carbon-based additives, and bio-based additives. Such additives may comprise propionylmethylphosphinate, dioxaphosphorinane and derivatives thereof, triazine-based compounds, phosphoramidate and derivates thereof, allyl-functionalized polyphosphazene, and non-halogenated compounds such as hydroxymethylphosphonium salts and N-methylol phosphonopropionamide and derivatives thereof. It is also possible for the flame-resistant additives to include one or more of those described in Seidi F, Movahedifar E, Naderi G, Akbari V. Ducos F. Shamsi R, Vahabi H, Saeb MR. Flame Retardant Polypropylenes: A Review. Polymers (Basel). 2020 Jul. 29; 12(8):1701. doi: 10.3390/polym12081701. PMID: 32751298; PMCID: PMC7464193.

In some embodiments, a non-woven fiber web having high performance is antimicrobial. Such non-woven fiber webs may destroy and/or inhibit the growth of microorganisms (e.g., bacteria, viruses, fungi) and, in some cases, pathogenic microorganisms. In some embodiments, a non-woven fiber web having high performance includes an antimicrobial species.

Antimicrobial species may comprise antimicrobial fibers and/or antimicrobial additives. The former may include fibers having an antimicrobial additive distributed within and/or throughout the fiber. Such fibers may be fabricated by a method described elsewhere herein with respect to the incorporation of charge-stabilizing additives into fibers. It is also possible for an antimicrobial non-woven fiber web to comprise an antimicrobial additive positioned in a location other than the fibers therein.

The amount of antimicrobial species in a non-woven fiber web having high performance may be selected as desired. In some embodiments, this amount is greater than or equal to 0.01 wt %, greater than or equal to 0.015 wt %, greater than or equal to 0.02 wt %, greater than or equal to 0.025 wt %, greater than or equal to 0.03 wt %, greater than or equal to 0.04 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 6 wt %, greater than or equal to 8 wt %, greater than or equal to 10 wt %, greater than or equal to 12.5 wt %, greater than or equal to 15 wt %, or greater than or equal to 17.5 wt % of the non-woven fiber web having relatively high performance. This amount may be less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.04 wt %, less than or equal to 0.03 wt %, less than or equal to 0.025 wt %, less than or equal to 0.02 wt %, or less than or equal to 0.015 wt % of the non-woven fiber web having relatively high performance. Combinations of the above-referenced ranges are also possible (e.g., greater than or equal to 0.01 wt % and less than or equal to 20 wt %, greater than or equal to 0.02 wt % and less than or equal to 10 wt %, or greater than or equal to 0.03 wt % and less than or equal to 3 wt %). Other ranges are also possible.

When a non-woven fiber web having high performance includes two or more types of antimicrobial species, each type of antimicrobial species may independently be present in one or more of the ranges described above and/or all of the antimicrobial species in the non-woven fiber web having high performance may be present in one or more of the ranges described above. When a filter media comprises two or more non-woven fiber webs having high performance, the preceding may be true for each such non-woven fiber web independently.

Antimicrobial additives may comprise bacteriostatic, fungistatic, and/or virostatic additives. Non-limiting examples of suitable antimicrobial additives include silver and derivatives thereof (e.g., silver particles, silver ions), zinc and derivatives thereof (e.g., zinc pyrithione), copper, metal oxides (e.g., silver oxide, iron oxide, titanium oxide, copper oxide, zinc oxide), triclosan, quaternary ammonium compounds, chitosan, poly(hexamethylene biguanide), terpinoids, flavonoids, quinones, lectins, n-halamines, and citric acid.

Antimicrobial fibers may comprise bacteriostatic, fungistatic, and/or virostatic polymers. Non-limiting examples of suitable polymers for use in antimicrobial fibers include polyethylene, polypropylene, polystyrene, ethylene/vinyl acetate copolymer, ethylene-vinyl alcohol copolymer, polyamide (e.g., nylon), polyacrylonitrile, acrylic, and polyethylene terephthalate.

In some embodiments, a non-woven fiber web having high performance includes an antiallergen species. Antiallergen species may comprise antiallergen fibers and/or antiallergen additives. The former may include fibers having an antiallergen additive distributed within and/or throughout the fiber. Such fibers may be fabricated by a method described elsewhere herein with respect to the incorporation of charge-stabilizing additives into fibers. It is also possible for non-woven fiber web to comprise an antiallergen additive positioned in a location other than the fibers therein. For instance, a non-woven fiber web may comprise an antiallergen additive that is separate from the fibers and was introduced into the non-woven fiber web by treating the non-woven fiber web with a solution (e.g., an aqueous solution, an acid solution, an alkaline solution) comprising the antiallergen additive.

The amount of antiallergen species in a non-woven fiber web having high performance may be selected as desired. In some embodiments, antiallergen species make up greater than or equal to 0.001 wt %, greater than or equal to 0.002 wt %, greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.25 wt %, greater than or equal to 1.5 wt %, greater than or equal to 1.75 wt %, greater than or equal to 2 wt %, greater than or equal to 3 wt %, greater than or equal to 4 wt %, greater than or equal to 5 wt %, greater than or equal to 6 wt %, or greater than or equal to 8 wt % of the non-woven fiber web having relatively high performance. In some embodiments, antiallergen species make up less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, less than or equal to 1.75 wt %, less than or equal to 1.5 wt %, less than or equal to 1.25 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, less than or equal to 0.0075 wt %, less than or equal to 0.005 wt %, or less than or equal to 0.002 wt % of the non-woven fiber web having relatively high performance. Combinations of the above-referenced ranges are also possible (e.g., greater than or equal to 0.001 wt % and less than or equal to 10 wt %, greater than or equal to 0.01 wt % and less than or equal to 5 wt %, or greater than or equal to 0.1 wt % and less than or equal to 2 wt %). Other ranges are also possible.

When a non-woven fiber web having high performance includes two or more types of antiallergen species, each type of antiallergen species may independently be present in one or more of the ranges described above and/or all of the antiallergen species in the non-woven fiber web having high performance may be present in one or more of the ranges described above. When a filter media comprises two or more non-woven fiber webs having high performance, the preceding may be true for each such non-woven fiber web independently.

Antiallergen additives may comprise silver and/or one or more drugs. Non-limiting examples of suitable drugs include antihistamines (e.g., diphenhydramine, chlorpheniramine, cetirizine, levocetirizine, fexofenadine, loratadine, doxylamine), ketotifen, naphazoline, fluticasone, budesonide, traimcinolone, hydrocortisone, desloratadine, azelstine, alcaftadine, bepotastine, olopatadine, epinephrine, pseudoephedrine, and oxymetazoline.

The fibers in the non-woven fiber web having high performance may have a variety of suitable average fiber diameters. In some embodiments, the fibers in this non-woven fiber web have an average fiber diameter of greater than or equal to 0.5 microns, greater than or equal to 0.75 microns, greater than or equal to 1 micron, greater than or equal to 1.25 microns, greater than or equal to 1.5 microns, greater than or equal to 1.75 microns, greater than or equal to 2 microns, greater than or equal to 2.5 microns, greater than or equal to 3 microns, greater than or equal to 3.5 microns, greater than or equal to 4 microns, greater than or equal to 4.5 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, or greater than or equal to 14 microns. In some embodiments, the fibers in this non-woven fiber web have an average fiber diameter of less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.75 microns, less than or equal to 1.5 microns, less than or equal to 1.25 microns, less than or equal to 1 micron, or less than or equal to 0.75 microns. Combinations of the above-referenced ranges are also possible (e.g., greater than or equal to 0.5 microns and less than or equal to 15 microns, greater than or equal to 0.5 microns and less than or equal to 5 microns, greater than or equal to 1 micron and less than or equal to 4.5 microns, greater than or equal to 2 microns and less than or equal to 4 microns, greater than or equal to 3 microns and less than or equal to 15 microns, greater than or equal to 3 microns and less than or equal to 12 microns, or greater than or equal to 3 microns and less than or equal to 10 microns). Other ranges are also possible.

When a non-woven fiber web having high performance includes two or more types of fibers, each type of fiber may independently have an average fiber diameter in one or more of the ranges described above and/or all of the fibers in the non-woven fiber web having high performance may together have an average fiber diameter in one or more of the ranges described above. When a filter media comprises two or more non-woven fiber webs having high performance, the preceding may be true for each such non-woven fiber web independently.

In some embodiments, a filter media comprises two or more non-woven fiber webs having high performance that have different average fiber diameters. As an example, a filter media may comprise one non-woven fiber web having high performance having a relatively large average fiber diameter (e.g., of greater than or equal to 3 microns) and one non-woven fiber web having high performance having a relatively small average fiber diameter (e.g., of less than or equal to 5 microns, less than or equal to 4.5 microns, or less than or equal to 4 microns).

Non-woven fiber webs having high performance may have a variety of suitable solidities. In some embodiments, a non-woven fiber web having high performance has a relatively low solidity. Without wishing to be bound by any particular theory, it is believed that a low solidity may beneficially make the non-woven fiber web more open, which may reduce pressure drop and also allow for contaminants to be collected throughout the thickness of the non-woven fiber web. This may desirably increase gamma and/or the ratio of dust holding capacity to basis weight In some embodiments, a non-woven fiber web having high performance has a solidity of less than or equal to 15%, less than or equal to 13%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2.75%, less than or equal to 2.5%, less than or equal to 2.25%, less than or equal to 2%, less than or equal to 1.75%, less than or equal to 1.5%, or less than or equal to 1.25%. In some embodiments, a non-woven fiber web having high performance has a solidity of greater than or equal to 1%, greater than or equal to 1.25%, greater than or equal to 1.5%, greater than or equal to 1.75%, greater than or equal to 2%, greater than or equal to 2.25%, greater than or equal to 2.5%, greater than or equal to 2.75%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 11%, or greater than or equal to 13%. Combinations of the above-referenced ranges are also possible (e.g., greater than or equal to 1% and less than or equal to 15%, greater than or equal to 2% and less than or equal to 10%, or greater than or equal to 2.5% and less than or equal to 6%). Other ranges are also possible.

The solidity of a non-woven fiber web having high performance is equivalent to the percentage of the interior of the non-woven fiber web occupied by solid material. One non-limiting way of determining solidity of such a non-woven fiber web is described in this paragraph, but other methods are also possible. The method described in this paragraph includes determining the basis weight and thickness of the non-woven fiber web and then applying the following formula: solidity=[basis weight of the non-woven fiber web/(density of the components forming the non-woven fiber web·thickness of the non-woven fiber web)]·100%. The density of the components forming the non-woven fiber web is equivalent to the average density of the material or material(s) forming the components of the non-woven fiber web (e.g., the fibers therein, any other components therein), which is typically specified by the manufacturer of each material. The average density of the materials forming the components of the non-woven fiber web may be determined by: (1) determining the total volume of all of the components in the non-woven fiber web; and (2) dividing the total mass of all of the components in the non-woven fiber web by the total volume of all of the components in the non-woven fiber web. If the mass and density of each component of the non-woven fiber web are known, the volume of all the components in the non-woven fiber web may be determined by: (1) for each type of component, dividing the total mass of the component in the non-woven fiber web by the density of the component; and (2) summing the volumes of each component. If the mass and density of each component of the non-woven fiber web are not known, the volume of all the components in the non-woven fiber web may be determined in accordance with Archimedes' principle.

When a filter media comprises two or more non-woven fiber webs having high performance, each such non-woven fiber web may independently have a solidity in one or more of the above-referenced ranges.

Non-woven fiber webs having high performance may have a variety of suitable thicknesses. In some embodiments, a non-woven fiber web having high performance has a thickness of greater than or equal to 6 mils, greater than or equal to 10 mils, greater than or equal to 25 mils, greater than or equal to 50 mils, greater than or equal to 75 mils, greater than or equal to 100 mils, greater than or equal to 150 mils, greater than or equal to 200 mils, greater than or equal to 250 mils, greater than or equal to 300 mils, greater than or equal to 350 mils, greater than or equal to 400 mils, or greater than or equal to 450 mils. In some embodiments, a non-woven fiber web having high performance has a thickness of less than or equal to 500 mils, less than or equal to 450 mils, less than or equal to 400 mils, less than or equal to 350 mils, less than or equal to 300 mils, less than or equal to 250 mils, less than or equal to 200 mils, less than or equal to 150 mils, less than or equal to 100 mils, less than or equal to 75 mils, less than or equal to 50 mils, less than or equal to 25 mils, or less than or equal to 10 mils. Combinations of the above-referenced ranges are also possible (e.g., greater than or equal to 6 mils and less than or equal to 500 mils). Other ranges are also possible.

The thickness of a non-woven fiber web having high performance may be determined in accordance with ASTM D1777 (2019) under a pressure of 2.65 psi applied by a 1 ft² foot.

When a filter media comprises two or more non-woven fiber webs having high performance, each such non-woven fiber web may independently have a thickness in one or more of the above-referenced ranges.

Non-woven fiber webs having high performance may have a variety of suitable basis weights. In some embodiments, a non-woven fiber web having high performance has a basis weight of greater than or equal to 2 g/m² (gsm), greater than or equal to 3 gsm, greater than or equal to 4 gsm, greater than or equal to 5 gsm, greater than or equal to 6 gsm, greater than or equal to 8 gsm, greater than or equal to 10 gsm, greater than or equal to 15 gsm, greater than or equal to 20 gsm, greater than or equal to 30 gsm, greater than or equal to 50 gsm, greater than or equal to 75 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 350 gsm, greater than or equal to 400 gsm, or greater than or equal to 450 gsm. In some embodiments, a non-woven fiber web having high performance has a basis weight of less than or equal to 500 gsm, less than or equal to 450 gsm, less than or equal to 400 gsm, less than or equal to 350 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 75 gsm, less than or equal to 50 gsm, less than or equal to 30 gsm, less than or equal to 20 gsm, less than or equal to 15 gsm, less than or equal to 10 gsm, less than or equal to 8 gsm, less than or equal to 6 gsm, less than or equal to 5 gsm, less than or equal to 4 gsm, or less than or equal to 3 gsm. Combinations of the above-referenced ranges are also possible (e.g., greater than or equal to 2 gsm and less than or equal to 500 gsm, greater than or equal to 5 gsm and less than or equal to 300 gsm, or greater than or equal to 10 gsm and less than or equal to 200 gsm). Other ranges are also possible.

The basis weight of a non-woven fiber web having high performance may be determined in accordance with ASTM D3776-20 (2020).

When a filter media comprises two or more non-woven fiber webs having high performance, each such non-woven fiber web may independently have a basis weight in one or more of the above-referenced ranges.

Non-woven fiber webs having high performance may have a variety of suitable mean flow pore sizes. In some embodiments, a non-woven fiber web having high performance has a mean flow pore size of greater than or equal to 20 microns, greater than or equal to 25 microns, greater than or equal to 30 microns, greater than or equal to 40 microns, greater than or equal to 50 microns, greater than or equal to 75 microns, greater than or equal to 100 microns, greater than or equal to 125 microns, greater than or equal to 150 microns, or greater than or equal to 175 microns. In some embodiments, a non-woven fiber web having high performance has a mean flow pore size of less than or equal to 200 microns, less than or equal to 175 microns, less than or equal to 150 microns, less than or equal to 125 microns, less than or equal to 100 microns, less than or equal to 75 microns, less than or equal to 50 microns, less than or equal to 40 microns, less than or equal to 30 microns, or less than or equal to 25 microns. Combinations of the above-referenced ranges are also possible (e.g., greater than or equal to 20 microns and less than or equal to 200 microns, greater than or equal to 20 microns and less than or equal to 150 microns, or greater than or equal to 20 microns and less than or equal to 100 microns). Other ranges are also possible.

The mean flow pore size of a non-woven fiber web having high performance may be determined in accordance with ASTM F316 (2003).

When a filter media comprises two or more non-woven fiber webs having high performance, each such non-woven fiber web may independently have a mean flow pore size in one or more of the above-referenced ranges.

Non-woven fiber webs having high performance may have a variety of suitable air permeabilities. In some embodiments, a non-woven fiber web having high performance has an air permeability of greater than or equal to 20 ft³/min/ft² (CFM), greater than or equal to 50 CFM, greater than or equal to 75 CFM, greater than or equal to 100 CFM, greater than or equal to 200 CFM, greater than or equal to 500 CFM, greater than or equal to 750 CFM, or greater than or equal to 1000 CFM. In some embodiments, a non-woven fiber web having high performance has an air permeability of less than or equal to 1300 CFM, less than or equal to 1000 CFM, less than or equal to 750 CFM, less than or equal to 500 CFM, less than or equal to 200 CFM, less than or equal to 100 CFM, less than or equal to 75 CFM, or less than or equal to 50 CFM. Combinations of the above-referenced ranges are also possible (e.g., greater than or equal to 20 CFM and less than or equal to 1300 CFM). Other ranges are also possible.

The air permeability of a non-woven fiber web having high performance may be determined in accordance with ASTM D737-04 (2016) at a pressure of 125 Pa.

When a filter media comprises two or more non-woven fiber webs having high performance, each such non-woven fiber web may independently have an air permeability in one or more of the above-referenced ranges.

Non-woven fiber webs having high performance may have relatively high values of gamma. Gamma is defined by the following formula: gamma=(−log₁₀(initial penetration, %/100%)/(initial air resistance, mm H₂O))·100. Penetration, often expressed as a percentage, is defined as follows: Pen (%)=(C/C₀)·100% where C is the particle concentration after passage through the non-woven fiber web having high performance and Co is the particle concentration before passage through the non-woven fiber web having high performance.

Initial penetration may be measured by blowing NaCl particles through a non-woven fiber web having high performance and measuring the percentage of particles that penetrate therethrough. This may be accomplished by use of a TSI 8130 automated filter testing unit from TSI, Inc. equipped with a generator for NaCl aerosol testing for NaCl particles having a particle size of 0.26 microns. The TSI 8130 automated filter testing unit may be employed to perform an automated procedure entitled “Filter Test” encoded by the software therein for 0.26 micron particles at a face velocity of 5.3 cm/s. Briefly, this test comprises blowing NaCl particles with an average particle diameter of 0.26 microns at a 100 cm² face area of the upstream face of the non-woven fiber web. The upstream and downstream particle concentrations may be measured by use of condensation particle counters. During the penetration measurement, the 100 cm² face area of the upstream face of the non-woven fiber web may be subject to a continuous flow of NaCl particles at a media face velocity of 5.3 cm/s until the penetration reading is determined to be stable by the TSI 8130 automated filter testing unit.

The initial air resistance of the non-woven fiber web having high performance may also be measured concurrently with the initial NaCl penetration at 0.26 microns while following this same procedure.

In some embodiments, a non-woven fiber web having high performance has a gamma of greater than or equal to 200, greater than or equal to 250, greater than or equal to 300, greater than or equal to 350, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, or greater than or equal to 850. In some embodiments, a non-woven fiber web having high performance has a gamma of less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 350, less than or equal to 300, or less than or equal to 250. Combinations of the above-referenced ranges are also possible (e.g., greater than or equal to 200 and less than or equal to 900, greater than or equal to 200 and less than or equal to 750, or greater than or equal to 200 and less than or equal to 600). Other ranges are also possible.

When a filter media comprises two or more non-woven fiber webs having high performance, each such non-woven fiber web may independently have a gamma in one or more of the above-referenced ranges.

In some embodiments, a non-woven fiber web having high performance has a relatively low air resistance after NaCl loading and/or a relatively low air resistance increase after NaCl loading. NaCl loading may be performed by blowing NaCl particles through the non-woven fiber web for 30 minutes. This may be accomplished by employing a TSI-8130 automated filter testing unit having the properties described above with respect to gamma. A solution of 2 wt % NaCl in distilled water may be employed as the source for NaCl aerosol generation. The loading may be accomplished by blowing the aerosol at a face velocity of 14.2 cm/s at a 100 cm² face area of the upstream face of the non-woven fiber web for 30 minutes. During this process, the air resistance and penetration may be measured every minute. The air resistance after NaCl loading may be the last air resistance measured (i.e., after 30 minutes of NaCl loading).

The air resistance after NaCl loading of a non-woven fiber web having high performance may be greater than or equal to 0.1 mm H₂O, greater than or equal to 0.2 mm H₂O, greater than or equal to 0.3 mm H₂O, greater than or equal to 0.4 mm H₂O, greater than or equal to 0.5 mm H₂O, greater than or equal to 0.6 mm H₂O, greater than or equal to 0.8 mm H₂O, greater than or equal to 1 mm H₂O, greater than or equal to 2 mm H₂O, greater than or equal to 5 mm H₂O, greater than or equal to 7.5 mm H₂O, greater than or equal to 10 mm H₂O, greater than or equal to 12.5 mm H₂O, greater than or equal to 15 mm H₂O, greater than or equal to 17.5 mm H₂O, greater than or equal to 20 mm H₂O, greater than or equal to 22 mm H₂O, greater than or equal to 23 mm H₂O, or greater than or equal to 24 mm H₂O. The air resistance after NaCl loading of a non-woven fiber web having high performance may be less than or equal to 25 mm H₂O, less than or equal to 24 mm H₂O, less than or equal to 23 mm H₂O, less than or equal to 22 mm H₂O, less than or equal to 20 mm H₂O, less than or equal to 17.5 mm H₂O, less than or equal to 15 mm H₂O, less than or equal to 12.5 mm H₂O, less than or equal to 10 mm H₂O, less than or equal to 7.5 mm H₂O, less than or equal to 5 mm H₂O, less than or equal to 2 mm H₂O, less than or equal to 1 mm H₂O, less than or equal to 0.8 mm H₂O, less than or equal to 0.6 mm H₂O, less than or equal to 0.5 mm H₂O, less than or equal to 0.4 mm H₂O, less than or equal to 0.3 mm H₂O, or less than or equal to 0.2 mm H₂O. Combinations of the above-referenced ranges are also possible (e.g., greater than or equal to 0.1 mm H₂O and less than or equal to 25 mm H₂O, greater than or equal to 0.5 mm H₂O and less than or equal to 24 mm H₂O, or greater than or equal to 1 mm H₂O and less than or equal to 23 mm H₂O). Other ranges are also possible.

When a filter media comprises two or more non-woven fiber webs having high performance, each such non-woven fiber web may independently have an air resistance after NaCl loading in one or more of the above-referenced ranges.

In some embodiments, a non-woven fiber web having high performance has a relatively low ratio of air resistance after NaCl loading to air resistance prior to NaCl loading (i.e., the ratio of the last air resistance measured during the NaCl loading procedure described above to the first air resistance measured during this procedure). This ratio may be less than or equal to 15, less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, less than or equal to 4, less than or equal to 3, less than or equal to 2, less than or equal to 1.75, less than or equal to 1.5, less than or equal to 1.4, less than or equal to 1.3, or less than or equal to 1.2. This ratio may be greater than or equal to 1.1, greater than or equal to 1.2, greater than or equal to 1.3, greater than or equal to 1.4, greater than or equal to 1.5, greater than or equal to 1.75, greater than or equal to 2, greater than or equal to 3, greater than or equal to 4, greater than or equal to 5, greater than or equal to 6, greater than or equal to 7, greater than or equal to 8, greater than or equal to 9, greater than or equal to 10, greater than or equal to 11, greater than or equal to 12, greater than or equal to 13, or greater than or equal to 14. Combinations of the above-referenced ranges are also possible (e.g., greater than or equal to 1.1 and less than or equal to 15, greater than or equal to 1.2 and less than or equal to 12, or greater than or equal to 1.3 and less than or equal to 10). Other ranges are also possible.

When a filter media comprises two or more non-woven fiber webs having high performance, each such non-woven fiber web may independently have a ratio of air resistance after NaCl loading to air resistance prior to NaCl loading in one or more of the above-referenced ranges.

Some non-woven webs having high performance are configured such that, during NaCl loading, the NaCl particles that are captured are distributed relatively evenly throughout the non-woven fiber web. This may be parametrized by a relatively high density of NaCl at the downstream surface in comparison to the density of NaCl at the upstream surface when both are measured after undergoing an NaCl loading process. The density of NaCl at the downstream surface of the non-woven fiber web may be greater than or equal to 50% greater than or equal to 55%, greater than or equal to 60%, greater than or equal to 65%, greater than or equal to 70%, greater than or equal to 75%, greater than or equal to 80%, greater than or equal to 85%, or greater than or equal to 90% of the density of NaCl at the upstream surface after undergoing an NaCl loading process. The density of NaCl at the downstream surface of the non-woven fiber web may be less than or equal to 95%, less than or equal to 90%, less than or equal to 85%, less than or equal to 80%, less than or equal to 75%, less than or equal to 70%, less than or equal to 65%, or less than or equal to 60% of the density of NaCl at the upstream surface after undergoing an NaCl loading process. Combinations of the above-referenced ranges are also possible (e.g., greater than or equal to 50% and less than or equal to 95%). Other ranges are also possible.

The density of NaCl at the upstream and downstream surfaces of a non-woven fiber web having high performance may be determined by a variety of suitable techniques. One such technique involves determining the density of the non-woven fiber web's upstream and downstream surfaces prior to the NaCl loading process and after the NaCl loading process. The increase in density upon NaCl loading may be attributed solely to NaCl. The density at these locations and points in time may be determined with a QTRS Tree ring scanner and data analyzer model no. QTRS-01X (Quintek Measurement Systems, Knoxville, TN). The QTRS Tree ring scanner may be employed to pass an X-ray beam through the upstream and downstream surfaces of the non-woven fiber web having high performance. Then, the observed transmitted intensity at each location may be compared to the intensity transmitted by a sample with a known density. Finally, the density at each location can be determined using the Lambert-Beer law.

When a filter media comprises two or more non-woven fiber webs having high performance, each such non-woven fiber web may independently be configured such that the density of NaCl at the downstream surface as a percentage of the density of NaCl at the upstream surface after undergoing an NaCl loading process is in one or more of the above-referenced ranges.

Some non-woven webs having high performance have relatively high dust holding capacities. In some embodiments, a non-woven fiber web having high performance has a dust holding capacity of greater than or equal to 5 gsm, greater than or equal to 7.5 gsm, greater than or equal to 10 gsm, greater than or equal to 12.5 gsm, greater than or equal to 15 gsm, greater than or equal to 17.5 gsm, greater than or equal to 20 gsm, greater than or equal to 30 gsm, greater than or equal to 40 gsm, greater than or equal to 50 gsm, greater than or equal to 60 gsm, greater than or equal to 80 gsm, greater than or equal to 100 gsm, greater than or equal to 120 gsm, greater than or equal to 150 gsm, or greater than or equal to 180 gsm. In some embodiments, a non-woven fiber web having high performance has a dust holding capacity of less than or equal to 200 gsm, less than or equal to 180 gsm, less than or equal to 150 gsm, less than or equal to 120 gsm, less than or equal to 100 gsm, less than or equal to 80 gsm, less than or equal to 60 gsm, less than or equal to 50 gsm, less than or equal to 40 gsm, less than or equal to 30 gsm, less than or equal to 20 gsm, less than or equal to 17.5 gsm, less than or equal to 15 gsm, less than or equal to 12.5 gsm, less than or equal to 10 gsm, or less than or equal to 7.5 gsm. Combinations of the above-referenced ranges are also possible (e.g., greater than or equal to 5 gsm and less than or equal to 200 gsm, greater than or equal to 10 gsm and less than or equal to 180 gsm, or greater than or equal to 15 gsm and less than or equal to 150 gsm). Other ranges are also possible.

Dust holding capacity may be determined by blowing ISO 12103-1 A2 fine test dust at the non-woven fiber web having high performance until the air resistance rises by 50 Pa and then measuring the increase in mass over this process. This process may be accomplished by employing a Palas MFP 3000 instrument and employing it to blow the A2 test dust at a media face velocity of 20 cm/s at a 100 cm² face area of the upstream face of the non-woven fiber web.

When a filter media comprises two or more non-woven fiber webs having high performance, each such non-woven fiber web may independently have a dust holding capacity in one or more of the above-referenced ranges.

Some non-woven webs having high performance have relatively high ratios of dust holding capacity to basis weight. In some embodiments, a non-woven fiber web having high performance has a ratio of dust holding capacity to basis weight of greater than or equal to 0.4 gsm/gsm, greater than or equal to 0.5 gsm/gsm, greater than or equal to 0.6 gsm/gsm, greater than or equal to 0.7 gsm/gsm, greater than or equal to 0.8 gsm/gsm, greater than or equal to 0.9 gsm/gsm, greater than or equal to 1 gsm/gsm, greater than or equal to 1.25 gsm/gsm, greater than or equal to 1.5 gsm/gsm, greater than or equal to 2 gsm/gsm, greater than or equal to 3 gsm/gsm, greater than or equal to 4 gsm/gsm, greater than or equal to 5 gsm/gsm, greater than or equal to 6 gsm/gsm, greater than or equal to 7 gsm/gsm, greater than or equal to 8 gsm/gsm, or greater than or equal to 9 gsm/gsm. In some embodiments, a non-woven fiber web having high performance has a ratio of dust holding capacity to basis weight of less than or equal to 10 gsm/gsm, less than or equal to 9 gsm/gsm, less than or equal to 8 gsm/gsm, less than or equal to 7 gsm/gsm, less than or equal to 6 gsm/gsm, less than or equal to 5 gsm/gsm, less than or equal to 4 gsm/gsm, less than or equal to 3 gsm/gsm, less than or equal to 2 gsm/gsm, less than or equal to 1.5 gsm/gsm, less than or equal to 1.25 gsm/gsm, less than or equal to 1 gsm/gsm, less than or equal to 0.9 gsm/gsm, less than or equal to 0.8 gsm/gsm, less than or equal to 0.7 gsm/gsm, or less than or equal to 0.6 gsm/gsm. Combinations of the above-referenced ranges are also possible (e.g., greater than or equal to 0.4 gsm/gsm and less than or equal to 10 gsm/gsm, greater than or equal to 0.6 gsm/gsm and less than or equal to 8 gsm/gsm, or greater than or equal to 0.8 gsm/gsm and less than or equal to 5 gsm/gsm). Other ranges are also possible.

When a filter media comprises two or more non-woven fiber webs having high performance, each such non-woven fiber web may independently have a ratio of dust holding capacity to basis weight in one or more of the above-referenced ranges.

Some non-woven webs having high performance have relatively high ratios of dust holding capacity to initial air resistance. In some embodiments, a non-woven fiber web having high performance has a ratio of dust holding capacity to initial air resistance of greater than or equal to 175 gsm/mm H₂O, greater than or equal to 200 gsm/mm H₂O, greater than or equal to 300 gsm/mm H₂O, greater than or equal to 500 gsm/mm H₂O, greater than or equal to 750 gsm/mm H₂O, greater than or equal to 1000 gsm/mm H₂O, greater than or equal to 1250 gsm/mm H₂O, greater than or equal to 1500 gsm/mm H₂O, or greater than or equal to 1750 gsm/mm H₂O. In some embodiments, a non-woven fiber web having high performance has a ratio of dust holding capacity to initial air resistance of less than or equal to 2000 gsm/mm H₂O, less than or equal to 1750 gsm/mm H₂O, less than or equal to 1500 gsm/mm H₂O, less than or equal to 1250 gsm/mm H₂O, less than or equal to 1000 gsm/mm H₂O, less than or equal to 750 gsm/mm H₂O, less than or equal to 500 gsm/mm H₂O, less than or equal to 300 gsm/mm H₂O, or less than or equal to 200 gsm/mm H₂O. Combinations of the above-referenced ranges are also possible (e.g., greater than or equal to 175 gsm/mm H₂O and less than or equal to 2000 gsm/mm H₂O). Other ranges are also possible.

When a filter media comprises two or more non-woven fiber webs having high performance, each such non-woven fiber web may independently have a ratio of dust holding capacity to initial air resistance in one or more of the above-referenced ranges.

In some embodiments, a non-woven web having high performance passes the MERV13A Appendix J test described in ANSI/ASHRAE Standard 52.2-2017.

In some embodiments, a non-woven fiber web having high performance is charged. For instance, it may be a charged meltblown layer. A charged non-woven fiber web may be formed via any of a variety of suitable methods and/or steps described herein, such as electrostatic charging, triboelectric charging, and/or hydrocharging.

In some such embodiments, one or more charge additives (e.g., one or more of those described elsewhere herein) may be present in a non-woven fiber web having high performance when the non-woven fiber web undergoes the charging process. The presence of a charge additive(s) during a charging process may be beneficial. As one example, the presence of such charge additives during a hydrocharging process may advantageously facilitate hydroentanglement of fibers and/or lead to a more efficient hydrocharging process. In some embodiments, hydroentanglement of fibers may advantageously impart a non-woven fiber web with a relatively low air resistance.

In some embodiments, a non-woven fiber web having high performance is charged by a hydrocharging process. A hydrocharging process may comprise impinging jets and/or streams of water droplets onto an initially uncharged non-woven fiber web to cause it to become charged electrostatically. At the conclusion of the hydrocharging process, the non-woven fiber web may have an electret charge. The jets and/or streams of water droplets may impinge on the non-woven fiber web at a variety of suitable pressures, such as a pressure of between 10 to 1000 psi, and may be provided by a variety of suitable sources, such as a sprayer.

In some embodiments, a pressure of greater than or equal to 10 psi, greater than or equal to 50 psi, greater than or equal to 100 psi, greater than or equal to 200 psi, greater than or equal to 300 psi, greater than or equal to 400 psi, greater than or equal to 500 psi, greater than or equal to 600 psi, greater than or equal to 700 psi, greater than or equal to 800 psi, or greater than or equal to 900 psi may be employed during a hydrocharging process. In some embodiments, a pressure of less than or equal to 1000 psi, less than or equal to 900 psi, less than or equal to 800 psi, less than or equal to 700 psi, less than or equal to 600 psi, less than or equal to 500 psi, less than or equal to 400 psi, less than or equal to 300 psi, less than or equal to 200 psi, less than or equal to 100 psi, or less than or equal to 50 psi may be employed during a hydrocharging process. Combinations of the above-referenced ranges are also possible (e.g., greater than or equal to 10 psi and less than or equal to 1000 psi, greater than or equal to 100 psi and less than or equal to 500 psi, or greater than or equal to 200 psi and less than or equal to 400 psi). Other ranges are also possible.

When a filter media comprises two or more non-woven fiber webs having high performance, each such non-woven fiber web may independently be subject to a pressure in one or more of the above-referenced ranges during a hydrocharging process.

In some embodiments, a non-woven fiber web having high performance is hydrocharged by using an apparatus that may be employed for the hydroentanglement of fibers which is operated at a lower pressure than is typical for the hydroentangling process. The water impinging on the non-woven fiber web may be relatively pure; for instance, it may be distilled water and/or deionized water. After electrostatic charging in this manner, the non-woven fiber web may be dried, such as with air dryer.

In some embodiments, a non-woven fiber web having high performance is hydrocharged while being moved laterally. The non-woven fiber web may be transported on a porous belt, such as a screen or mesh-type conveyor belt. As it is being transported on the porous belt, it may be exposed to a spray and/or jets of water pressurized by a pump. The water jets and/or spray may impinge on the non-woven fiber web and/or penetrate therein. In some embodiments, a vacuum is provided beneath the porous transport belt, which may aid the passage of water through the non-woven fiber web and/or reduce the amount of time and energy necessary for drying the non-woven fiber web at the conclusion of the hydrocharging process.

In some embodiments, a hydrocharging apparatus may include a plurality of nozzles configured to spray jets of pressurized water at a non-woven fiber web described herein. The nozzles may be present in any suitable number density in the apparatus and/or have any suitable diameter. In some embodiments, the nozzles may be present in a hydrocharging apparatus in a nozzle number density of greater than or equal to 10 nozzles per inch, greater than or equal to 15 nozzles per inch, greater than or equal to 20 nozzles per inch, greater than or equal to 25 nozzles per inch, greater than or equal to 30 nozzles per inch, greater than or equal to 35 nozzles per inch, greater than or equal to 40 nozzles per inch, greater than or equal to 45 nozzles per inch, greater than or equal to 50 nozzles per inch, greater than or equal to 55 nozzles per inch, greater than or equal to 60 nozzles per inch, greater than or equal to 70 nozzles per inch, greater than or equal to 80 nozzles per inch, greater than or equal to 90 nozzles per inch, greater than or equal to 100 nozzles per inch, greater than or equal to 110 nozzles per inch, greater than or equal to 120 nozzles per inch, greater than or equal to 130 nozzles per inch, greater than or equal to 140 nozzles per inch, greater than or equal to 150 nozzles per inch, greater than or equal to 160 nozzles per inch, greater than or equal to 170 nozzles per inch, greater than or equal to 180 nozzles per inch, or greater than or equal to 190 nozzles per inch. In some embodiments, the nozzles may be present in a hydrocharging apparatus in a nozzle number density of less than or equal to 200 nozzles per inch, less than or equal to 190 nozzles per inch, less than or equal to 180 nozzles per inch, less than or equal to 170 nozzles per inch, less than or equal to 160 nozzles per inch, less than or equal to 150 nozzles per inch, less than or equal to 140 nozzles per inch, less than or equal to 130 nozzles per inch, less than or equal to 120 nozzles per inch, less than or equal to 110 nozzles per inch, less than or equal to 100 nozzles per inch, less than or equal to 90 nozzles per inch, less than or equal to 80 nozzles per inch, less than or equal to 70 nozzles per inch, less than or equal to 60 nozzles per inch, less than or equal to 55 nozzles per inch, less than or equal to 50 nozzles per inch, less than or equal to 45 nozzles per inch, less than or equal to 40 nozzles per inch, less than or equal to 35 nozzles per inch, less than or equal to 30 nozzles per inch, less than or equal to 25 nozzles per inch, less than or equal to 20 nozzles per inch, or less than or equal to 15 nozzles per inch. Combinations of the above-referenced ranges are also possible (e.g., greater than or equal to 10 nozzles per inch and less than or equal to 200 nozzles per inch). Other ranges are also possible.

In some embodiments, a nozzle may have a nozzle diameter of greater than or equal to 50 microns, greater than or equal to 60 microns, greater than or equal to 70 microns, greater than or equal to 80 microns, greater than or equal to 90 microns, greater than or equal to 100 microns, greater than or equal to 120 microns, greater than or equal to 140 microns, greater than or equal to 160 microns, greater than or equal to 180 microns, greater than or equal to 200 microns, greater than or equal to 220 microns, greater than or equal to 240 microns, greater than or equal to 260 microns, or greater than or equal to 280 microns. In some embodiments, a nozzle may have a nozzle diameter of less than or equal to 300 microns, less than or equal to 280 microns, less than or equal to 260 microns, less than or equal to 240 microns, less than or equal to 220 microns, less than or equal to 200 microns, less than or equal to 180 microns, less than or equal to 160 microns, less than or equal to 140 microns, less than or equal to 120 microns, less than or equal to 100 microns, less than or equal to 90 microns, less than or equal to 80 microns, less than or equal to 70 microns, or less than or equal to 60 microns. Combinations of the above-referenced ranges are also possible (e.g., greater than or equal to 50 microns and less than or equal to 300 microns). Other ranges are also possible.

In some embodiments, each of the plurality of nozzles in the hydrocharging apparatus may independently have a diameter in one or more ranges described above. In some embodiments, the diameters of two or more of the plurality of nozzles may be the same or different.

In some embodiments, a non-woven fiber web having high performance is charged via a triboelectric charging process. A triboelectric charging process may comprise bringing into contact and then separating two surfaces, at least one of which is a surface at which fibers to be charged are positioned. This process may cause the transfer of charge between the two surfaces and the associated buildup of charge on the two surfaces. The surfaces may be selected such that they have sufficiently different positions in the triboelectric series to result in a desirable level of charge transfer therebetween upon contact.

It is also possible for a non-woven fiber web having high performance to be charged via an electrostatic charging process, such as via a corona discharge process.

As described elsewhere herein, in some embodiments, a filter media comprises an adsorptive layer. Such a layer may further comprise an adsorptive species, which may be particulate. The adsorptive layer may be capable of and/or configured to remove a contaminant from a fluid. The adsorption may comprise physical adsorption (e.g., via weak interactions, such as van der Waals forces and/or hydrogen bonds) and/or may comprise chemical adsorption (e.g., via stronger interactions, such as covalent and/or ionic bonds). It is also possible for a filter media to comprise two or more adsorptive layers. Such adsorptive layers may be the same or may differ in one or more ways.

Adsorptive species may be present in an adsorptive layer in a variety of suitable amounts. In some embodiments, adsorptive species make up greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 25 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 85 wt %, greater than or equal to 90 wt %, greater than or equal to 92.5 wt %, greater than or equal to 95 wt %, or greater than or equal to 97.5 wt % of the adsorptive layer. In some embodiments, adsorptive species make up less than or equal to 99 wt %, less than or equal to 97.5 wt %, less than or equal to 95 wt %, less than or equal to 92.5 wt %, less than or equal to 90 wt %, less than or equal to 85 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, or less than or equal to 2 wt % of the adsorptive layer. Combinations of the above-referenced ranges are also possible (e.g., greater than or equal to 1 wt % and less than or equal to 99 wt %, greater than or equal to 15 wt % and less than or equal to 95 wt %, or greater than or equal to 30 wt % and less than or equal to 90 wt %). Other ranges are also possible.

When an adsorptive layer includes two or more types of adsorptive species, each type of adsorptive species may independently be present in one or more of the ranges described above and/or all of the adsorptive species in the adsorptive layer may together be present in one or more of the ranges described above. When a filter media comprises two or more adsorptive layers, the preceding may be true for each such layer independently.

A variety of types of adsorptive species may be included in the adsorptive layers described herein. One example of a suitable type of adsorptive species is activated carbon. Without wishing to be bound by any particular theory, it is believed that activated carbon may be capable of physically adsorbing one or more contaminants. The activated carbon may be derived from coconut shells or from wood. In some embodiments, the activated carbon is also surface-treated. Non-limiting examples of surface treatments include treatment such that the activated carbon transforms into chemically-active carbon, treatment with calcium carbonate, treatment with potassium iodide, treatment with tris-hydroxymethyl-aminomethane, treatment with phosphoric acid, treatment with a metal (e.g., a transition metal, such as copper, silver, zinc, and/or molybdenum) and treatment with tricthylenediamine.

In some embodiment, surface-treating activated carbon comprises impregnating activated carbon with the species with which it is being surface-treated in order to cause a chemical reaction at the surface of the activated carbon. The species surface-treating the activated carbon is present in an amount of between 0.5% and 30% of the weight of the activated carbon (e.g., between 2% and 10% of the weight of the activated carbon) during this process. After surface treatment, the activated carbon may comprise functional groups comprising nitrogen (e.g., amine groups), polar functional groups, and/or functional groups comprising sulfur (e.g., sulfur bound to the activated carbon matrix). It is also possible for surface treatment to increase the surface area of the activated carbon.

Chemically-active carbon may be formed by treating activated carbon with a metal chloride (e.g., ZnCl₂, FeCl₃, MgCl₂) in the presence of heat. This treatment may cause the activated carbon to exhibit an increase in surface area (e.g., to 500 m²/g to 1000 m²/g) and/or porosity, and/or may cause the pore size distribution in the activated carbon to change. It is also possible for this treatment to cause the formation of phenolic, lactonic, and/or carboxylic-acid functional groups on the activated carbon.

Other suitable types of adsorptive species include ion-exchange resins (e.g., cation-exchange resins, anion-exchange resins), polymers, activated alumina, alloys (e.g., copper-zinc alloys), molecular sieves, metal oxides (e.g., copper oxide, titanium dioxide), zeolites, salts (e.g., metal chloride salts, metal bicarbonate salts including sodium bicarbonate, sulfate salts), and MOFs.

Non-limiting examples of suitable cation-exchange resins include species comprising negatively-charged and/or acidic functional groups (e.g., sulfuric acid functional groups, sulfonic acid functional groups, and/or acrylic acid functional groups). For instance, some cation-exchange resins may comprise poly(styrene sulfonic acid) and/or poly(acrylic acid). Non-limiting examples of suitable anion-exchange resins include species comprising positively-charged and/or basic functional groups, such as amine functional groups (e.g., primary amine functional groups, secondary amine functional groups, tertiary amine functional groups, quaternary amine functional groups). For instance, some anion-exchange resins may comprise poly(ethyleneimine), poly(diallyl dimethyl ammonium chloride), and/or poly(4-vinylpyrridinium).

Suitable superabsorbent polymers may be capable of adsorbing one or more liquids (e.g., water) in an amount in excess of their weight. Non-limiting examples of suitable superabsorbent polymers include poly(acrylate), poly(acrylamide), carboxymethylcellulose, copolymers of the foregoing, and cross-linked networks formed from the foregoing.

In some embodiments, activated alumina suitable for inclusion in the filter media described herein is surface treated with a permanganate salt (e.g., sodium permanganate, potassium permanganate, both). The permanganate salt may make up at least 12 wt %, at least 15 wt %, or at least 17.5 wt % of the resultant material. In some embodiments, the permanganate salt makes up that at most 20 wt %, at most 17.5 wt %, or at most 15 wt % of the resultant material. Combinations of the above-referenced ranges are also possible (e.g., at least 12 wt % and at most 20 wt %). Other ranges are also possible.

Non-limiting examples of species (e.g., types of contaminants) that the adsorptive species may be capable of and/or configured to remove include volatile organic compounds (e.g., toluene, n-butane, SO₂, NOₓ), benzene, aldehydes (e.g., acetaldehyde, formaldehyde), acidic gases (e.g., H₂S, HCl, HF, HCN), basic gases (e.g., ammonia, amines such as trimethylamine and/or triethylamine), H₂, CO, N₂, sulfur, hydrocarbons, alcohols, O₃, water, and gaseous chemical weapons (e.g., nerve agents, mustard gases). Such species may be gaseous or may be liquids. Some of these contaminants may be unpleasantly odorous and some may be toxic. The contaminants may originate from a variety of sources (e.g., microbes, sewage, marshes, farm animals, power generation, fuel processing, plastic manufacturing, steel blast furnaces, the chemical and/or semiconductor industry, automotive combustion, food processing, office buildings, tobacco smoke).

Table 1, below, shows various adsorptive species and examples species they may be particularly suitable for adsorbing. It should be understood that Table 1 is non-limiting, that the adsorptive species listed in Table 1 may be configured for and/or capable of adsorbing other types of species than those listed in Table 1, and that the species listed in Table 1 may be configured to be adsorbed by and/or capable of being adsorbed by other types of adsorptive species than those listed in Table 1.

TABLE 1

| | Species Capable of Being Adsorbed |
|---|---|
| Adsorptive Species Type | and/or Configured to be Adsorbed |
| Coconut shell-derived activated carbon, not | Toluene, n-butane, SO₂, NOₓ, benzene, |
| surface treated | acetaldehyde, formaldehyde, H₂S |
| Coconut shell-derived activated carbon, | Acidic gases, SO₂, NOₓ, H₂S |
| surface treated with calcium carbonate | |
| Coconut shell-derived activated carbon, | H₂S |
| surface treated with potassium iodide | |
| Coconut shell-derived activated carbon, | Aldehydes |
| surface treated with tris-hydroxymethyl- | |
| aminomethane | |
| Coconut shell-derived activated carbon, | Ammonia, amines |
| surface treated with phosphoric acid | |
| Coconut shell-derived activated carbon, | Gaseous chemical weapons |
| surface treated with a transition metal and | |
| triethylenediamine | |
| Wood-derived activated carbon | Toluene, n-butane |
| Chemically-active carbon | SO₂, H₂S |
| Cation exchange resin comprising sulfonic | Ammonia, trimethylamine |
| acid functional groups | |
| Superabsorbent polymers | Water |
| Metal oxides | Acidic gases, SO₂, H₂S |
| Activated alumina, not surface treated | Acidic gases, SO₂, H₂S |
| Activated alumina, surface treated with 12 | Acidic gases, SO₂ |
| wt % sodium/potassium permanganate | |
| Copper-zinc alloy | Water impurities |
| Zeolites | SO₂, NH₃ |
| Sodium bicarbonate | SO₂ |

It should be understood that some, all, or none of the adsorptive species listed in Table 1 and described elsewhere herein may be present in the adsorptive layers described herein and that the adsorptive layers described herein may be suitable for adsorbing some, all, or none of the species listed in Table 1 and described elsewhere herein. In some embodiments, an adsorptive 5 layer comprises one type of adsorptive species, two types of adsorptive species, three types of adsorptive species, four types of adsorptive species, or even more types of adsorptive species.

Adsorptive species may have a relatively high basis weight. In some embodiments, the basis weight of the adsorptive species is greater than or equal to 70 gsm, greater than or equal to 80 gsm, greater than or equal to 90 gsm, greater than or equal to 100 gsm, greater than or equal 10 to 125 gsm, greater than or equal to 150 gsm, greater than or equal to 175 gsm, greater than or equal to 200 gsm, greater than or equal to 250 gsm, greater than or equal to 300 gsm, greater than or equal to 400 gsm, greater than or equal to 500 gsm, greater than or equal to 750 gsm, greater than or equal to 1000 gsm, greater than or equal to 1250 gsm, greater than or equal to 1500 gsm, or greater than or equal to 1750 gsm. In some embodiments, the basis weight of the adsorptive species is less than or equal to 2000 gsm, less than or equal to 1750 gsm, less than or equal to 1500 gsm, less than or equal to 1250 gsm, less than or equal to 1000 gsm, less than or equal to 750 gsm, less than or equal to 500 gsm, less than or equal to 400 gsm, less than or equal to 300 gsm, less than or equal to 250 gsm, less than or equal to 200 gsm, less than or equal to 175 gsm, less than or equal to 150 gsm, less than or equal to 125 gsm, less than or equal to 100 gsm, less than or equal to 90 gsm, or less than or equal to 80 gsm. Combinations of the above-referenced ranges are also possible (e.g., greater than or equal to 70 gsm and less than or equal to 2000 gsm, greater than or equal to 90 gsm and less than or equal to 1000 gsm, or greater than or equal to 90 gsm and less than or equal to 250 gsm). Other ranges are also possible.

The basis weight of the adsorptive species may be determined in accordance with ISO 536:2012.

When an adsorptive layer includes two or more types of adsorptive species, each type of adsorptive species may independently have a basis weight in one or more of the ranges described above and/or all of the adsorptive species in the adsorptive layer may together have a basis weight in one or more of the ranges described above. When a filter media comprises two or more adsorptive layers, the preceding may be true for each such layer independently.

Adsorptive species may take the form of particles that may have a variety of suitable average diameters. In some embodiments, the adsorptive particles have an average diameter of greater than or equal to 250 microns, greater than or equal to 300 microns, greater than or equal to 350 microns, greater than or equal to 400 microns, greater than or equal to 450 microns, greater than or equal to 500 microns, greater than or equal to 550 microns, greater than or equal to 600 microns, greater than or equal to 650 microns, greater than or equal to 700 microns, greater than or equal to 750 microns, greater than or equal to 800 microns, greater than or equal to 850 microns, greater than or equal to 900 microns, greater than or equal to 950 microns, greater than or equal to 1 mm, greater than or equal to 1.05 mm, greater than or equal to 1.1 mm, or greater than or equal to 1.15 mm. In some embodiments, the adsorptive particles have an average diameter of less than or equal to 1.2 mm, less than or equal to 1.15 mm, less than or equal to 1.05 mm, less than or equal to 1 mm, less than or equal to 950 microns, less than or equal to 900 microns, less than or equal to 850 microns, less than or equal to 800 microns, less than or equal to 750 microns, less than or equal to 700 microns, less than or equal to 650 microns, less than or equal to 600 microns, less than or equal to 550 microns, less than or equal to 500 microns, less than or equal to 450 microns, less than or equal to 400 microns, less than or equal to 350 microns, or less than or equal to 300 microns. Combinations of the above-referenced ranges are also possible (e.g., greater than or equal to 250 microns and less than or equal to 1.2 mm, or greater than or equal to 250 microns and less than or equal to 850 microns). Other ranges are also possible.

The average diameter of adsorptive particles may be determined in accordance with ASTM D2862 (2016).

When an adsorptive layer includes two or more types of adsorptive particles, each type of adsorptive particle may independently have an average diameter in one or more of the ranges described above and/or all of the adsorptive particles in the adsorptive layer may together have an average diameter in one or more of the ranges described above. When a filter media comprises two or more adsorptive layers, the preceding may be true for each such layer independently.

Some filter media may comprise two adsorptive layers comprising adsorptive species taking the form of particles, each of which comprises adsorptive particles having an average diameter in one or more of the ranges described above and having an average diameter different from that of the adsorptive particles in the other layer. For instance, in some embodiments, a filter media comprises first layer and second adsorptive layers comprising adsorptive particles, and the adsorptive particles in the first adsorptive layer have an average diameter that is greater than or equal to 150%, greater than or equal to 200%, greater than or equal to 250%, greater than or equal to 300%, greater than or equal to 350%, greater than or equal to 400%, or greater than or equal to 450% of the average diameter or adsorptive particles in the second adsorptive layer. In some embodiments, a filter media comprises first layer and second layers comprising adsorptive particles, and the adsorptive particles in the first adsorptive layer have an average diameter that is less than or equal to 500%, less than or equal to 450%, less than or equal to 400%, less than or equal to 350%, less than or equal to 300%, less than or equal to 250%, or less than or equal to 200% of the average diameter or adsorptive particles in the second adsorptive layer. Combinations of the above-referenced ranges are also possible (e.g., greater than or equal to 150% and less than or equal to 500%). Other ranges are also possible.

Adsorptive particles may have a variety of suitable specific surfaces areas. In some embodiments, an adsorptive layer comprises adsorptive particles having a specific surface area of greater than or equal to 1 m²/g, greater than or equal to 2 m²/g, greater than or equal to 5 m²/g, greater than or equal to 7.5 m²/g, greater than or equal to 10 m²/g, greater than or equal to 12.5 m²/g, greater than or equal to 15 m²/g, greater than or equal to 17.5 m²/g, greater than or equal to 20 m²/g, greater than or equal to 25 m²/g, greater than or equal to 30 m²/g, greater than or equal to 40 m²/g, greater than or equal to 50 m²/g, greater than or equal to 75 m²/g, greater than or equal to 100 m²/g, greater than or equal to 200 m²/g, greater than or equal to 500 m²/g, greater than or equal to 750 m²/g, greater than or equal to 1000 m²/g, greater than or equal to 1500 m²/g, greater than or equal to 2000 m²/g, greater than or equal to 2500 m²/g, greater than or equal to 3000 m²/g, greater than or equal to 3500 m²/g, greater than or equal to 4000 m²/g, greater than or equal to 4500 m²/g, or greater than or equal to 5000 m²/g. In some embodiments, an adsorptive layer comprises adsorptive particles having a specific surface area of less than or equal to 5500 m²/g, less than or equal to 5000 m²/g, less than or equal to 4500 m²/g, less than or equal to 4000 m²/g, less than or equal to 3500 m²/g, less than or equal to 3000 m²/g, less than or equal to 2500 m²/g, less than or equal to 2000 m²/g, less than or equal to 1500 m²/g, less than or equal to 1000 m²/g, less than or equal to 750 m²/g, less than or equal to 500 m²/g, less than or equal to 200 m²/g, less than or equal to 100 m²/g, less than or equal to 75 m²/g, less than or equal to 50 m²/g, less than or equal to 40 m²/g, less than or equal to 30 m²/g, less than or equal to 25 m²/g, less than or equal to 20 m²/g, less than or equal to 17.5 m²/g, less than or equal to 15 m²/g, less than or equal to 12.5 m²/g, less than or equal to 10 m²/g, less than or equal to 7.5 m²/g, less than or equal to 5 m²/g, or less than or equal to 2 m²/g. Combinations of the above-referenced ranges are also possible (e.g., greater than or equal to 1 m²/g and less than or equal to 5500 m²/g, greater than or equal to 20 m²/g and less than or equal to 3000 m²/g, or greater than or equal to 20 m²/g and less than or equal to 40 m²/g). Other ranges are also possible.

The specific surface area of adsorptive particles may be measured in accordance with ASTM D5742 (2016).

When an adsorptive layer includes two or more types of adsorptive particles, each type of adsorptive particle may independently have a specific surface area in one or more of the ranges described above and/or all of the adsorptive species in the adsorptive layer may together have a specific surface area in one or more of the ranges described above. When a filter media comprises two or more adsorptive layers, the preceding may be true for each such layer independently.

In some embodiments, a layer comprising adsorptive species further comprises multicomponent fibers. The multicomponent fibers may comprise bicomponent fibers (i.e., fibers including two components), and/or may comprise fibers comprising three or more components. Multicomponent fibers may have a variety of suitable structures. For instance, a layer comprising adsorptive species may comprise one or more of the following types of bicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the adsorptive species together while the core remains solid. In such embodiments, the multicomponent fibers may serve as a binder for the layer.

When present, multicomponent fibers may be included in an adsorptive layer in a variety of suitable amounts. In some embodiments, multicomponent fibers make up greater than or equal to 6 wt %, greater than or equal to 7 wt %, greater than or equal to 8 wt %, greater than or equal to 10 wt %, greater than or equal to 12.5 wt %, greater than or equal to 15 wt %, or greater than or equal to 17.5 wt % of an adsorptive layer. In some embodiments, multicomponent fibers make up less than or equal to 20 wt %, less than or equal to 17.5 wt %, less than or equal to 15 wt %, less than or equal to 12.5 wt %, less than or equal to 10 wt %, less than or equal to 8 wt %, or less than or equal to 7 wt % of an adsorptive layer. Combinations of the above-referenced ranges are also possible (e.g., greater than or equal to 6 wt % and less than or equal to 20 wt %). Other ranges are also possible.

When an adsorptive layer includes two or more types of multicomponent fiber, each type of multicomponent fiber may independently be present in one or more of the ranges described above and/or all of the multicomponent fibers in the adsorptive layer may together be present in one or more of the ranges described above. When a filter media comprises two or more adsorptive layers, the preceding may be true for each such layer independently.

Non-limiting examples of suitable materials that may be included in multicomponent fibers include polyolefins such as polyethylene, polypropylene, and polybutylene; polyesters and co-polyesters such as poly(ethylene terephthalate), co-poly(ethylene terephthalate), poly(butylene terephthalate), and poly(ethylene isophthalate); polyamides and co-polyamides such as nylons and aramids; and halogenated polymers such as polytetrafluoroethylene. Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Co-poly(ethylene terephthalate)s may include repeat units formed by polymerization of comonomers (e.g., monomers other than ethylene glycol and terephthalic acid) in a variety of suitable amounts. For instance, a co-poly(ethylene terephthalate) may be formed from a mixture of monomers in which the comonomer may make up greater than or equal to 0.5 mol %, greater than or equal to 0.75 mol %, greater than or equal to 1 mol %, greater than or equal to 1.5 mol %, greater than or equal to 2 mol %, greater than or equal to 3 mol %, greater than or equal to 5 mol %, greater than or equal to 7.5 mol %, greater than or equal to 10 mol %, or greater than or equal to 12.5 mol % of the total amount of monomers. The co-poly(ethylene terephthalate) may be formed from a mixture of monomers in which the comonomer makes up less than or equal to 15 mol %, less than or equal to 12.5 mol %, less than or equal to 10 mol %, less than or equal to 7.5 mol %, less than or equal to 5 mol %, less than or equal to 3 mol %, less than or equal to 2 mol %, less than or equal to 1.5 mol %, less than or equal to 1 mol %, or less than or equal to 0.75 mol % of the total amount of monomers. Combinations of the above-referenced ranges are also possible (e.g., greater than or equal to 0.5 mol % and less than or equal to 15 mol %). Other ranges are also possible.

In embodiments in which a co-poly(ethylene terephthalate) comprises two or more types of repeat units formed by polymerization of a comonomer, each type of repeat unit may independently make up a mol % of the total amount of monomers from which the co-poly(ethylene terephthalate) is formed in one or more of the ranges described above and/or all of the comonomers together may make up a mol % of the total amount of monomers from which the co-poly(ethylene terephthalate) is formed in one or more of the ranges described above.

Non-limiting examples of suitable pairs of materials that may be included in bicomponent fibers include polyethylene/poly(ethylene terephthalate), polypropylene/poly(ethylene terephthalate), co-poly(ethylene terephthalate)/poly(ethylene terephthalate), poly(butylene terephthalate)/poly(ethylene terephthalate), co-polyamide/polyamide, and polyethylene/polypropylene. In the preceding list, the material having the lower melting temperature is listed first and the material having the higher melting temperature is listed second.

Core-sheath bicomponent fibers comprising one of the above such pairs may have a sheath comprising the first material and a core comprising the second material.

In embodiments in which a layer comprises two or more types of bicomponent fibers, each type of bicomponent fiber may independently comprise one of the pairs of materials described above.

The multicomponent fibers described herein may comprise components having a variety of suitable melting points. In some embodiments, a multicomponent fiber comprises a component having a melting point of greater than or equal to 80° C. greater than or equal to 90° C., greater than or equal to 100° C., greater than or equal to 110° C., greater than or equal to 120° C., greater than or equal to 130° C., greater than or equal to 140° C. greater than or equal to 150° C., greater than or equal to 160° C., greater than or equal to 170° C., greater than or equal to 180° C., greater than or equal to 190° C., greater than or equal to 200° ° C., greater than or equal to 210° C., or greater than or equal to 220° C. In some embodiments, a multicomponent fiber comprises a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C. less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible. In some embodiments, a multicomponent fiber comprises a component having a melting point of less than or equal to 100° C.

The melting point of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

When present, multicomponent fibers may have a variety of suitable average diameters. In some embodiments, an adsorptive layer comprises multicomponent fibers having an average diameter of greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, or greater than or equal to 30 microns. In some embodiments, an adsorptive layer comprises multicomponent fibers having an average diameter of less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, or less than or equal to 12.5 microns. Combinations of the above-referenced ranges are also possible (e.g., greater than or equal to 10 microns and less than or equal to 32.5 microns). Other ranges are also possible.

When an adsorptive layer includes two or more types of multicomponent fibers, each type of multicomponent fiber may independently have an average fiber diameter in one or more of the ranges described above and/or all of the multicomponent fibers in the adsorptive layer may together have an average fiber diameter in one or more of the ranges described above. When a filter media comprises two or more adsorptive layers, the preceding may be true for each such layer independently.

When present, multicomponent fibers may have a variety of suitable deniers. In some embodiments, an adsorptive layer comprises multicomponent fibers having a denier of greater than or equal to 0.9, greater than or equal to 1, greater than or equal to 1.25, greater than or equal to 1.5, greater than or equal to 1.75, greater than or equal to 2, greater than or equal to 2.5, greater than or equal to 3, greater than or equal to 3.5, greater than or equal to 4, greater than or equal to 4.5, greater than or equal to 5, or greater than or equal to 5.5. In some embodiments, an adsorptive layer comprises multicomponent fibers having a denier of less than or equal to 6, less than or equal to 5.5, less than or equal to 5, less than or equal to 4.5, less than or equal to 4, less than or equal to 3.5, less than or equal to 3, less than or equal to 2.5, less than or equal to 2, less than or equal to 1.75, less than or equal to 1.5, less than or equal to 1.25, or less than or equal to 1. Combinations of the above-referenced ranges are also possible (e.g., greater than or equal to 0.9 and less than or equal to 6). Other ranges are also possible.

When an adsorptive layer includes two or more types of multicomponent fibers, each type of multicomponent fiber may independently have a denier in one or more of the ranges described above and/or all of the multicomponent fibers in the adsorptive layer may together have a denier in one or more of the ranges described above. When a filter media comprises two or more adsorptive layers, the preceding may be true for each such layer independently.

In some embodiments, an adsorptive layer comprises an adhesive. The adhesive may bond the adsorptive species together. In other words, it may serve as a binder for the layer. One example of a suitable adhesive is a polyurethane hot-melt adhesive. This adhesive may initially be provided as an uncross-linked material that cross-links upon exposure to moisture (e.g., water vapor). The final adsorptive layer may comprise the adhesive in a cross-linked form. Prior to cross-linking, the adhesive may have a viscosity of greater than or equal to 3500 Pas and less than or equal to 8000 Pa·s. This viscosity may be determined at 120° C. by use of a Brookfield Viscometer with a 27 spindle and at a shear rate of 20 min⁻¹. Further non-limiting examples of suitable adhesives include acrylics, polyurethanes, polyolefins, polyesters, polyamides, polyureas, and copolymers thereof. Such adhesives may also be hot-melt adhesives and/or may be cross-linkable. It is also possible for such adhesives to be supplied as a dispersion from which a solvent evaporates after application of the dispersion to produce a final, solid adhesive.

When present, adhesive may be included in an adsorptive layer in a variety of suitable amounts. In some embodiments, an adhesive makes up greater than or equal to 5 wt %, greater than or equal to 6 wt %, greater than or equal to 7 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 30 wt %, or greater than or equal to 35 wt % of an adsorptive layer. In some embodiments, an adhesive makes up less than or equal to 40 wt %, less than or equal to 35 wt %, less than or equal to 30 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 8 wt %, less than or equal to 7 wt %, or less than or equal to 6 wt % of an adsorptive layer. Combinations of the above-referenced ranges are also possible (e.g., greater than or equal to 5 wt % and less than or equal to 40 wt %, or greater than or equal to 7 wt % and less than or equal to 20 wt %). Other ranges are also possible.

When an adsorptive layer includes two or more types of adhesives, each type of adhesive may independently be present in one or more of the ranges described above and/or all of the adhesive in the adsorptive layer may together be present in one or more of the ranges described above. When a filter media comprises two or more adsorptive layers, the preceding may be true for each such layer independently.

In some embodiments, an adsorptive layer is non-fibrous. In other words, it may lack fibers and/or comprise fibers in relatively small amounts. In such embodiments, the adsorptive species may be bound together and/or held in the layer by components other than fibers. For instance, the adsorptive species may be bound together and/or held in the layer by adhesive and/or a melted component of a multicomponent fiber. It is also possible for a component binding adsorptive species together and/or holding them in a layer to also adhere them to a layer to which they are adjacent (e.g., a support layer).

As used herein, when a layer is referred to as being “on” or “adjacent” another layer, it can be directly on or adjacent the layer, or an intervening layer or material also may be present. A layer that is “directly on”, “directly adjacent” or “in contact with” another layer means that no intervening layer or material is present.

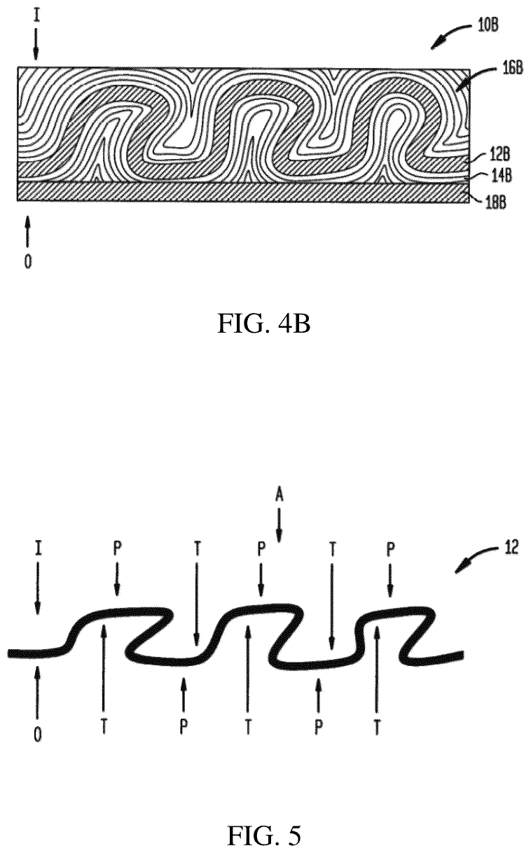

FIG. 3 shows one non-limiting example of a layer comprising adsorptive species (taking the form of adsorptive particles) and lacking fibers positioned between two other layers. In FIG. 3, the layer 306 comprises a plurality of adsorbent particles 308 and an adhesive 310. It is also possible for an adhesive layer to have a morphology similar to that of FIG. 3, but in which a melted component of a multicomponent fiber bonds the adsorptive species (e.g., particles) together instead of the adhesive shown in FIG. 3. In either case, it is apparent that, in some embodiments, the material binding the adsorptive species together is not fibrous. Instead, this material may have another morphology (e.g., it may comprise globules, as is shown in FIG. 3, or it may have another suitable non-fibrous morphology).

When present, a material binding together adsorptive species may have one or more similarities to the adhesive shown in FIG. 3 and/or may differ from the adhesive shown in FIG. 3 in one or more ways. For instance, the material binding together the adsorptive species may have a relatively uniform morphology throughout the layer (e.g., it may comprise particles of a relatively uniform size) or may comprise components that differ across the layer (e.g., it may comprise particles of varying size). As another example, the material binding together the adsorptive species may have a relatively uniform density across the layer or may be distributed across the layer such that some regions of the layer are richer in the material in comparison to other regions of the layer. As a third example, the relative size of a material binding together adsorptive species with respect to the adsorptive species may be similar to the relative size of the adhesive to the adsorptive particles shown in FIG. 3 or may differ from the relative size of the adhesive to the adsorptive particles shown in FIG. 3.

Similarly, an adsorptive layer may comprise adsorptive species similar to the adsorptive particles shown in FIG. 3 in one or more ways and/or different from the adsorptive particles shown in FIG. 3 in one or more ways. For instance, an adsorptive layer may comprise particles that have a morphology similar to those shown in FIG. 3 or may differ in shape from those shown in FIG. 3 or may be non-particulate. As another example, the adsorptive species may have a size and/or shape uniformity similar to the adsorptive particles shown in FIG. 3 or may be more or less uniform than the adsorptive particles shown in FIG. 3. As a third example, the adsorptive species may have a relatively uniform density across the layer or may be distributed across the layer such that some regions of the layer are richer in the adsorptive species in comparison to other regions of the layer.

In some embodiments, fibers make up less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 4 wt %, less than or equal to 2 wt %, or less than or equal to 1 wt % of an adsorptive layer. In some embodiments, fibers make up greater than or equal to 0 wt %, greater than or equal to 1 wt %, greater than or equal to 2 wt %, greater than or equal to 4 wt %, greater than or equal to 6 wt %, greater than or equal to 8 wt %, greater than or equal to 10 wt %, greater than or equal to 12.5 wt %, greater than or equal to 15 wt %, or greater than or equal to 17.5 wt % of an adsorptive layer. Combinations of the above-referenced ranges are also possible (e.g., less than or equal to 20 wt % and greater than or equal to 0 wt %, or less than or equal to 20 wt % and greater than or equal to 6 wt %). Other ranges are also possible. In some embodiments, fibers make up 0 wt % of an adsorptive layer (i.e., the adsorptive layer is non-fibrous).

When an adsorptive layer includes two or more types of fibers, each type of fiber may independently be present in one or more of the ranges described above and/or all of the fibers in the adsorptive layer may together be present in one or more of the ranges described above. When a filter media comprises two or more adsorptive layers, the preceding may be true for each such layer independently.

Adsorptive layers may have a relatively high adsorption efficiency. In some embodiments, an adsorptive layer has an adsorption efficiency of greater than or equal to 0%, greater than or equal to 1%, greater than or equal to 2%, greater than or equal to 5%, greater than or equal to 7.5%, greater than or equal to 10%, greater than or equal to 12.5%, greater than or equal to 15%, greater than or equal to 17.5%, greater than or equal to 20%, greater than or equal to 25%, greater than or equal to 30%, greater than or equal to 35%, greater than or equal to 40%, greater than or equal to 45%, greater than or equal to 50%, greater than or equal to 60%, or greater than or equal to 80%. In some embodiments, an adsorptive layer has an adsorption efficiency of less than or equal to 100%, less than or equal to 80%, less than or equal to 60%, less than or equal to 50%, less than or equal to 45%, less than or equal to 40%, less than or equal to 35%, less than or equal to 30%, less than or equal to 25%, less than or equal to 20%, less than or equal to 17.5%, less than or equal to 15%, less than or equal to 12.5%, less than or equal to 10%, less than or equal to 7.5%, less than or equal to 5%, less than or equal to 2%, or less than or 5 equal to 1%. Combinations of the above-referenced ranges are also possible (e.g., greater than or equal to 0% and less than or equal to 30%, greater than or equal to 0% and less than or equal to 50%, or greater than or equal to 0% and less than or equal to 100%). Other ranges are also possible.

The adsorption efficiency of an adsorptive layer may be measured in accordance with ISO 11155-2 (2009).

In embodiments in which a layer comprises two or more types of adsorptive species, each type of adsorptive species may independently have an adsorption efficiency for one or more species (e.g., volatile organic compounds (e.g., toluene, n-butane, SO₂, NOx), benzene, aldehydes (e.g., acetaldehyde, formaldehyde), acidic gases (e.g., H₂S, HCl, HF, HCN), basic gases (e.g., ammonia, amines such as trimethylamine and/or tricthylamine), H₂, CO, N₂, sulfur, hydrocarbons, alcohols, O₃, water, and gaseous chemical weapons (e.g., nerve agents, mustard gases)) in one or more of the ranges described above. In some embodiments, all of the adsorptive species in a layer together have an adsorption efficiency for one or more species (e.g., volatile organic compounds (e.g., toluene, n-butane, SO₂, NOx), benzene, aldehydes (e.g., acetaldehyde, formaldehyde), acidic gases (e.g., H₂S, HCl, HF, HCN), basic gases (e.g., ammonia, amines such as trimethylamine and/or tricthylamine), H₂, CO, N₂, sulfur, hydrocarbons, alcohols, O₃, water, and gaseous chemical weapons (e.g., nerve agents, mustard gases)) in one or more of the ranges described above. When a filter media comprises two or more adsorptive layers, the preceding may be true for each such layer independently.

An adsorptive layer may exhibit a relatively low break through for one or more species. In some embodiments, the break through is less than or equal to 90%, less than or equal to 80%, less than or equal to 70%, less than or equal to 60%, less than or equal to 50%, less than or equal to 40%, less than or equal to 30%, or less than or equal to 20% for one or more species. In some embodiments, the break through is greater than or equal to 10%, greater than or equal to 20%, greater than or equal to 30%, greater than or equal to 40%, greater than or equal to 50%, greater than or equal to 60%, greater than or equal to 70%, or greater than or equal to 80% for one or more species. Combinations of the above-referenced ranges are also possible (e.g., less than or equal to 90% and greater than or equal to 10%). Other ranges are also possible.

The break through of an adsorptive layer for any particular species is the percentage of that species that passes through the adsorptive layer. This may be determined in accordance with ISO 11155-2 (2009) on a flat sheet sample of the layer. Briefly, the method comprises: (1) drying the flat sheet at 60° C. in a drying cabinet until the filter mass is observed to have a mass that is stable to ±2%; (2) conditioning the flat sheet in a climactic chamber at 23° C. and at a relative humidity of 50% for 14 hours; (3) placing the flat sheet on a test stand and exposing it to clean air for 15 minutes; (4) exposing the flat sheet to a flow of air having 40% relative humidity and comprising the relevant species (i.e., the species whose break through is being assessed) and then measuring the amount of the relevant species in the flow of air after passing through the flat sheet by use of a gas analyzer. The air flow may have a face velocity of 20 cm/s and a temperature of 23° C. The measurement may be made until the concentration of the relevant species in the air after passing through the flat sheet is 95% of the concentration of the relevant species in the air prior to passing through the flat sheet or for a predetermined time. Unless otherwise specified, the measurement is performed for 0 minutes (i.e., the point in time at which the flow has reached steady-state through the flat sheet) and the concentration of the relevant species in the flow of air prior to passing through the flat sheet is 80 ppm. Specifically, for the ranges above, the measurement time is 0 minutes and the concentration of the relevant species in the flow of air prior to passing through the flat sheet 80 ppm. The break through is equal to 100% multiplied by the ratio of the amount of the relevant species in the air that passed through the flat sheet (in ppm) to the initial amount of the relevant species in the air prior to passing through the flat sheet (in ppm).

The adsorptive layers may have a break-through in one or more of the ranges in the preceding paragraph for one or more of the following species: volatile organic compounds (e.g., toluene, n-butane, SO₂, NOₓ), benzene, aldehydes (e.g., acetaldehyde, formaldehyde), acidic gases (e.g., H₂S, HCl, HF, HCN), basic gases (e.g., ammonia, amines such as trimethylamine and/or triethylamine), H₂, CO, N₂, sulfur, hydrocarbons, alcohols, O₃, water, and gaseous chemical weapons (e.g., nerve agents, mustard gases). When a filter media comprises two or more adsorptive layers, the preceding may be true for each such layer independently.

An adsorptive layer may be able to provide relatively high values of cumulate clean mass from a fluid initially comprising formaldehyde. For instance, an adsorptive layer may have a grade of F1 (i.e., it may be capable of providing a cumulate clean mass of greater than or equal to 300 mg per weight of adsorptive layer in mg and less than 600 mg per weight of adsorptive layer), F2 (i.e., it may be capable of providing a cumulate clean mass of greater than or equal to 600 mg per weight of adsorptive layer in mg and less than 1 g per weight of adsorptive layer in mg), F3 (i.e., it may be capable of providing a cumulate clean mass of greater than or equal to 1 g per weight of adsorptive layer in mg and less than 1.5 g per weight of adsorptive layer in mg), or F4 (i.e., it may be capable of providing a cumulate clean mass of greater than or equal to 1.5 g per weight of adsorptive layer in mg).

The rating of the adsorptive layer may be determined in accordance with GB/T 18801-2015. Briefly, this process comprises injecting formaldehyde gas at 20 mg/hour into a 3 m³ chamber comprising the adsorptive layer, recording the concentration of formaldehyde in the chamber every five minutes until one hour has elapsed, and then multiplying the rate of formaldehyde adsorption by the formaldehyde flow rate.

When a filter media comprises two or more adsorptive layers, each such adsorptive layer may independently have one or more of the above-referenced grades.

An adsorptive layer may be able to provide relatively high values of cumulate clean mass from a fluid initially comprising benzene. For instance, the adsorptive layer may have a grade of B1 (i.e., it may be capable of providing a cumulate clean mass of greater than or equal to 300 mg per weight of adsorptive layer in mg and less than 600 mg per weight of adsorptive layer in mg), B2 (i.e., it may be capable of providing a cumulate clean mass of greater than or equal to 600 mg per weight of adsorptive layer in mg and less than 1 g per weight of adsorptive layer in mg), B3 (i.e., it may be capable of providing a cumulate clean mass of greater than or equal to 1 g per weight of adsorptive layer in mg and less than 1.5 g per weight of adsorptive layer in mg), or B4 (i.e., it may be capable of providing a cumulate clean mass of greater than or equal to 1.5 g per weight of adsorptive layer in mg).

The rating of the adsorptive layer may be determined in accordance with GB/T 18801-2015. Briefly, this process comprises injecting benzene gas at 20 mg/hour into a 3 m³ chamber comprising the layer, recording the concentration of benzene in the chamber every five minutes until one hour has elapsed, and then multiplying the rate of benzene adsorption by the benzene flow rate.

When a filter media comprises two or more adsorptive layers, each such adsorptive layer may independently have one or more of the above-referenced grades

An adsorptive layer may have a relatively high clean air delivery rate from a fluid initially comprising formaldehyde. The clean air delivery rate from a fluid initially comprising formaldehyde may be greater than or equal to 10 m³/hour, greater than or equal to 20 m³/hour, greater than or equal to 50 m³/hour, greater than or equal to 75 m³/hour, greater than or equal to 100 m³/hour, greater than or equal to 150 m³/hour, greater than or equal to 200 m³/hour, greater than or equal to 250 m³/hour, greater than or equal to 300 m³/hour, greater than or equal to 400 m³/hour, greater than or equal to 500 m³/hour, or greater than or equal to 600 m³/hour. The clean air delivery rate from a fluid initially comprising formaldehyde may be less than or equal to 700 m³/hour, less than or equal to 600 m³/hour, less than or equal to 500 m³/hour, less than or equal to 400 m³/hour, less than or equal to 300 m³/hour, less than or equal to 250 m³/hour, less than or equal to 200 m³/hour, less than or equal to 150 m³/hour, less than or equal to 100 m³/hour, less than or equal to 75 m³/hour, less than or equal to 50 m³/hour, or less than or equal to 20 m³/hour. Combinations of the above-referenced ranges are also possible (e.g., greater than or equal to 10 m³/hour and less than or equal to 700 m³/hour). Other ranges are also possible.

The clean air delivery rate from a fluid initially comprising formaldehyde for an adsorptive layer may be determined in accordance with GB/T 18801-2015. Briefly, this process comprises: (1) pumping 1 mg/m³ of formaldehyde into a 1 m³ closed chamber containing the adsorptive layer and then measuring the concentration of formaldehyde every 5 minutes for 60 minutes; (2) pumping 1 mg/m³ of formaldehyde into a 1 m³ closed chamber lacking the adsorptive layer and then measuring the concentration of formaldehyde every 5 minutes for 60 minutes; (3) identifying the difference between the formaldehyde removed from the chamber containing the adsorptive layer and the formaldehyde removed from the chamber lacking the adsorptive layer as the volume of formaldehyde removed; and (4) dividing the volume of formaldehyde removed by 60 minutes to yield the clean air delivery rate.

When a filter media comprises two or more adsorptive layers, each adsorptive layer may independently have a clean air delivery rate from a fluid initially comprising formaldehyde in one or more of the above-referenced ranges.

An adsorptive layer may have a relatively high clean air delivery rate from a fluid initially comprising benzene. The clean air delivery rate from a fluid initially comprising benzene may be greater than or equal to 10 m³/hour, greater than or equal to 20 m³/hour, greater than or equal to 50 m³/hour, greater than or equal to 75 m³/hour, greater than or equal to 100 m³/hour, greater than or equal to 150 m³/hour, greater than or equal to 200 m³/hour, greater than or equal to 250 m³/hour, greater than or equal to 300 m³/hour, greater than or equal to 400 m³/hour, greater than or equal to 500 m³/hour, or greater than or equal to 600 m³/hour. The clean air delivery rate from a fluid initially comprising benzene may be less than or equal to 700 m³/hour, less than or equal to 600 m³/hour, less than or equal to 500 m³/hour, less than or equal to 400 m³/hour, less than or equal to 300 m³/hour, less than or equal to 250 m³/hour, less than or equal to 200 m³/hour, less than or equal to 150 m³/hour, less than or equal to 100 m³/hour, less than or equal to 75 m³/hour, less than or equal to 50 m³/hour, or less than or equal to 20 m³/hour. Combinations of the above-referenced ranges are also possible (e.g., greater than or equal to 10 m³/hour and less than or equal to 700 m³/hour). Other ranges are also possible.

The clean air delivery rate from a fluid initially comprising benzene for an adsorptive layer may be determined in accordance with GB/T 18801-2015. Briefly, this process comprises: (1) pumping 1 mg/m³ of benzene into a 1 m³ closed chamber containing the adsorptive layer and then measuring the concentration of benzene every 5 minutes for 60 minutes; (2) pumping 1 mg/m³ of benzene into a 1 m³ closed chamber lacking the adsorptive layer and then measuring the concentration of benzene every 5 minutes for 60 minutes; (3) identifying the difference between the benzene removed from the chamber containing the adsorptive layer and the benzene removed from the chamber lacking the adsorptive layer as the volume of benzene removed; and (4) dividing the volume of benzene removed by 60 minutes to yield the clean air delivery rate.

When a filter media comprises two or more adsorptive layers, each adsorptive layer may independently have a clean air delivery rate from a fluid initially comprising benzene in one or more of the above-referenced ranges.

Adsorptive layers may have a variety of suitable basis weights. In some embodiments, an adsorptive layer has a basis weight of greater than or equal to 120 gsm, greater than or equal to 150 gsm, greater than or equal to 175 gsm, greater than or equal to 200 gsm, greater than or equal to 225 gsm, greater than or equal to 250 gsm, greater than or equal to 300 gsm, greater than or equal to 400 gsm, greater than or equal to 500 gsm, greater than or equal to 600 gsm, greater than or equal to 700 gsm, greater than or equal to 800 gsm, greater than or equal to 900 gsm, greater than or equal to 1000 gsm, greater than or equal to 1100 gsm, greater than or equal to 1200 gsm, greater than or equal to 1500 gsm, or greater than or equal to 1750 gsm. In some embodiments, an adsorptive layer has a basis weight of less than or equal to 2000 gsm, less than 5 or equal to 1750 gsm, less than or equal to 1500 gsm, less than or equal to 1200 gsm, less than or equal to 1100 gsm, less than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 250 gsm, less than or equal to 225 gsm, less than or equal to 200 gsm, less than or equal to 175 gsm, or less than or equal to 150 gsm. Combinations of the above-referenced ranges are also possible (e.g., greater than or equal to 120 gsm and less than or equal to 2000 gsm, or greater than or equal to 120 gsm and less than or equal to 1100 gsm). Other ranges are also possible.

The basis weight of an adsorptive layer may be determined in the same manner described above for the basis weight of a non-woven fiber web having high performance.

When a filter media comprises two or more adsorptive layers, each adsorptive layer may independently have a basis weight in one or more of the above-referenced ranges.

Adsorptive layers may have a variety of suitable thicknesses. In some embodiments, an adsorptive layer has a thickness of greater than or equal to 0.5 mm, greater than or equal to 0.75 mm, greater than or equal to 1 mm, greater than or equal to 1.25 mm, greater than or equal to 1.5 mm, greater than or equal to 1.75 mm, greater than or equal to 2 mm, greater than or equal to 2.25 mm, greater than or equal to 2.5 mm, greater than or equal to 2.75 mm, greater than or equal to 3 mm, greater than or equal to 3.5 mm, greater than or equal to 4 mm, greater than or equal to 4.5 mm, greater than or equal to 5 mm, greater than or equal to 6 mm, or greater than or equal to 7 mm. In some embodiments, an adsorptive layer has a thickness of less than or equal to 8 mm, less than or equal to 7 mm, less than or equal to 6 mm, less than or equal to 5 mm, less than or equal to 4.5 mm, less than or equal to 4 mm, less than or equal to 3.5 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, or less than or equal to 0.75 mm. Combinations of the above-referenced ranges are also possible (e.g., greater than or equal to 0.5 mm and less than or equal to 8 mm, greater than or equal to 0.5 mm and less than or equal to 5 mm, or greater than or equal to 0.5 mm and less than or equal to 2.5 mm). Other ranges are also possible.

The thickness of an adsorptive layer may be determined in accordance with ASTM D1777 (2015) under an applied pressure of 0.8 kPa.

In some embodiments, an adsorptive layer and a support layer on which it is disposed together have a thickness in one or more of the ranges in the preceding paragraph. In some embodiments, an adsorptive layer has a thickness in one or more of the ranges in the preceding paragraph and it is disposed on a support layer. When a filter media comprises two or more adsorptive layers, the preceding may be true for each such layer independently.

In some embodiments, a filter media comprises a non-woven fiber web comprising nanofibers. The non-woven fiber web comprising nanofibers may enhance the filtration performance of the filter media and/or may serve as an efficiency layer. It is also possible for a filter media to comprise two or more non-woven fiber webs comprising nanofibers. Such non-woven fiber webs may be the same or may differ in one or more ways.

When present, a non-woven fiber web comprising nanofibers may have a variety of suitable morphologies. For instance, the non-woven fiber web comprising nanofibers may be an electrospun non-woven fiber web, a meltblown non-woven fiber web, a centrifugal spun non-woven fiber web, an electroblown spun non-woven fiber web, or a fibrillated spun non-woven fiber web. In some embodiments, a non-woven fiber web is disposed (e.g., directly or indirectly) on a carrier. Non-limiting examples of suitable carriers include spunbond layers, wetlaid backers, carded backers, meltblown non-woven fiber webs, a meltblown non-woven fiber web disposed on a spunbond layer, and a calendered meltblown layer.

The fibers present in a non-woven fiber web comprising nanofibers may be of a variety of suitable types. In some embodiments, a non-woven fiber web comprising nanofibers includes fibers comprising one or more of: polyether-b-polyamide, polysulfone, polyamides (e.g., nylons, such as nylon 6), polyesters (e.g., polycaprolactone, poly(butylene terephthalate)), polyurethanes, polyureas, acrylics, polymers comprising a side chain comprising a carbonyl functional group (e.g., poly(vinyl acetate), cellulose ester, polyacrylamide), poly(ether sulfone), polyacrylics (e.g., polyacrylonitrile, poly(acrylic acid)), fluorinated polymers (e.g., poly(vinylidene difluoride)), polyols (e.g., poly(vinyl alcohol)), polyethers (e.g., poly(ethylene oxide)), poly(vinyl pyrrolidone), polyallylamine, butyl rubber, polyethylene, polymers comprising a silane functional group, polymers comprising a thiol functional group, and polymers comprising a methylol functional group (e.g., phenolic polymers, melamine polymers, melamine-formaldehyde polymers, cross-linkable polymers comprising pendant methylol groups).

In some embodiments, a non-woven fiber web comprising nanofibers comprises fibers that comprise both a matrix polymer and an impact modifier. The presence of a matrix polymer and an impact modifier may enhance one or more mechanical properties of the non-woven web comprising nanofibers (e.g., elongation at break, tensile strength, toughness, puncture strength, durability during pleating).

Non-limiting examples of suitable matrix polymers include synthetic polymers, such as polyamides (e.g., Nylons, such as Nylon 6 (also known as polyamide 6)), polyesters (e.g., polycaprolactone, poly(butylene terephthalate)), polyurethanes, polyureas, acrylics, polymers comprising a side chain comprising a carbonyl functional group (e.g., poly(vinyl acetate), cellulose, cellulose ester, polyacrylamide), poly(ether sulfone), polyacrylics (e.g., polyacrylonitrile, poly(acrylic acid)), polystyrene, polycarbonates, polyvinyl chloride, polysulfone, poly(amic acid), fluorinated polymers (e.g., poly(vinylidene difluoride)), polyols (e.g., poly(vinyl alcohol)), polyethers (e.g., poly(ethylene oxide)), poly(vinyl pyrrolidone), polyallylamine, butyl rubber, polyethylene, polymers comprising a silane functional group, polymers comprising a thiol functional group, polymers comprising a methylol functional group (e.g., phenolic polymers, melamine polymers, melamine-formaldehyde polymers, cross-linkable polymers comprising pendant methylol groups), and/or combinations thereof. In some embodiments, the matrix polymer comprising a copolymer of two or more of the polymers listed above and/or a blend of two or more of the polymers listed above (e.g., a blend of a polyamide and a polyester). In certain embodiments, the matrix polymer is a glassy polymer and/or a semicrystalline polymer.

In certain embodiments, an impact modifier comprises a copolymer comprising at least two different monomers, wherein at least one monomer has affinity to the matrix polymer and wherein at least one monomer does not have affinity to the matrix polymer. As used herein, a copolymer is a polymer derived from at least two different species of monomers.

In some embodiments, a monomer has affinity to the matrix polymer when it is the same as a monomer of the matrix polymer, when it is miscible with the matrix polymer, when it comprises reactive sites that will covalently bond with the matrix polymer, when it is subject to ionic interactions with the matrix polymer, and/or when the total solubility parameter of the monomer is similar to that of a monomer of the matrix polymer. Whether covalent bonds are formed and whether ionic interactions are present may be determined by spectroscopy techniques, such as FTIR.

According to some embodiments, the impact modifier and/or a monomer thereof comprises a polyamide (e.g., polyamide 6, polyamide 11, and/or polyamide 6,6), a polystyrene, a polyether, a polypropylene, a polycarbonate, a polyethylene, a polyester, ABS (acrylonitrile butadiene styrene), and/or PVC (polyvinyl chloride). Examples of suitable impact modifiers include the impact modifiers in Table 2.

TABLE 2

| Type of | | | Suitable | Type of |
|---|---|---|---|---|
| impact | Type of | | matrix | interaction |
| modifier | copolymer | Monomers/repeat units | polymers | with matrix |
| styrenic | block | 1. Styrene | polystyrene | like monomers |
| | | 2. olefin rubber (e.g., | polypropylene | |
| | | isoprene, butadiene, | | |
| | | hydrogenated isoprene, | | |
| | | hydrogenated butylene) | | |
| maleated | random/ | 1. maleic anhydride | polyamide | polar interaction |
| | graft | 2. ethylene | polycarbonate | chemical reaction |
| ethylene- | random | 1. ethylene, propylene | polyethylene | like monomers |
| acrylate | | 2. acrylic (e.g., butyl, | polypropylene | miscibility |
| terpolymer | | ethyl, or methyl acrylates) | polyester | polar interaction |
| | | 3. glycidyl methacrylate | polyamide | reaction |
| | | | ABS | |
| polyamide | random | 1. mixed amide monomers | polyamide | like monomers |
| terpolymer | | | | |
| PEBA | block | 1. amides | polyamide | like monomers |
| | | 2. ether | | |
| ionomers | random | 1. ethylene | polyamide | polar interaction |
| | | 2. acrylic acid salt | | chemical reaction |
| chlorinated | random/ | 3. vinyl chloride | PVC | like monomers |
| polyethylene | graft | 4. ethylene | | |

Non-woven fiber webs comprising nanofibers may comprise fibers having a variety of suitable average fiber diameters. In some embodiments, the fibers in a non-woven fiber web comprising nanofibers have an average fiber diameter of greater than or equal to 50 nm, greater than or equal to 55 nm, greater than or equal to 60 nm, greater than or equal to 65 nm, greater than or equal to 70 nm, greater than or equal to 75 nm, greater than or equal to 80 nm, greater than or equal to 85 nm, greater than or equal to 90 nm, greater than or equal to 95 nm, greater than or equal to 100 nm, greater than or equal to 105 nm, greater than or equal to 110 nm, greater than or equal to 115 nm, greater than or equal to 120 nm, greater than or equal to 125 nm, greater than or equal to 130 nm, greater than or equal to 140 nm, greater than or equal to 150 nm, greater than or equal to 175 nm, greater than or equal to 200 nm, greater than or equal to 225 nm, greater than or equal to 250 nm, or greater than or equal to 275 nm. In some embodiments, the fibers in a non-woven fiber web comprising nanofibers have an average fiber diameter of less than or equal to 300 nm, less than or equal to 275 nm, less than or equal to 250 nm, less than or equal to 225 nm, less than or equal to 200 nm, less than or equal to 175 nm, less than or equal to 150 nm, less than or equal to 140 nm, less than or equal to 130 nm, less than or equal to 125 nm, less than or equal to 120 nm, less than or equal to 115 nm, less than or equal to 110 nm, less than or equal to 105 nm, less than or equal to 100 nm, less than or equal to 95 nm, less than or equal to 90 nm, less than or equal to 85 nm, less than or equal to 80 nm, less than or equal to 75 nm, less than or equal to 70 nm, less than or equal to 65 nm, less than or equal to 60 nm, or less than or equal to 55 nm. Combinations of the above-referenced ranges are also possible (e.g., greater than or equal to 50 nm and less than or equal to 300 nm, greater than or equal to 60 nm and less than or equal to 200 nm, or greater than or equal to 80 nm and less than or equal to 120 nm). Other ranges are also possible.

When a non-woven fiber web comprising nanofibers includes two or more types of fibers, each type of fiber may independently have an average fiber diameter in one or more of the ranges described above and/or all of the fibers in the non-woven fiber web comprising nanofibers may together have an average fiber diameter in one or more of the ranges described above. When a filter media comprises two or more non-woven fiber webs comprising nanofibers, the preceding may be true for each such non-woven fiber web independently.

A non-woven fiber web comprising nanofibers may have a variety of suitable basis weights. In some embodiments, a non-woven fiber web comprising nanofibers has a basis weight of greater than or equal to 0.01 gsm, greater than or equal to 0.02 gsm, greater than or equal to 0.03 gsm, greater than or equal to 0.04 gsm, greater than or equal to 0.05 gsm, greater than or equal to 0.06 gsm, greater than or equal to 0.08 gsm, greater than or equal to 0.1 gsm, greater than or equal to 0.2 gsm, greater than or equal to 0.5 gsm, greater than or equal to 0.75 gsm, greater than or equal to 1 gsm, greater than or equal to 1.25 gsm, greater than or equal to 1.5 gsm, greater than or equal to 1.75 gsm, greater than or equal to 2 gsm, greater than or equal to 2.5 gsm, greater than or equal to 3 gsm, greater than or equal to 3.5 gsm, greater than or equal to 4 gsm, or greater than or equal to 4.5 gsm. In some embodiments, a non-woven fiber web comprising nanofibers has a basis weight of less than or equal to 5 gsm, less than or equal to 4.5 gsm, less than or equal to 4 gsm, less than or equal to 3.5 gsm, less than or equal to 3 gsm, less than or equal to 2.5 gsm, less than or equal to 2 gsm, less than or equal to 1.75 gsm, less than or equal to 1.5 gsm, less than or equal to 1.25 gsm, less than or equal to 1 gsm, less than or equal to 0.75 gsm, less than or equal to 0.5 gsm, less than or equal to 0.2 gsm, less than or equal to 0.1 gsm, less than or equal to 0.08 gsm, less than or equal to 0.06 gsm, less than or equal to 0.05 gsm, less than or equal to 0.04 gsm, less than or equal to 0.03 gsm, or less than or equal to 0.02 gsm. Combinations of the above-referenced ranges are also possible (e.g., greater than or equal to 0.01 gsm and less than or equal to 5 gsm, greater than or equal to 0.03 gsm and less than or equal to 4 gsm, or greater than or equal to 0.05 gsm and less than or equal to 2 gsm). Other ranges are also possible.

The basis weight of a non-woven fiber web comprising nanofibers may be determined in the same manner described above for the basis weight of a non-woven fiber web having high performance.

When a filter media comprises two or more non-woven fiber webs comprising nanofibers, each non-woven fiber web comprising nanofibers may independently have a basis weight in one or more of the above-referenced ranges.

Non-woven fiber webs comprising nanowires may have a variety of suitable thicknesses. In some embodiments, a non-woven fiber web comprising nanofibers has a thickness of greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.8 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, or greater than or equal to 80 microns. In some embodiments, a non-woven fiber web comprising nanofibers has a thickness of less than or equal to 100 microns, less than or equal to 80 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.8 microns, less than or equal to 0.6 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.1 micron. Combinations of the above-referenced ranges are also possible (e.g., greater than or equal to 0.1 micron and less than or equal to 100 microns, greater than or equal to 0.2 microns and less than or equal to 50 microns, or greater than or equal to 0.5 microns and less than or equal to 10 microns). Other ranges are also possible.

The thickness of a nanofiber layer may be determined by cross-sectional scanning electron microscopy.

When a filter media comprises two or more non-woven fiber webs comprising nanofibers, each non-woven fiber web comprising nanofibers may independently have a thickness in one or more of the above-referenced ranges.

Non-woven fiber webs comprising nanofibers may have a variety of suitable solidities. In some embodiments, a non-woven fiber web comprising nanofibers has a solidity of greater than or equal to 0.1%, greater than or equal to 0.2%, greater than or equal to 0.3%, greater than or equal to 0.4%, greater than or equal to 0.5%, greater than or equal to 0.6%, greater than or equal to 0.8%, greater than or equal to 1%, greater than or equal to 2%, greater than or equal to 5%, greater than or equal to 7.5%, greater than or equal to 10%, greater than or equal to 12.5%, greater than or equal to 15%, greater than or equal to 20%, or greater than or equal to 25%. In some embodiments, a non-woven fiber web comprising nanofibers has a solidity of less than or equal to 30%, less than or equal to 25%, less than or equal to 20%, less than or equal to 15%, less than or equal to 12.5%, less than or equal to 10%, less than or equal to 7.5%, less than or equal to 5%, less than or equal to 2%, less than or equal to 1%, less than or equal to 0.8%, less than or equal to 0.6%, less than or equal to 0.5%, less than or equal to 0.4%, less than or equal to 0.3%, or less than or equal to 0.2%. Combinations of the above-referenced ranges are also possible (e.g., greater than or equal to 0.1% and less than or equal to 30%, greater than or equal to 0.5% and less than or equal to 20%, or greater than or equal to 1% and less than or equal to 10%). Other ranges are also possible.

The solidity of a non-woven fiber web comprising nanofibers may be determined in the same manner described above for the solidity of a non-woven fiber web having high performance.

When a filter media comprises two or more non-woven fiber webs comprising nanofibers, each non-woven fiber web comprising nanofibers may independently have a solidity in one or more of the above-referenced ranges.

Non-woven fiber webs comprising nanofibers may have a variety of suitable air permeabilities. In some embodiments, a non-woven fiber web comprising nanofibers has an air permeability of greater than or equal to 10 (CFM), greater than or equal to 20 CFM, greater than or equal to 30 CFM, greater than or equal to 40 CFM, greater than or equal to 50 CFM, greater than or equal to 60 CFM, greater than or equal to 70 CFM, greater than or equal to 80 CFM, greater than or equal to 100 CFM, greater than or equal to 125 CFM, or greater than or equal to 150 CFM. In some embodiments, a non-woven fiber web comprising nanofibers has an air permeability of less than or equal to 170 CFM, less than or equal to 150 CFM, less than or equal to 125 CFM, less than or equal to 100 CFM, less than or equal to 80 CFM, less than or equal to 60 CFM, less than or equal to 50 CFM, less than or equal to 40 CFM, less than or equal to 30 CFM, or less than or equal to 20 CFM. Combinations of the above-referenced ranges are also possible (e.g., greater than or equal to 10 CFM and less than or equal to 170 CFM, greater than or equal to 30 CFM and less than or equal to 80 CFM, or greater than or equal to 40 CFM and less than or equal to 70 CFM). Other ranges are also possible.

The air permeability of a non-woven fiber web comprising nanofibers may be determined in the same manner as that described above for determining the air permeability of a non-woven fiber web having high performance.

When a filter media comprises two or more non-woven fiber webs comprising nanofibers, each non-woven fiber web comprising nanofibers may independently have an air permeability in one or more of the above-referenced ranges.

In some embodiments, a non-woven fiber web comprising nanofibers comprises fibers that comprise oleophobic properties, comprises an oleophobic component, and/or is surface-modified. In some embodiments, a non-woven fiber web comprising nanofibers comprises a coating (e.g., an oleophobic coating, an oleophobic component that is an oleophobic coating) and/or comprises a resin (e.g., an oleophobic resin, an oleophobic component that is an oleophobic resin). The coating process may involve chemical deposition techniques and/or physical deposition techniques. For instance, a coating process may comprise introducing resin or a material (e.g., an oleophobic component that is a resin or material) dispersed in a solvent or solvent mixture into a pre-formed fiber layer (e.g., a pre-formed fiber web formed by an electrospinning process). As an example, a pre-filter may be sprayed with a coating material (e.g., a water-based fluoroacrylate such as AGE 550D). Non-limiting examples of coating methods include the use of vapor deposition (e.g., chemical vapor deposition, physical vapor deposition), layer-by-layer deposition, wax solidification, self-assembly, sol-gel processing, the use of a slot die coater, gravure coating, screen coating, size press coating (e.g., employing a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, powder coating, spray coating (e.g., electrospraying), gapped roll coating, roll transfer coating, padding saturant coating, saturation impregnation, chemical bath deposition, and solution deposition. Other coating methods are also possible. As described further elsewhere herein, a non-woven fiber web comprising nanofibers may be charged or uncharged, and it should be understood that any of the techniques described herein may be used to form layers which are either charged or uncharged.

In some embodiments, a coating material may be applied to a non-woven fiber web comprising nanofibers using a non-compressive coating technique. The non-compressive coating technique may coat the non-woven fiber web comprising nanofibers, while not substantially decreasing its thickness. In other embodiments, a resin may be applied to the non-woven fiber web comprising nanofibers using a compressive coating technique.

Other techniques include vapor deposition methods. Such methods include atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), chemical vapor infiltration (CVI), chemical beam epitaxy (CBE), electron beam assisted radiation curing, and atomic layer deposition. In physical vapor deposition (PVD), thin films (e.g., thin films comprising an oleophobic component) are deposited by the condensation of a vaporized form of the desired film material onto substrate. This method involves physical processes such as high-temperature vacuum evaporation with subsequent condensation, plasma sputter bombardment rather than a chemical reaction, electron beam evaporation, molecular beam epitaxy, and/or pulsed laser deposition.

In some embodiments, a surface of a non-woven fiber web comprising nanofibers may be modified using additives (e.g., oleophobic components that are additives such as oleophobic additives). In some embodiments, a non-woven fiber web comprising nanofibers comprises an additive or additives (e.g., oleophobic components that are additive(s) such as oleophobic additive(s)). The additives may be functional chemicals that are added to polymeric/thermoplastic fibers during an electrospinning process that may result in different physical and chemical properties at the surface from those of the polymer/thermoplastic itself after formation. For instance, the additive(s) may be added to an electrospinning solution used to form the non-woven fiber web comprising nanofibers. The additive(s) may, in some embodiments, migrate towards the surface of the fibers during and/or after formation of the fibers such that the surface of the fiber is modified with the additive, with the center of the fiber including more of the polymer/thermoplastic material. In some embodiments, one or more additives are included to render the surface of a fiber oleophobic as described herein. For instance, the additive may be an oleophobic material as described herein. Non-limiting examples of suitable additives include fluoroacrylates, fluorosurfactants, oleophobic silicones, fluoropolymers, fluoromonomers, fluorooligomers, and oleophobic polymers.

The additive (e.g., the oleophobic component in the form of an additive), if present, may be present in any suitable form prior to undergoing an electrospinning procedure and/or in any suitable form in the fiber after fiber formation. For instance, in some embodiments, the additive may be in a liquid (e.g., melted) form that is mixed with a thermoplastic material prior to and/or during fiber formation. In some cases, the additive may be in particulate form prior to, during, and/or after fiber formation. In certain embodiments, particles of a melt additive may be present in the fully formed fibers. In some embodiments, an additive may be one component of a binder, and/or may be added to one or more layers by spraying the layer with a composition comprising the additive. If particulate, the additive may have any suitable morphology (e.g., particles of different shapes and sizes, flakes, ellipsoids, fibers).

In some embodiments, a material (e.g., an oleophobic component, a precursor that reacts to form an oleophobic component) undergoes a chemical reaction (e.g., polymerization) after being applied to a non-woven fiber web comprising nanofibers. For example, a surface of a non-woven fiber web comprising nanofibers may be coated with one or more monomers that is polymerized after coating. In another example, a surface of a non-woven fiber web comprising nanofibers may include monomers, as a result of a melt additive, that are polymerized after formation of the nanofiber layer. In some such embodiments, an in-line polymerization may be used. In-line polymerization (e.g., in-line ultraviolet polymerization) is a process to cure a monomer or liquid polymer solution onto a substrate under conditions sufficient to induce polymerization (e.g., under UV irradiation).

The term “self-assembled monolayers” (SAMs) refers to molecular assemblies that may be formed spontaneously by the immersion of an appropriate substrate into a solution of an active surfactant in an organic solvent to create an oleophobic surface. In some embodiments, a surface modification comprises a SAM formed on one or more surfaces of the fibers in a non-woven fiber web comprising nanofibers.

In wax solidification, the non-woven fiber web comprising nanofibers is dipped into melted alkylketene dimer (AKD) heated at 90° C., and then cooled at room temperature in an atmosphere of dry N₂ gas. AKD undergoes fractal growth when it solidifies and improves the oleophobicity of the non-woven fiber web comprising nanofibers. In some embodiments, a surface modification comprises a layer formed by wax solidification.

In some embodiments, a species used to form a surface-modified non-woven fiber web comprising nanofibers or a species that is a component of such a layer comprises a small molecule, such as an inorganic or organic oleophobic molecule. Non-limiting examples include hydrocarbons (e.g., CH₄, C₂H₂, C₂H₄, C₆H₆), fluorocarbons (e.g., fluoroaliphatic compounds, fluoroaromatic compounds, fluoropolymers, fluorocarbon block copolymers, fluorocarbon acrylate polymers, fluorocarbon methacrylate polymers, fluoroelastomers, fluorosilanes, fluorosiloxanes, fluoro polyhedral oligomeric silsesquioxane, fluorinated dendrimers, inorganic fluorine compounds, CF₄, C₂F₄, C₃F₆, C₃F₈, C₄H₈, C₅H₁₂, C₆F₆, SF₃, SiF₄, BF₃), silanes (e.g., SiH₄, Si₂H₆, Si₃H₈. Si₄H₁₀), organosilanes (e.g., methylsilane, dimethylsilane, triethylsilane), siloxanes (e.g., dimethylsiloxane, hexamethyldisiloxane), ZnS, CuSe, InS, CdS, tungsten, silicon carbide, silicon nitride, silicon oxynitride, titanium nitride, carbon, silicon-germanium, and hydrophobic acrylic monomers terminating with alkyl groups and their halogenated derivatives (e.g., ethyl 2-ethylacrylate, methyl methacrylate; acrylonitrile). In certain embodiments, suitable hydrocarbons for modifying a surface of a non-woven fiber web comprising nanofibers have the formula CₓH_{y}, where x is an integer from 1 to 10 and y is an integer from 2 to 22. In certain embodiments, suitable silanes for modifying a surface of a non-woven fiber web comprising nanofibers have the formula SiₙH₂ₙ₊₂ where any hydrogen may be substituted for a halogen (e.g., Cl, F, Br, I), and where n is an integer from 1 to 10. In some embodiments, a species used to form a surface-modified non-woven fiber web comprising nanofibers or a species that is a component of a surface-modified non-woven fiber web comprising nanofibers comprises one or more of a wax, a silicone, and a corn based polymer (e.g., Zein). In some embodiments, a species used to form a surface-modified non-woven fiber web comprising nanofibers or a species that is a component of a surface-modified non-woven fiber web comprising nanofibers may comprise one or more nano-particulate materials. Other compositions are also possible.

As used herein, “small molecules” refers to molecules, whether naturally occurring or artificially created (e.g., via chemical synthesis) that have a relatively low molecular weight. Typically, a small molecule is an organic compound (i.e., it contains carbon). The small organic molecule may contain multiple carbon-carbon bonds, stereocenters, and/or other functional groups (e.g., amines, hydroxyl, carbonyls, and heterocyclic rings, etc.). In certain embodiments, the molecular weight of a small molecule is at most 1,000 g/mol, at most 900 g/mol, at most 800 g/mol, at most 700 g/mol, at most 600 g/mol, at most 500 g/mol, at most 400 g/mol, at most 300 g/mol, at most 200 g/mol, or at most 100 g/mol. In certain embodiments, the molecular weight of a small molecule is at least 100 g/mol, at least 200 g/mol, at least 300 g/mol, at least 400 g/mol, at least 500 g/mol, at least 600 g/mol, at least 700 g/mol, at least 800 g/mol, at least 900 g/mol, or at least 1,000 g/mol. Combinations of the above ranges are also possible (e.g., at least 200 g/mol and at most 500 g/mol). Other ranges are also possible.

In some embodiments, a species used to form a surface-modified non-woven fiber web comprising nanofibers or a species that is a component of a non-woven fiber web comprising nanofibers (e.g., an oleophobic component, a precursor that reacts to form an oleophobic component) comprises a cross-linker. Non-limiting examples of suitable cross-linkers include species with one or more acrylate groups, such as 1,6-hexanediol diacrylate, and alkoxylated cyclohexane dimethanol diacrylate.

In some embodiments, a surface of a non-woven fiber web comprising nanofibers is modified by roughening the surface or material on the surface of the non-woven fiber web comprising nanofibers. In some such cases, the surface modification may be a roughened surface or material. The surface roughness of the surface of a non-woven fiber web comprising nanofibers or material on the surface of a non-woven fiber web comprising nanofibers may be roughened microscopically and/or macroscopically. Non-limiting examples of methods for enhancing roughness include modifying a surface with certain fibers, mixing fibers having different diameters, and lithography. In certain embodiments, fibers with different diameters (e.g., staple fibers, continuous fibers) may be mixed or used to enhance or decrease surface roughness. In some embodiments, electrospinning may be used to create applied surface roughness alone or in combination with other methods, such as chemical vapor deposition. In some embodiments, lithography may be used to roughen a surface. Lithography encompasses many different types of surface preparation in which a design is transferred from a master onto a surface.

In some embodiments, the roughness of a non-woven fiber web comprising nanofibers may be used to modify the wettability of the non-woven fiber web comprising nanofibers with respect to a particular fluid. In some instances, the roughness may alter or enhance the wettability of a surface of a non-woven fiber web comprising nanofibers. In some cases, roughness may be used to enhance the oleophobicity of an intrinsically oleophobic surface.

Some non-woven fiber web comprising nanofibers that are oleophobic may have an oil rank of greater than or equal to 1. The oil rank may be due to fibers within the non-woven fiber web that intrinsically have an oil rank greater than or equal to 1 (e.g., polytetrafluoroethylene fibers), may be due to a surface modification that raises the oil rank of fibers within the layer having an initially lower oil rank, and/or may be due to an oleophobic component that raises the oil rank of the layer. In some embodiments, a non-woven fiber web comprising nanofibers has an oil rank of greater than or equal to 1, greater than or equal to 2, greater than or equal to 3, greater than or equal to 4, greater than or equal to 4.5, greater than or equal to 5, greater than or equal to 5.5, greater than or equal to 6, greater than or equal to 6.5, greater than or equal to 7, or greater than or equal to 7.5. In some embodiments, a non-woven fiber web comprising nanofibers has an oil rank of less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3, or less than or equal to 2. Combinations of the above-referenced ranges are also possible (e.g., greater than or equal to 1 and less than or equal to 8, greater than or equal to 1 and less than or equal to 8, greater than or equal to 1 and less than or equal to 6, or greater than or equal to 5 and less than or equal to 6). Other ranges are also possible.

Oil rank may be determined according to AATCC™ 118 (1997) measured at 23° C. and 50% relative humidity (RH). Briefly, 5 drops of each test oil (having an average droplet diameter of about 2 mm) are placed on five different locations on the surface of the non-woven fiber web comprising nanofibers. The test oil with the greatest oil surface tension that does not wet the surface of the fiber web (e.g., has a contact angle greater than or equal to 90 degrees with the surface) after 30 seconds of contact with the fiber web at 23° C. and 50% RH, corresponds to the oil rank (listed in Table 3). For example, if a test oil with a surface tension of 26.6 mN/m does not wet (i.e., has a contact angle of greater than or equal to 90 degrees with the surface) the surface of the non-woven fiber web comprising nanofibers after 30 seconds, but a test oil with a surface tension of 25.4 mN/m wets the surface of the non-woven fiber web comprising nanofibers within thirty seconds, the non-woven fiber web comprising nanofibers has an oil rank of 4. By way of another example, if a test oil with a surface tension of 25.4 mN/m does not wet the surface of the non-woven fiber web comprising nanofibers after 30 seconds, but a test oil with a surface tension of 23.8 mN/m wets the surface of the non-woven fiber web comprising nanofibers within thirty seconds, the non-woven fiber web comprising nanofibers has an oil rank of 5. By way of yet another example, if a test oil with a surface tension of 23.8 mN/m does not wet the surface of the non-woven fiber web comprising nanofibers after 30 seconds, but a test oil with a surface tension of 21.6 mN/m wets the surface of the non-woven fiber web comprising nanofibers within thirty seconds, the nanofiber layer has an oil rank of 6. In some embodiments, if three of more of the five drops partially wet the surface (e.g., forms a droplet, but not a well-rounded drop on the surface) in a given test, then the oil rank is expressed to the nearest 0.5 value determined by subtracting 0.5 from the number of the test liquid. By way of example, if a test oil with a surface tension of 25.4 mN/m does not wet the surface of the non-woven fiber web comprising nanofibers after 30 seconds, but a test oil with a surface tension of 23.8 mN/m only partially wets the surface of non-woven fiber web comprising nanofibers after 30 seconds (e.g., three or more of the test droplets form droplets on the surface of the fiber web that are not well-rounded droplets) within thirty seconds, the non-woven fiber web comprising nanofibers has an oil rank of 5.5.

TABLE 3

| Oil Rank | Test Oil | Surface Tension (mN/m) |
|---|---|---|
| 1 | Kaydol (mineral oil) | 31 |
| 2 | 65/35 Kaydol/n-hexadecane | 28 |
| 3 | n-hexadecane | 27.5 |
| 4 | n-tetradecane | 26.6 |
| 5 | n-dodecane | 25.4 |
| 6 | n-decane | 23.8 |
| 7 | n-octane | 21.6 |
| 8 | n-heptane | 20.1 |

When a filter media comprises two or more non-woven fiber webs comprising nanofibers, each non-woven fiber web comprising nanofibers may independently have an oil rank in one or more of the above-referenced ranges.

It is also possible for non-woven fiber webs comprising nanofibers to comprise fibers that comprise hydrophobic properties, to comprise a hydrophobic component (e.g., a hydrophobic additive), and/or to be surface-modified to be hydrophobic. In some embodiments, the non-woven fiber web comprising nanofibers comprises a hydrophobic coating and/or comprises a hydrophobic resin. For instance, in some embodiments, a non-woven fiber web comprising nanofibers comprises fibers that are hydrophobic. Non-limiting examples of such fibers include polypropylene fibers and polyvinylidene difluoride fibers. In some embodiments, one or more of the techniques described above that enhance the oleophobicity of a non-woven fiber web comprising nanofibers may also enhance its hydrophobicity. For instance, the presence of fluorinated species (e.g., fluoropolymers) and/or non-polar species (e.g., polyolefins, waxes, silicon-based materials) in a non-woven fiber web comprising nanofibers will enhance both its oleophobicity and hydrophobicity.

A non-woven fiber web comprising nanofibers that is hydrophobic may have a water contact angle of greater than or equal to 90°, greater than or equal to 100°, greater than or equal to 110°, greater than or equal to 120°, greater than or equal to 130°, greater than or equal to 140°, or greater than or equal to 150°. A non-woven fiber web comprising nanofibers that is hydrophobic may have a water contact angle of less than or equal to 160°, less than or equal to 150°, less than or equal to 140°, less than or equal to 130°, less than or equal to 120°, less than or equal to 110°, or less than or equal to 100°. Combinations of the above-referenced ranges are also possible (e.g., greater than or equal to 90° and less than or equal to 160°). Other ranges are also possible.

The water contact angle may be determined by following the procedure described in ASTM D5946 (2009) and measuring the contact angle within 15 seconds of water application.

When a filter media comprises two or more non-woven fiber webs comprising nanofibers, each non-woven fiber web comprising nanofibers may independently have a water contact angle in one or more of the above-referenced ranges.

In some embodiments, a non-woven fiber web comprising nanofibers comprises fibers that comprise hydrophilic properties, comprises a hydrophilic component (e.g., a hydrophilic additive), and/or is surface-modified to be hydrophilic. For instance, in some embodiments, a non-woven fiber web comprising nanofibers comprises fibers that are hydrophilic. Non-limiting examples of such fibers include poly(amide) fibers (e.g., nylon fibers) and poly(ester) fibers. As another example, a non-woven fiber web comprising nanofibers may be surface-treated with a hydrophilic surfactant. Non-limiting examples of suitable such surfactants include alkylbenzene sulfonates (e.g., 4-(5-dodecyl)benzenesulfonate), fatty acids and their salts (e.g., sodium stearate), lauryl sulfate, di-alkyl sulfosuccinates (e.g., dioctyl sodium sulfosuccinate), lignosulfonates, alkyl ether phosphates, benzalkonium chloride, and perfluorooctanesulfonate.

A non-woven fiber web comprising nanofibers that is hydrophilic may have a water contact angle of less than 90°, less than or equal to 80°, less than or equal to 70°, less than or equal to 60°, less than or equal to 50°, less than or equal to 40°, less than or equal to 30°, less than or equal to 20°, or less than or equal to 10°. A non-woven fiber web comprising nanofibers that is hydrophilic may have a water contact angle of greater than or equal to 0°, greater than or equal to 10°, greater than or equal to 20°, greater than or equal to 30°, greater than or equal to 40°, greater than or equal to 50°, greater than or equal to 60°, greater than or equal to 70°, or greater than or equal to 80°. Combinations of the above-referenced ranges are also possible (e.g., less than 90° and greater than or equal to 0°). Other ranges are also possible. It is also possible for a non-woven fiber web comprising nanofibers to be so hydrophilic that water applied thereto wicks into the layer and so does not form a droplet for which the contact angle can be measured. When such behavior is observed, the layer is assigned a contact angle of 0°.

The water contact angle may be determined in accordance with ASTM D5946 (2009) described elsewhere herein with respect to the water contact angle of hydrophobic non-woven fiber web comprising nanofibers.

When a filter media comprises two or more non-woven fiber webs comprising nanofibers, each non-woven fiber web comprising nanofibers may independently have a water contact angle in one or more of the above-referenced ranges.

In some embodiments, a non-woven fiber web comprising nanofibers is charged. Such charging may be performed in the manner described above with respect to the charging of non-woven fiber webs having high performance.

In some embodiments, a filter media comprises a layer that is charged and comprises non-continuous fibers (e.g., staple fibers). This layer may assist with providing charge to the filter media, which may be beneficial for the reasons discussed elsewhere herein with respect to charged non-woven fiber webs having high performance. It is also possible for a filter media to comprise two or more layers that are charged and comprise non-continuous fibers. Such layers may be the same or may differ in one or more ways.

In some embodiments, as described herein, a charged layer comprising non-continuous fibers may comprise a one or more plurality of fibers. For example, in certain embodiments, a charged layer comprising non-continuous fibers comprises a first plurality of fibers (e.g., comprising a first polymer) and a second plurality of fibers (e.g., comprising a second polymer, different than the first polymer). In some such embodiments, each of the plurality of fibers (e.g., the first plurality of fibers, the second plurality of fibers) may have an average fiber diameter as described above. For example, in an exemplary embodiment, the charged fiber layer comprises a first plurality of fibers and a second plurality of fibers, the first plurality of fibers and/or the second plurality of fibers having an average fiber diameter of less than 15 microns and greater than or equal to 1 micron. In another exemplary embodiment, the charged fiber layer comprises a first plurality of fibers and a second plurality of fibers, the first plurality of fibers and/or the second plurality of fibers having an average fiber diameter of greater than or equal to 1 micron and less than or equal to 22 microns.

In certain embodiments, the fibers present in a charged layer comprising non-continuous fibers include synthetic fibers (synthetic polymer fibers). The synthetic fibers may be staple fibers. Non-limiting examples of suitable synthetic fibers include polypropylene, dry-spun acrylic (e.g., produced from a dry-spinning process), polyvinyl chloride, mod-acrylic, wet spun acrylic, polytetrafluoroethylene, polypropylene, polystyrene, polysulfone, polyethersulfone, polycarbonate, nylon (e.g., nylon 6/6), polyurethane, phenolic, polyvinylidene fluoride, polyester, polyaramid, polyimide, polyolefin (e.g., polyethylene), Kevlar, Nomex, halogenated polymers (e.g., polyethylene terephthalate), polyacrylics, polyphenylene oxide, polyphenylene sulfide, polymethyl pentene, and combinations thereof. In some embodiments, the synthetic fibers are halogen-free such that significant dioxins are not detectable when incinerated. For example, the fibers may be halogen-free acrylic fibers formed by dry spinning. In some embodiments, the second layer and/or the entire filter media is halogen-free such that significant dioxins are not detectable when incinerated.

In some embodiments, a charged layer comprising non-continuous fibers comprises a mixture of two or more polymeric fibers. For instance, the charged layer comprising non-continuous fibers may comprise at least a first plurality of fibers comprising a first polymer and a second plurality of fibers comprising a second polymer. For example, in an exemplary embodiment, the charged layer comprising non-continuous fibers comprises a first plurality of fibers comprising a first polymer where the first polymer is acrylic (e.g., dry-spun acrylic). In certain embodiments, the charged layer comprising non-continuous fibers comprises a second plurality of fibers comprising a second type of polymer fiber, different than the first type of polymer fiber. In certain embodiments, the second type of polymer fiber is polypropylene.

In certain embodiments, a first polymer and a second polymer are selected such that the first polymer and the second polymer have different dielectric constants. The two polymers having different dielectric constants may facilitate charging of the layer (e.g., triboelectric charging). Without wishing to be bound by theory, two polymers with different dielectric constants in the layer may come into frictional contact during manufacture of the layer such that one polymer will lose electrons and give them away to the other polymer and, as a result, the polymer losing electrons is net positively charged, the other polymer receiving electrons is net negatively charged. In some embodiments, a charged layer comprising non-continuous fibers may have one or more characteristics described in commonly-owned U.S. Pat. No. 6,623,548, entitled “Filter materials and methods for the production thereof”, issued Sep. 23, 2003, which is incorporated herein by reference in its entirety for all purposes. For example, in some embodiments, a charged layer comprising non-continuous fibers is an electrostatically charged layer formed by blending together polypropylene fibers with halogen free acrylic fibers, polypropylene with polyvinyl chloride (PVC) fibers, or a mixture of halogen free acrylic fibers and PVC fibers and, optionally, carding the blended fibers so as to form a non-woven fabric.

In some embodiments, the difference in dielectric constants between a first polymer and a second polymer positioned in a charged layer comprising non-continuous fibers may be greater than or equal to 0.8, greater than or equal to 1, greater than or equal to 1.2, greater than or equal to 1.5, greater than or equal to 2, greater than or equal to 3, greater than or equal to 5, or greater than or equal to 7. In certain embodiments, the difference in dielectric constants between the first polymer and the second polymer may be less than or equal to 8, less than or equal to 7, less than or equal to 5, less than or equal to 3, less than or equal to 2, less than or equal to 1.5, less than or equal to 1.2, or less than or equal to 1. Combinations of the above-referenced ranges are also possible (e.g., the difference in dielectric constants between the first polymer and the second polymer is greater than or equal to 0.8 and less than or equal to 8, greater than or equal to 1.5 and less than or equal to 5). Other ranges are also possible.

Table 4 shows representative dielectric constants for several exemplary polymers.

TABLE 4

| Polymer | Dielectric constant |
|---|---|
| Polytetrafluoroethylene | 2.10 |
| Polypropylene | 2.2-2.36 |
| Polyethylene | 2.25-2.35 |
| Polystyrene | 2.45-2.65 |
| Polyvinyl chloride | 2.8-3.1 |
| Polysulfone | 3.07 |
| Polyethersulfone | 3.10 |
| Polyethylene terephthalate | 3.1 |
| Polycarbonate | 3.17 |
| Acrylic | 3.5-4.5 |
| Nylon 6/6 | 4.0-4.6 |
| Polyurethane | 6.3 |
| Phenolic | 6.5 |
| Polyvinylidene fluoride | 8.4 |

A first polymer and a second polymer may be present in a charged layer comprising non-continuous fibers in a variety of suitable amounts. For example, in some embodiments, the first polymer makes up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 50 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of the fibers in the charged layer comprising non-continuous fibers. In certain embodiments, the first polymer makes up less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 50 wt %, less than or equal to 40 wt %, less than or equal to 35 wt %, less than or equal to 30 wt %, less than or equal to 25 wt %, less than or equal to 20 wt %, or less than or equal to 15 wt % of the fibers in the charged layer comprising non-continuous fibers. Combinations of the above referenced ranges are also possible (e.g., greater than or equal to 10 wt % and less than or equal to 90 wt %, greater than or equal to 25 wt % and less than or equal to 75 wt %, greater than or equal to 35 wt % and less than or equal to 65 wt %). Other ranges are also possible.

In some embodiments, a second polymer makes up less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 50 wt %, less than or equal to 40 wt %, less than or equal to 35 wt %, less than or equal to 30 wt %, less than or equal to 25 wt %, less than or equal to 20 wt %, or less than or equal to 15 wt % of the fibers in the charged layer comprising non-continuous fibers. In certain embodiments, the second makes up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 50 wt %, greater than or equal to 60 wt %, greater than or equal to 65 wt %, greater than or equal to 70 wt %, greater than or equal to 75 wt %, greater than or equal to 80 wt %, or greater than or equal to 85 wt % of the fibers in the charged layer comprising non-continuous fibers. Combinations of the above referenced ranges are also possible (e.g., greater than or equal to 10 wt % and less than or equal to 90 wt %, greater than or equal to 25 wt % and less than or equal to 75 wt %, greater than or equal to 35 wt % and less than or equal to 65 wt %). Other ranges are also possible.

In some embodiments, a charged layer comprising non-continuous fibers comprises a first polymer in an amount of greater than or equal to 10 wt % and less than or equal to 90 wt % and a second polymer in an amount of less than or equal to 90 wt % and greater than or equal to 10 wt % with respect to the total amount of fibers in the layer. For example, in some embodiments, a charged layer comprising non-continuous fibers comprises the first polymer in an amount of greater than or equal to 25 wt % and less than or equal to 75 wt % and the second polymer in an amount of less than or equal to 75 wt % and greater than or equal to 25 wt % with respect to the total amount of fibers in the layer. In certain embodiments, a charged layer comprising non-continuous fibers may comprise the first polymer in an amount of greater than or equal to 35 wt % and less than or equal to 65 wt %, and the second polymer in an amount of less than or equal to 65 wt % and greater than or equal to 35 wt %, with respect to the total amount of fibers in the layer. In certain embodiments, a charged layer comprising non-continuous fibers comprises each of the first polymer and the second polymer in an amount of about 50 wt % with respect to the total amount of fibers in the layer.

In some embodiments, a charged layer comprising non-continuous fibers may comprise a plurality of fibers having a particular average fiber diameter. In some embodiments, a plurality of fibers positioned in the charged layer comprising non-continuous fibers has an average fiber diameter of greater than or equal to 1 micron, greater than or equal to 2 microns, greater than or equal to 3 microns, greater than or equal to 5 microns, greater than or equal to 7 microns, greater than or equal to 9 microns, greater than or equal to 10 microns, greater than or equal to 12 microns, greater than or equal to 14 microns, greater than or equal to 15 microns, greater than or equal to 16 microns, greater than or equal to 18 microns, greater than or equal to 19 microns, greater than or equal to 20 microns, or greater than or equal to 21 microns. In certain embodiments, a plurality of fibers positioned in the charged layer comprising non-continuous fibers has an average fiber diameter of less than or equal to 22 microns, less than or equal to 21 microns, less than or equal to 20 microns, less than or equal to 19 microns, less than or equal to 18 microns, less than or equal to 16 microns, less than or equal to 15 microns, less than or equal to 14 microns, less than or equal to 12 microns, less than or equal to 10 microns, less than or equal to 9 microns, less than or equal to 7 microns, less than or equal to 5 microns, less than or equal to 4 microns, less than or equal to 3 microns, or less than or equal to 2 microns. Combinations of the above-referenced ranges are also possible (e.g., greater than or equal to 1 micron and less than or equal to 22 microns, greater than or equal to 1 micron and less than or equal to 15 microns, or greater than or equal to 15 microns and less than or equal to 22 microns). Other ranges also possible.

When a charged layer comprising non-continuous fibers includes two or more types of fibers, each type of fiber may independently have an average fiber diameter in one or more of the ranges described above and/or all of the fibers in the charged layer comprising non-continuous fibers may be present in one or more of the ranges described above. When a filter media comprises two or more charged layers comprising non-continuous fibers, the preceding may be true for each such layer independently.

In some embodiments, a charged layer comprising non-continuous fibers may comprise a plurality of fibers that are relatively fine (e.g., having an average fiber diameter less than 15 microns). For example, in certain embodiments, a plurality of fibers that are relatively fine has an average fiber diameter less than 15 microns, less than or equal to 14 microns, less than or equal to 12 microns, less than or equal to 10 microns, less than or equal to 9 microns, less than or equal to 7 microns, less than or equal to 5 microns, less than or equal to 4 microns, less than or equal to 3 microns, or less than or equal to 2 microns. In some embodiments, a plurality of fibers that are relatively fine has an average fiber diameter of greater than or equal to 1 micron, greater than or equal to 2 microns, greater than or equal to 3 microns, greater than or equal to 5 microns, greater than or equal to 7 microns, greater than or equal to 9 microns, greater than or equal to 10 microns, greater than or equal to 12 microns, or greater than or equal to 14 microns.

Combinations of the above-referenced ranges are also possible (e.g., less than 15 microns and greater than or equal to 1 micron, less than 15 microns and greater than or equal to 3 microns, less than or equal to 12 microns and greater than or equal to 3 microns). Other ranges are also possible.

When a charged layer comprising non-continuous fibers includes two or more types of fibers, each type of fiber may independently have an average fiber diameter in one or more of the ranges described above and/or all of the fibers in the charged layer comprising non-continuous fibers may together have an average fiber diameter in one or more of the ranges described above. When a filter media comprises two or more charged layers comprising non-continuous fibers, the preceding may be true for each such layer independently.

In some embodiments, a first plurality of fibers and/or a second plurality of fibers present in a charged layer comprising non-continuous fibers have a particular average largest cross-sectional dimension, for example, of greater than or equal to 2 microns, greater than or equal to 2.5 microns, greater than or equal to 3 microns, greater than or equal to 5 microns, greater than or equal to 7 microns, greater than or equal to 9 microns, greater than or equal to 10 microns, greater than or equal to 12 microns, or greater than or equal to 14 microns. In some embodiments, a first plurality of fibers and/or a second plurality of fibers in a charged layer comprising non-continuous fibers have an average largest cross-sectional dimension of less than or equal to 15 microns, less than or equal to 14 microns, less than or equal to 12 microns, less than or equal to 10 microns, less than or equal to 9 microns, less than or equal to 7 microns, less than or equal to 5 microns, or less than or equal to 3 microns. Combinations of the above-referenced ranges are also possible (e.g., greater than or equal to 2 microns and less than or equal to 15 microns). Other ranges are also possible.

The average largest cross-sectional dimensions of fibers (may be determined according to test standard ASTM D2130-22.

In certain embodiments, the cross-sectional shapes of a first plurality of fibers and/or a second plurality of fibers positioned in a charged layer comprising non-continuous fibers may be selected as desired. In some embodiments, the cross-sectional shape of the first plurality of fibers and/or second plurality of fibers is selected from the group consisting of round, elliptical, dogbone, kidney bean, ribbon, irregular, and multi-lobal. In a particular set of embodiments, the first plurality of fibers and/or the second plurality of fibers have a multi-lobal shape (e.g., dilobal, trilobal, quadralobal, pentalobal, polylobal). A multilobal shaped fiber, as used herein, generally refers to a fiber having, at a cross-section of the fiber, two or more (e.g., three or more, four or more, five or more) lobes extending from a core of the fiber. The lobes may be, in some cases, the same or different material as the core. In some embodiments, the lobes and the core of the fiber are the same material. In certain embodiments, the fiber is a bicomponent or multicomponent fiber (e.g., the lobe(s) and the core comprise different materials).

In some embodiments, a charged layer comprising non-continuous fibers comprises fibers (e.g., synthetic fibers, staple fibers) having an average length of less than 5 inches (127 mm). For example, the fibers in a charged layer comprising non-continuous fibers may have an average length of less than or equal to 100 mm, less than or equal to 80 mm, less than or equal to 60 mm, less than or equal to 40 mm, less than or equal to 20 mm, less than or equal to 10 mm, less than or equal to 5 mm, less than or equal to 1 mm, less than or equal to 0.5 mm, or less than or equal to 0.1 mm. In some instances, fibers in a charged layer comprising non-continuous fibers may have an average length of greater than or equal to 0.02 mm, greater than or equal to 0.1 mm, greater than or equal to 0.5 mm, greater than or equal to 1 mm, greater than or equal to 5 mm, greater than or equal to 10 mm, greater than or equal to 20 mm, greater than or equal to 40 mm, greater than or equal to 60 mm. Combinations of the above-referenced ranges are possible (e.g., greater than or equal to 1 mm and less than or equal to 80 mm, greater than or equal to 1 mm and less than or equal to 60 mm). Other ranges are also possible.

When a charged layer comprising non-continuous fibers includes two or more types of fibers, each type of fiber may independently have an average fiber length in one or more of the ranges described above and/or all of the fibers in the charged layer comprising non-continuous fibers may together have an average fiber length in one or more of the ranges described above. When a filter media comprises two or more charged layers comprising non-continuous fibers, the preceding may be true for each such layer independently.

The basis weights of charged layers comprising non-continuous fibers may be selected as desired. For instance, in some embodiments, a charged layer comprising non-continuous fibers may have a basis weight of greater than or equal to 12 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 100 gsm, greater than or equal to 200 gsm, greater than or equal to 300 gsm, greater than or equal to 400 gsm, greater than or equal to 500 gsm, or greater than or equal to 600 gsm. In some instances, a charged layer comprising non-continuous fibers may have a basis weight of less than or equal to 700 gsm, less than or equal to 600 gsm, less than or equal to 500 gsm, less than or equal to 400 gsm, less than or equal to 300 gsm, less than or equal to 200 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, or less than or equal to 15 gsm. Combinations of the above-referenced ranges are also possible (e.g., greater than or equal to 12 gsm and less than or equal to 700 gsm, greater than or equal to 12 gsm and less than or equal to 250 gsm, or greater than or equal to 15 gsm and less than or equal to 100 gsm). Other ranges are also possible.

The basis weight of a charged layer comprising non-continuous fibers may be determined as described above with respect to the basis weights of non-woven fiber webs having high performance.

When a filter media comprises two or more charged layers comprising non-continuous fibers, each charged layer comprising non-continuous fibers may independently have a basis weight in one or more of the above-referenced ranges.

In some cases, a charged layer comprising non-continuous fibers may be designed to have a relatively high surface area and/or a relatively low number of fibers per gram (of the layer). Advantageously, and without wishing to be bound by theory, a charged layer comprising non-continuous fibers having a relatively high surface area per gram (of the layer) and a relatively low number of fibers per gram (of the layer) may exhibit an increased initial efficiency, increased charge generation (e.g., triboelectric charge), and/or decreased charge dissipation (e.g., during use of the layer and/or a filter media comprising the layer), as compared to layers having a relatively low surface areas per unit mass and/or relatively higher numbers of fibers per gram of the layer.

In certain embodiments, the BET surface area of a charged layer comprising non-continuous fibers is greater than or equal to 0.33 m²/g, greater than or equal to 0.35 m²/g, greater than or equal to 0.37 m²/g, greater than or equal to 0.4 m²/g, greater than or equal to 0.5 m²/g, greater than or equal to 0.6 m²/g, greater than or equal to 0.7 m²/g, greater than or equal to 0.8 m²/g, greater than or equal to 0.9 m²/g, greater than or equal to 1 m²/g, or greater than or equal to 1.2 m²/g. In some embodiments, the BET surface area of a charged layer comprising non-continuous fibers is less than or equal to 1.5 m²/g, less than or equal to 1.2 m²/g, less than or equal to 1 m²/g, less than or equal to 0.9 m²/g, less than or equal to 0.8 m²/g, less than or equal to 0.75 m²/g, less than or equal to 0.7 m²/g, less than or equal to 0.6 m²/g, less than or equal to 0.5 m²/g, less than or equal to 0.4 m²/g, less than or equal to 0.37 m²/g, or less than or equal to 0.35 m²/g. Combinations of the above-referenced ranges are also possible (e.g., greater than or equal to 0.33 m²/g and less than or equal to 1.5 m²/g, greater than or equal to 0.35 m²/g and less than or equal to 1 m²/g). Other ranges are also possible.

The BET surface area of a layer may be measured through use of a standard BET surface area measurement technique, such as according to section 10 of Battery Council International Standard BCIS-03A, “Recommended Battery Materials Specifications Valve Regulated Recombinant Batteries”, section 10 being “Standard Test Method for Surface Area of Recombinant Battery Separator Mat”. Following this technique, the BET surface area may be measured via adsorption analysis using a BET surface analyzer (e.g., Micromeritics Gemini III 2375 Surface Area Analyzer) with nitrogen gas; the sample amount may be between 0.5 and 0.6 grams in a ¾″ tube; and, the sample may allowed to degas at 75° C. for a minimum of 3 hours.

When a filter media comprises two or more charged layers comprising non-continuous fibers, each charged layer comprising non-continuous fibers may independently have a BET surface area in one or more of the above-referenced ranges.

In certain embodiments, a charged layer comprising non-continuous fibers has a particular number of fibers per gram (of fiber layer). In some embodiments, a charged layer comprising non-continuous fibers has less than or equal to 125,000 fibers, less than or equal to 120,000 fibers, less than or equal to 110,000 fibers, less than or equal to 105,000 fibers, less than or equal to 103,000 fibers, less than or equal to 100,000 fibers, less than or equal to 95,000 fibers, less than or equal to 90,000 fibers, less than or equal to 80,000 fibers, less than or equal to 75,000 fibers, less than or equal to 70,000 fibers, or less than or equal to 60,000 fibers per gram (of the layer). In certain embodiments, a charged layer comprising non-continuous fibers has greater than or equal to 50,000 fibers, greater than or equal to 60,000 fibers, greater than or equal to 70,000 fibers, greater than or equal to 75,000 fibers, greater than or equal to 80,000 fibers, greater than or equal to 90,000 fibers, greater than or equal to 95,000 fibers, greater than or equal to 100,000 fibers, greater than or equal to 103,000 fibers, greater than or equal to 105,000 fibers, greater than or equal to 110,000 fibers, or greater than or equal to 120,000 fibers per gram (of layer). Combinations of the above-referenced ranges are also possible (e.g., less than or equal to 125,000 fibers and greater than or equal to 50,000 fibers per gram, less than or equal to 105,000 fibers and greater than or equal to 75,000 fibers per gram). Other ranges are also possible.

The number of fibers per gram may be determined by dividing the average BET surface area of the layer by the average geometric surface area of the fibers in the (charged) fiber layer. Average geometric surface area of the fibers in the layer may be determined by measuring the average cross-sectional perimeter of the fibers (e.g., by Scanning Electron Microscopy) and multiplying by the average fiber length.

When a charged layer comprising non-continuous fibers includes two or more types of fibers, each type of fiber may independently have a number of fibers per gram in one or more of the ranges described above and/or all of the fibers in the charged layer comprising non-continuous fibers may together have a number of fibers per gram in one or more of the ranges described above. When a filter media comprises two or more charged layers comprising non-continuous fibers, the preceding may be true for each such layer independently.

In an exemplary embodiment, a charged layer comprising non-continuous fibers has a BET surface area greater than or equal to 0.33 m²/g (e.g., greater than or equal to 0.33 m²/g and less than or equal to 1.5 m²/g) and less than or equal to 125,000 fibers (e.g., less than or equal to 125,000 fibers and greater than or equal to 50,000 fibers per gram) per gram (of charged fiber layer).

The charged layers comprising non-continuous fibers may have a variety of suitable uncompressed thicknesses. In some embodiments, the uncompressed thickness of t a charged layer comprising non-continuous fibers may be greater than or equal to greater than or equal to 5 mils, greater than or equal to 10 mils, greater than or equal to 25 mils, greater than or equal to 30 mils, greater than or equal to 50 mils, greater than or equal to 100 mils, greater than or equal to 200 mils, greater than or equal to 250 mils, greater than or equal to 300 mils, greater than or equal to 350 mils, greater than or equal to 400 mils, greater than or equal to 450 mils, or greater than or equal to 500 mils. In certain embodiments, the uncompressed thickness of a charged layer comprising non-continuous fibers may be less than or equal to 600 mils, less than or equal to 500 mils, less than or equal to 450 mils, less than or equal to 400 mils, less than or equal to 350 mils, less than or equal to 300 mils, less than or equal to 250 mils, less than or equal to 200 mils, less than or equal to 100 mils, less than or equal to 50 mils, less than or equal to 25 mils, or less than or equal to 10 mils. Combinations of the above referenced ranges are also possible (e.g., greater than or equal to 5 mils and less than or equal to 600 mils, greater than or equal to 30 mils and less than or equal to 350 mils). Other ranges are also possible.

The uncompressed thickness of a charged layer comprising non-continuous fibers may be determined using a Mitutoyo thickness gauge. Briefly, the layer may be compressed using a circular probe having a diameter of 1 mm under at least three different weights (e.g., 10 grams, 5 grams, 2 grams). The ordinary least squares linear regression may be determined for each weight and corresponding thickness, which may be used to calculated the thickness of the layer corresponding to 0 grams of applied weight (i.e. the uncompressed thickness for that layer).

When a filter media comprises two or more charged layers comprising non-continuous fibers, each charged layer comprising non-continuous fibers may independently have an uncompressed thickness in one or more of the above-referenced ranges.

The air permeability of the charged layers comprising non-continuous fibers may have a variety of suitable air permeabilities. In some embodiments, the air permeability of a charged layer comprising non-continuous fibers is greater than or equal to 10 CFM, greater than or equal to 25 CFM, greater than or equal to 50 CFM, greater than or equal to 80 CFM, greater than or equal to 100 CFM, greater than or equal to 200 CFM, greater than or equal to 250 CFM, greater than or equal to 300 CFM, greater than or equal to 350 CFM, greater than or equal to 400 CFM, greater than or equal to 450 CFM, greater than or equal to 500 CFM, greater than or equal to 550 CFM, greater than or equal to 600 CFM, greater than or equal to 650 CFM, greater than or equal to 700 CFM, greater than or equal to 750 CFM, greater than or equal to 800 CFM, greater than or equal to 850 CFM, greater than or equal to 900 CFM, greater than or equal to 950 CFM, greater than or equal to 1000 CFM, greater than or equal to 1050 CFM, greater than or equal to 1100 CFM, or greater than or equal to 1150 CFM. In certain embodiments, the air permeability of a charged layer comprising non-continuous fibers is less than or equal to 1200 CFM, less than or equal to 1150 CFM, less than or equal to 1100 CFM, less than or equal to 1050 CFM, less than or equal to 1000 CFM, less than or equal to 950 CFM, less than or equal to 900 CFM, less than or equal to 850 CFM, less than or equal to 800 CFM, less than or equal to 750 CFM, less than or equal to 700 CFM, less than or equal to 650 CFM, less than or equal to 600 CFM, less than or equal to 550 CFM, less than or equal to 500 CFM, less than or equal to 450 CFM, less than or equal to 400 CFM, less than or equal to 350 CFM, less than or equal to 300 CFM, less than or equal to 250 CFM, less than or equal to 200 CFM, less than or equal to 150 CFM, less than or equal to 100 CFM, less than or equal to 80 CFM, less than or equal to 50 CFM, or less than or equal to 25 CFM. Combinations of the above referenced ranges are also possible (e.g., greater than or equal to 10 CFM and less than or equal to 1200 CFM, greater than or equal to 80 CFM and less than or equal to 1200 CFM, greater than or equal to 50 CFM and less than or equal to 650 CFM). Other ranges are also possible.

The air permeability of a charged layer comprising non-continuous fibers may be determined in the manner described above with respect to determining the air permeability of a non-woven fiber web having high performance.

In some embodiments, a filter media comprises a backer. The backer may be a relatively open layer that provides structural support to one or more other layers in the filter media (e.g., a non-woven fiber web having high performance, a non-woven fiber web comprising nanofibers) and/or to the filter media as a whole. Backers may also assist with pleatability. In some embodiments, the presence of a backer may not appreciably affect the air permeability of the filter media.

The air permeability of a backer may be selected as desired. In some embodiments, a backer has an air permeability of greater than or equal to 200 CFM, greater than or equal to 225 CFM, greater than or equal to 250 CFM, greater than or equal to 275 CFM, greater than or equal to 300 CFM, greater than or equal to 350 CFM, greater than or equal to 400 CFM, greater than or equal to 500 CFM, greater than or equal to 750 CFM, greater than or equal to 1000 CFM, or greater than or equal to 1250 CFM. In some embodiments, a backer has an air permeability of less than or equal to 1500 CFM, less than or equal to 1000 CFM, less than or equal to 750 CFM, less than or equal to 500 CFM, less than or equal to 400 CFM, less than or equal to 350 CFM, less than or equal to 300 CFM, less than or equal to 275 CFM, less than or equal to 250 CFM, or less than or equal to 225 CFM. Combinations of the above-referenced ranges are also possible (e.g., greater than or equal to 200 CFM and less than or equal to 1500 CFM, greater than or equal to 250 CFM and less than or equal to 1250 CFM, or greater than or equal to 300 CFM and less than or equal to 1000 CFM). Other ranges are also possible.

The air permeability of a backer may be measured in the same manner as the air permeability of a non-woven fiber web having high performance described elsewhere herein.

When a filter media comprises two or more backers, each backer may independently have an air permeability in one or more of the above-referenced ranges.

The stiffness of a backer may be selected as desired. In some embodiments, a backer has a stiffness of greater than or equal to 300 mg, greater than or equal to 350 mg, greater than or equal to 400 mg, greater than or equal to 450 mg, greater than or equal to 500 mg, greater than or equal to 600 mg, greater than or equal to 750 mg, greater than or equal to 1000 mg, greater than or equal to 1250 mg, greater than or equal to 1500 mg, greater than or equal to 1750 mg, greater than or equal to 2000 mg, greater than or equal to 2250 mg, greater than or equal to 2500 mg, or greater than or equal to 2750 mg. In some embodiments, a backer has a stiffness of less than or equal to 3000 mg, less than or equal to 2750 mg, less than or equal to 2500 mg, less than or equal to 2250 mg, less than or equal to 2000 mg, less than or equal to 1750 mg, less than or equal to 1500 mg, less than or equal to 1250 mg, less than or equal to 1000 mg, less than or equal to 750 mg, less than or equal to 600 mg, less than or equal to 500 mg, less than or equal to 450 mg, less than or equal to 400 mg, or less than or equal to 350 mg. Combinations of the above-referenced ranges are also possible (e.g., greater than or equal to 300 mg and less than or equal to 3000 mg, greater than or equal to 400 mg and less than or equal to 2500 mg, or greater than or equal to 500 mg and less than or equal to 2000 mg). Other ranges are also possible.

The stiffness of a backer may be determined in accordance with TAPPI T543 om-94.

When a filter media comprises two or more backers, each backer may independently have a stiffness in one or more of the above-referenced ranges.

In some embodiments, a filter media comprises a mesh. The mesh may comprise a plurality of strands (e.g., connected to each other in one or more locations). The strands may comprise a metal, a synthetic material, and/or a natural material. The strands may be flexible and/or ductile.

In some embodiments, a mesh has a relatively high air permeability. In other words, it may be a relatively open layer. In some embodiments, a mesh has an air permeability of greater than or equal to greater than or equal to 500 CFM, greater than or equal to 750 CFM, greater than or equal to 1000 CFM, or greater than or equal to 1250 CFM. In some embodiments, a backer has an air permeability of less than or equal to 1500 CFM, less than or equal to 1000 CFM, or less than or equal to 750 CFM. Combinations of the above-referenced ranges are also possible (e.g., greater than or equal to 500 CFM and less than or equal to 1500 CFM). Other ranges are also possible.

The air permeability of a mesh may be measured in the same manner as the air permeability of a non-woven fiber web having high performance described elsewhere herein.

When a filter media comprises two or more meshes, each mesh may independently have an air permeability in one or more of the above-referenced ranges.

In some embodiments, a filter media comprises one or more layers (e.g., a non-woven fiber web having high performance, an adsorptive layer, a non-woven fiber web comprising nanofibers, a charged layer comprising non-continuous fibers) that are held in a waved or curvilinear configuration by one or more support layers. Such layers may be referred to herein as “waved layers.” In some embodiments, the waved configuration of a waved layer may increase the surface area of the layers relative to a planar layer having a similar length, resulting in improved filtration properties, such as efficiency and air resistance. In addition to the waved layer(s), the filter media described herein may comprise one or more layers that are unwaved.

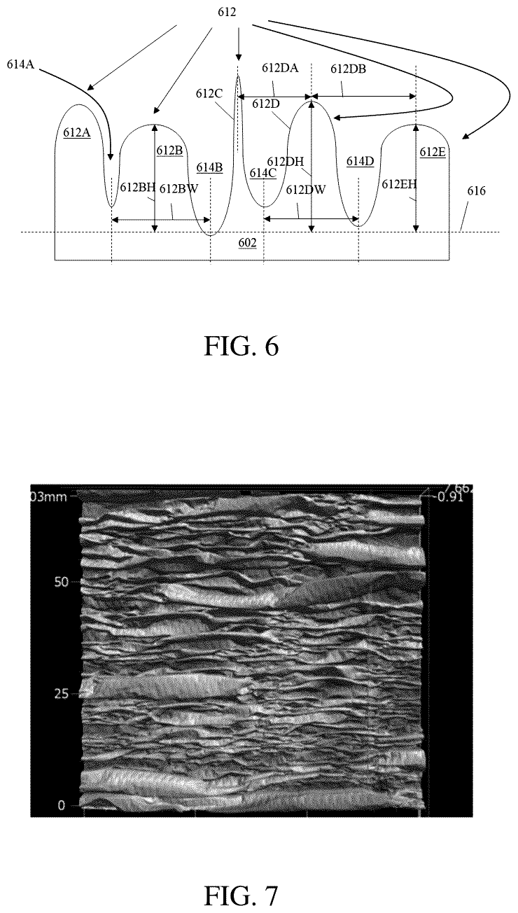

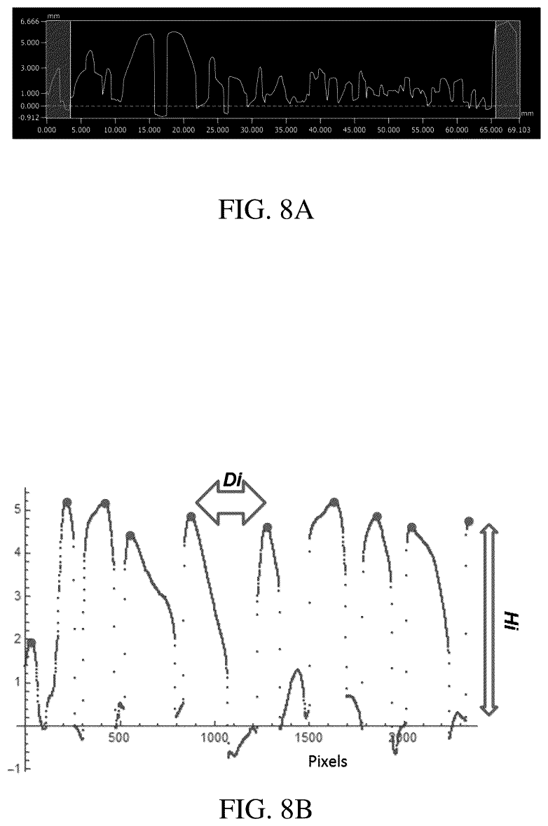

A non-limiting example of the waved configuration of a filter media comprising a waved layer and a support layer that holds the waved layer in a waved configuration to maintain separation of peaks and troughs of adjacent waves of the filtration layer is shown in FIG. 4A. As shown in FIG. 4A, a filter media 10 may include a waved layer 12 positioned between a first support layer 16 and an optional second support layer 14. Though two support layers (e.g., 14 and 16) are shown, it should be understood that the filter media 10 need not include both support layers. Where only one support layer is provided, the support layer can be disposed on a top or bottom surface (e.g., upstream or downstream) of the waved layer. The one or more support layers (e.g., 14, 16) can help maintain the waved layer 12, and optionally any additional layers or fiber webs in the waved configuration, as described further below.

As described herein, in some embodiments, a filter media 10 may also include one or more optional layers. For instance, filter media 10 may optionally include one or more cover layers located on the top (e.g., upstream-most) and/or bottom (e.g., downstream-most) sides of the filter media 10. As shown in FIG. 4A, the filter media 10 may include a cover layer 18 positioned on the top (e.g., most upstream) side of filter media. In certain embodiments, a cover layer 18 may serve as an aesthetic layer or an abrasion resistance layer. In some such embodiments, the filter media may be configured, as shown in FIG. 4A, such that the cover layer 18 is positioned on the fluid (e.g., air) entering side of the filter media, labeled I, the support layer 16 is positioned directly or indirectly adjacent to (e.g., downstream of) the cover layer 18, the filtration layer 12 is positioned directly or indirectly adjacent to (e.g., downstream of) the support layer 16, and the optional second support layer 14 is positioned directly or indirectly adjacent to (e.g., downstream) of the filtration layer 12 on the fluid (e.g., air) outflow side, labeled O. The direction of fluid (e.g., air) flow, i.e., from fluid entering I to fluid outflow O, is indicated by the arrows marked with reference A.

In certain embodiments, as illustrated in FIG. 4B, a filter media 10B may include an optional cover layer 18B positioned on the fluid (e.g., air) exiting side of the filter media, labeled I, in addition to or as an alternative to the optional cover layer 18 in FIG. 4A. In some such embodiments, the optional cover layer 18B is positioned directly or indirectly adjacent to (e.g., downstream of) an optional support layer 14 is positioned directly or indirectly adjacent to (e.g., upstream of) an optional cover layer 18B, a waved layer 12B is positioned directly or indirectly adjacent to (e.g., upstream of) an optional support layer 14B, a support layer 16B is positioned directly or indirectly adjacent to (e.g., upstream of) a waved layer 12B. In some embodiments, the cover layer 18B may serve as a strengthening component that provides structural integrity to the filter media 10 to help maintain the waved configuration or offer abrasion resistance.

In some embodiments, as shown in FIGS. 4A and 4B, the optional cover layer(s) may have a topography that is different than the topographies of the waved layer and/or the support layer(s). For instance, regardless of whether the filter media is in a pleated or non-pleated configuration, the cover layer(s) may be non-waved (e.g., substantially planar), whereas the waved layer and/or the support layer(s) may have a waved configuration.

Some or all of the layers can be formed into a waved configuration using various manufacturing techniques, but in an exemplary embodiment a waved layer, at least one of the support layers, and any additional fiber webs or layers are positioned adjacent to one another in a desired arrangement from air entering side to air outflow side, and the combined layers are conveyed between first and second moving surfaces that are traveling at different speeds, such as with the second surface traveling at a speed that is slower than the speed of the first surface. A suction force, such as a vacuum force, can be used to pull the layers toward the first moving surface, and then toward the second moving surface as the layers travel from the first to the second moving surfaces. The speed difference causes the layers to form z-direction waves as they pass onto the second moving surface, thus forming peaks and troughs in the layers. The speed of each surface can be altered to obtain the desired number of waves per inch. The distance between the surfaces can also be altered to determine the amplitude of the peaks and troughs, and in an exemplary embodiment the distance is adjusted between 0.025″ to 4″. For example, the amplitude of the peaks and waves may be between about 0.1″ to 2.0″, e.g., between about 0.1″ to 1.0″ or between about 0.1″ to 2.0. For certain applications, the amplitude of the peaks and waves may be between about 0.1″ and 1.0″, between about 0.1″ and 0.5″, or between about 0.1″ and 0.3″. The properties of the different layers can also be altered to obtain a desired filter media configuration. In an exemplary embodiment the filter media has about 2 to 6 waves per inch, with a height (overall thickness) in the range of about 0.025″ to 2″, however this can vary significantly depending on the intended application. For instance, in other embodiments, the filter media may have about 2 to 4 waves per inch, e.g., about 3 waves per inch. As shown in FIG. 4A, a single wave W extends from the middle of one peak to the middle of an adjacent peak.

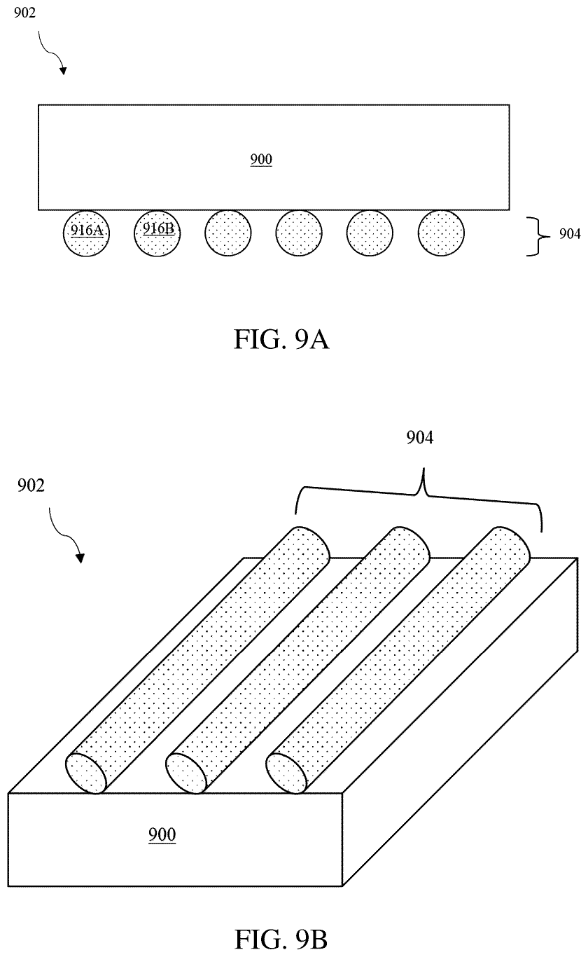

In the embodiment shown in FIG. 4A, when the waved layer 12 and the support layer are waved, the resulting waved layer 12 will have a plurality of peaks P and troughs T on each surface (i.e., air entering side I and air outflow side O) thereof, as shown in FIG. 5. The support layer will extend across the peaks P and into the troughs T so that the support layer also has a waved configuration. A person skilled in the art will appreciate that a peak P on the air entering side I of the filtration layer will have a corresponding trough T on the air outflow side O. Thus, a downstream support layer will extend into a trough T, and exactly opposite that same trough T is a peak P, across which an upstream support layer will extend. Since the downstream support layer extends into the troughs T on the air outflow side O of the filtration layer, the downstream support layer, if provided, will maintain adjacent peaks P on the air outflow side O at a distance apart from one another and will maintain adjacent troughs T on the air outflow side O at a distance apart from one another. The upstream support layer, if provided, can likewise maintain adjacent peaks P on the air entering side I of the filtration layer at a distance apart from one another and can maintain adjacent troughs T on the air entry side I of the filtration layer at a distance apart from one another. As a result, the waved layer has a surface area that is significantly increased, as compared to a surface area that it would have in the planar configuration. In certain exemplary embodiments, the surface area in the waved configuration is increased by at least about 50%, and in some instances as much as 120%, as compared to the surface area of the same layer in a planar configuration.

In embodiments in which the one or more support layers hold a waved layer in a waved configuration, it may be desirable to reduce the amount of free volume (e.g., volume that is unoccupied by any fibers) in the troughs. That is, a relatively high percentage of the volume in the troughs may be occupied by the support layer(s) to give the waved layer structural support. For example, at least 95% or substantially all of the available volume in the troughs may be filled with the support layer and the support layer may have a solidity ranging between about 1% to 90%, between about 1% to 50%, between about 10% to 50%, or between about 20% to 50%. Additionally, as shown in the exemplary embodiments of FIG. 4A, the extension of the support layer(s) across the peaks and into the troughs may be such that the surface area of the support layer in contact with a cover layer 18 is similar across the peaks as it is across the troughs. Similarly, the surface area of the support layer in contact with the cover layer 18B shown in FIG. 4B may be similar across the peaks as it is across the troughs. For example, the surface area of the support layer in contact with a top or bottom layer across a peak may differ from the surface area of the support layer in contact with the cover layer(s) across a trough by less than about 70%, less than about 50%, less than about 30%, less than about 20%, less than about 10%, or less than about 5%.

In certain exemplary embodiments, one or more support layers can have a fiber density that is greater at the peaks than it is in the troughs; and, in some embodiments, a fiber mass that is less at the peaks than it is in the troughs. In some embodiments, this can result from the coarseness of the support layer relative to the waved layer. In particular, as the layers are passed from the first moving surface to the second moving surface, the relatively fine nature of the layer being waved may allow the support layer to conform around the waves formed in the waved layer. As the support layer extends across a peak P, the distance traveled will be less than the distance that each support layer travels to fill a trough. As a result, the support layer may compact at the peaks, thus having an increased fiber density at the peaks as compared to the troughs, through which the layers will travel to form a loop-shaped configuration.

Once the layers are formed into a waved configuration, the waved shape can be maintained by activating binder fibers to effect bonding of the fibers. A variety of techniques can be used to activate binder fibers. For example, if bicomponent binder fibers having a core and sheath are used, the binder fibers can be activated upon the application of heat. If monocomponent binder fibers are used, the binder fibers can be activated upon the application of heat, steam and/or some other form of warm moisture. A person skilled in the art will also appreciate that the layers can optionally be mated to one another using various techniques other than using binder fibers. The layers can also be individually bonded layers, and/or they can be mated, including bonded, to one another prior to being waved.

In some embodiments, a filter media described herein, and/or one or more layers positioned therein (e.g., a non-woven fiber web having high performance, an adsorptive layer, a non-woven fiber web comprising nanofibers, a charged layer comprising non-continuous fibers), comprises an irregular structure. The irregular structure may serve to enhance the surface area of the filter media per filter media footprint, which may enhance the gamma and/or dust holding capacity of the filter media.

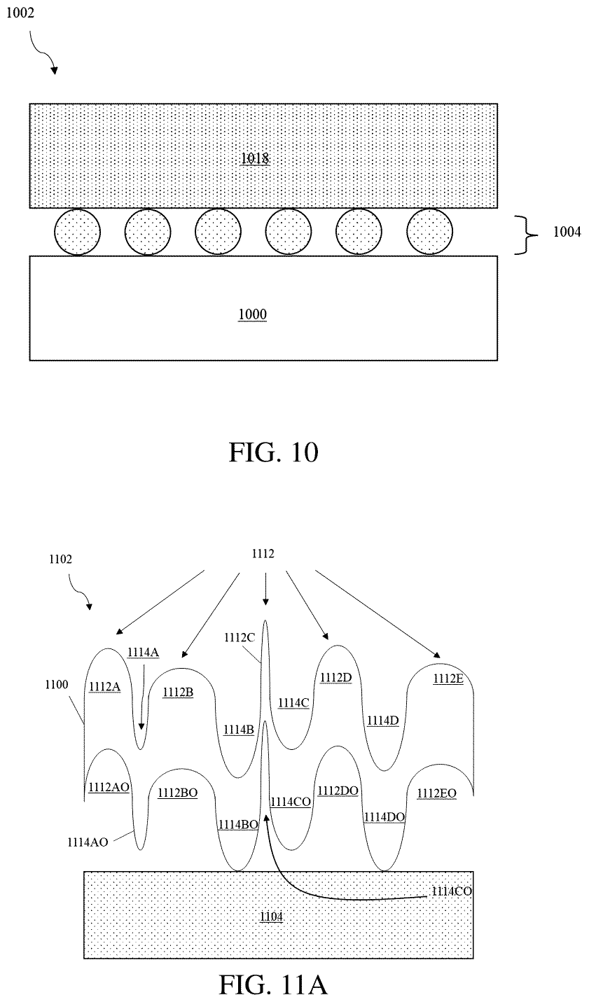

One non-limiting example of a filter media comprising an irregular structure is shown in FIG. 6. In FIG. 6, the irregular structure is present at least at the surface of the filter media; therefore, FIG. 6 shows a filter media 602 comprising an irregular structure at the surface. The filter media shown in FIG. 6 comprises a plurality of peaks 612. The plurality of peaks 612 comprises peaks 612A, 612B, 612C, 612D, and 612E separated by troughs 614A, 614B, 614C, and 614D. Each peak has a height and a width. The peaks not on the outer edges of the filter media (i.e., peaks 612B, 612C, and 612D) have two nearest neighbor spacings; those on the outer edges of the filter media (i.e., peaks 612A and 612E) have one nearest neighbor spacing. By way of example, the peak 612D has a height 612DH, a width 612DW, and two nearest neighbor spacings 612DA and 612DB. These features of the peaks may be determined with the aid of a scanning optical microscope, such as a Keyence VR-3000G2, Measurement Unit Model VR3200 Wide-Area 3D Measurement system. The scanning optical microscope may be employed to measure the surface topography of the filter media according to the standard described in ISO 25178 (2006) at a resolution in each of the x- and y-axes of at least 25 microns and in the z-axis of at least 0.5 microns. This measurement yields a matrix of numerical values representing the measured surface height at a set of points on the sample, where the x- and y-positions of each measured surface height are given by the column and row, respectively, of the matrix. Then, a value of z of which 95% of the points making up the measured surface topography are above and 5% of the points making up the measured surface topography are below may be defined as a reference height (shown as dashed line 616 in FIG. 6). This reference height may be subtracted from the height of each point in the measured surface topography to yield a relative height of each point in the measured surface topography and a relative surface topography made up of the relative height values.

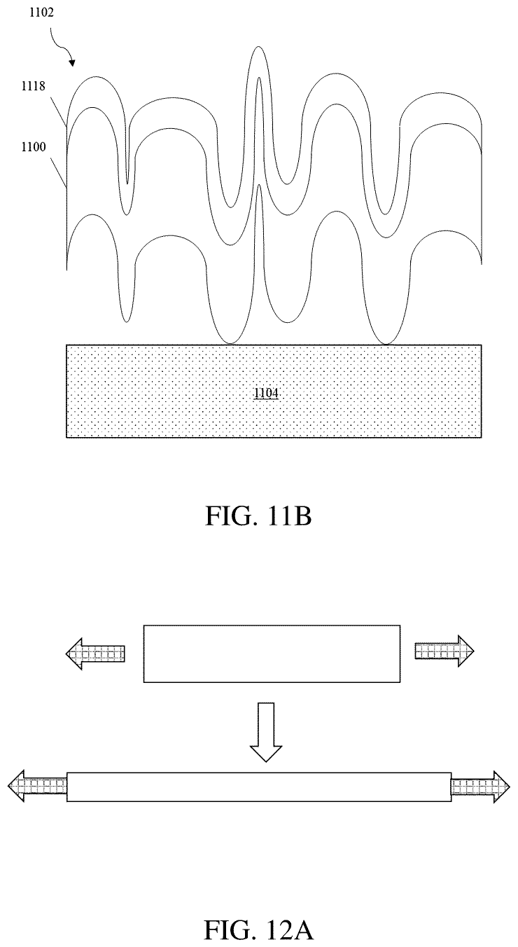

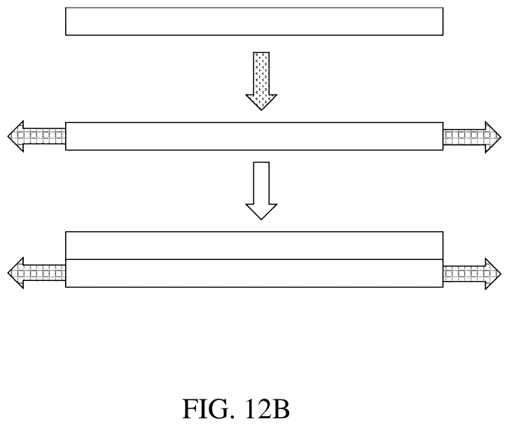

The relative surface topography may then undergo further computational processing according to ISO 16610-21:2011 to determine the height of each peak. The computational process may include the following sequence of steps: (1) removal of the outer 10% of points from each edge to reduce edge effects; (2) application of a Gaussian filter with a kernel size of 30 pixels to smooth the resultant data; (3) conversion of the resultant data into a set of line data by selecting every 10th row; and (4) identification of the local maxima. The local maxima identified in step (4) are the peak heights. The spacing between two peaks may be determined by finding the difference between the positions of the points at which these local maxima occur. FIG. 7 shows one example of a relative surface topography measured according to this procedure after step (2), and FIG. 8A shows one example of a set of line data measured according to this procedure after step (3). FIG. 8B shows one example of a set of line data at which the local maxima have been identified (shown as larger points), and employed to determine a peak height (Hi) and a spacing between two adjacent peaks (Di).

In some embodiments, like that shown in FIGS. 6-8B, the peaks within the plurality of peaks may differ from each other in one or more ways. For instance, a plurality of peaks may comprise two or more peaks having differing heights, differing spacings from their nearest neighbor(s), and/or differing shapes. By way of example, with reference to FIG. 6, the height 612DH of the peak 612D is different than the height 612BH of the peak 612B. As another example, the spacing 612DA between the peaks 612C and 612D is different than the spacing 612DB between the peaks 612D and 612E. In some embodiments, a plurality of peaks comprises no two peaks that have the same height, no two sets of peaks that have the same spacing, and/or no two peaks that have the same width. For instance, the irregular structure and/or the filter media may not comprise a peak having the same height, spacing, and/or width as another peak.

In some embodiments, a plurality of peaks comprises two or more peaks that are similar in one or more ways. For instance, a plurality of peaks may comprise two peaks having the same height, two sets of peaks having the same spacing, and/or two peaks having the same width. By way of example, with reference to FIG. 6, the height 612BH of the peak 612B has the same value as the height 612DH of the peak 612D. In some embodiments, a plurality of peaks comprises two or more peaks that are similar in one or more ways (e.g., that have the same height, same spacing to a nearest neighbor, and/or same width) and two or more peaks that are different in one or more ways (e.g., that have differing heights, differing spacings from their nearest neighbors, and/or differing widths). With reference again to FIG. 6, the plurality of peaks 612 comprises peaks 612B and 612E having heights 612BH and 612EH with the same value, and also comprises a peak 612D with a height 612DH having a different value than 612DH and 12BH.

It should be understood that an irregular structure may be present at any location within the filter media, but need not be present at all locations. For instance, some filter media may, like the filter media shown in FIG. 6, comprise a first surface that has an irregular structure (e.g., plurality of peaks) and comprise a second surface opposite the first surface that is relatively regular (e.g., flat) in comparison or lacks an irregular structure (e.g., peaks) entirely. Some filter media may, unlike the filter media shown in FIG. 6, include two opposing surfaces, each of which comprises an irregular structure. For instance, some filter media may comprise two opposing surfaces, each of which comprises a plurality of peaks and/or each of which comprises a plurality of peaks that is irregular in one or more ways. In some embodiments, as will be described in more detail below, a filter media comprises a first surface comprising a first plurality of peaks irregular in one or more ways, and a second surface that comprises a second plurality of peaks similar to a plurality of troughs positioned between the peaks in the first plurality of peaks in all ways except for amplitude. The second plurality of peaks may have the same (or substantially similar) position, shape, spacing, and/or width of the plurality of troughs positioned between the peaks in the first plurality of peaks, but may have smaller heights.

Filter media described herein should be understood to comprise an irregular structure if one or more portions thereof (e.g., one or more layers therein, one or more surfaces thereof) comprises an irregular structure. The irregular structure (e.g., plurality of peaks) may be located at one or more surfaces of the filter media, in the interior of the filter media, and/or throughout the filter media. By way of example, a filter media comprising an irregular structure may comprise: a plurality of peaks irregular in one or more ways that is present at one or more surfaces of the filter media; a plurality of peaks that extends through one or more layers of the filter media; and/or a plurality of peaks that is present at one or more surfaces of a layer of the filter media.

It should also be understood that in embodiments in which the irregular structure is not present at an exterior surface of the filter media, the characteristics of the irregular structure may be measured by removing the portions of the filter media that obstruct the irregular structure from measurement and measuring the irregular structure as described above. For instance, in some embodiments, a filter media includes two opposing layers that lack an irregular structure, but comprises a layer positioned between the two opposing layers lacking an irregular structure that comprises an irregular structure (e.g., plurality of peaks irregular in one or more ways). For such filter media, a layer comprising one of the surfaces lacking the irregular structure may be removed so that the irregular structure is exposed, and features of interest of the exposed irregular structure may be measured by optical microscopy as described above.

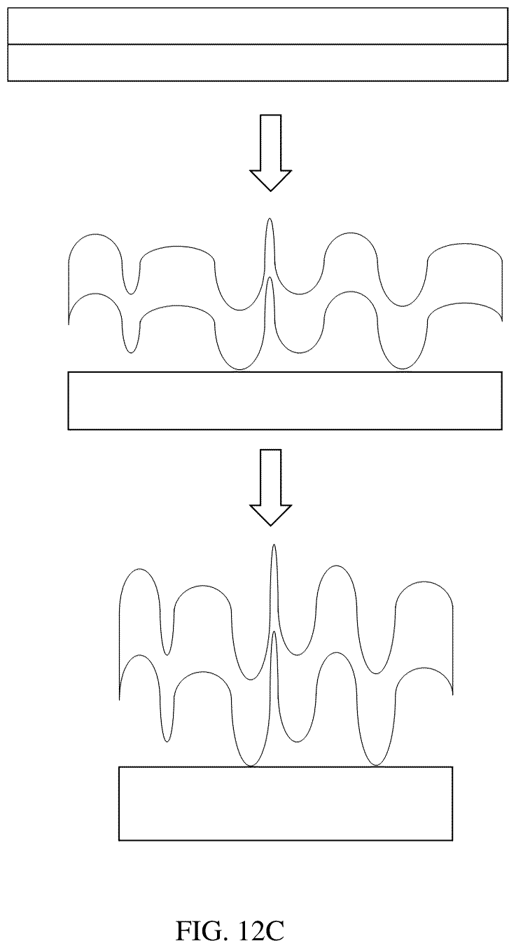

Some layers may be topologically connected throughout the layer and some layers may comprise two or more portions topologically disconnected from each other. For instance, FIG. 9A shows one example of a filter media 902 comprising a first layer 900 that is topologically connected throughout the layer and a second layer 904 that comprises portions (e.g., the portions 916A and 916B) that are topologically disconnected from each other. FIG. 9B shows a perspective view of this same filter media. Although not shown in FIGS. 9A-9B, it is possible for either type of layer to comprise an irregular structure. Additionally, some layers may lack portions that may be removed from the layer without the use of specialized tools and/or without breaking apart the layer, and some layers may comprise such portions.

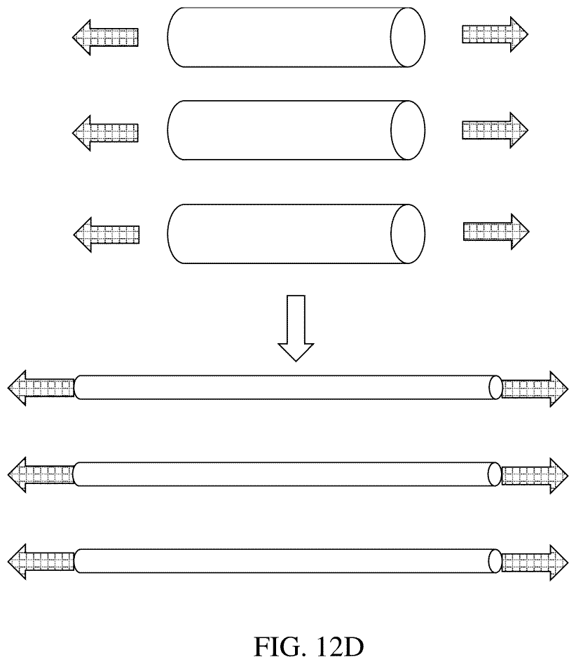

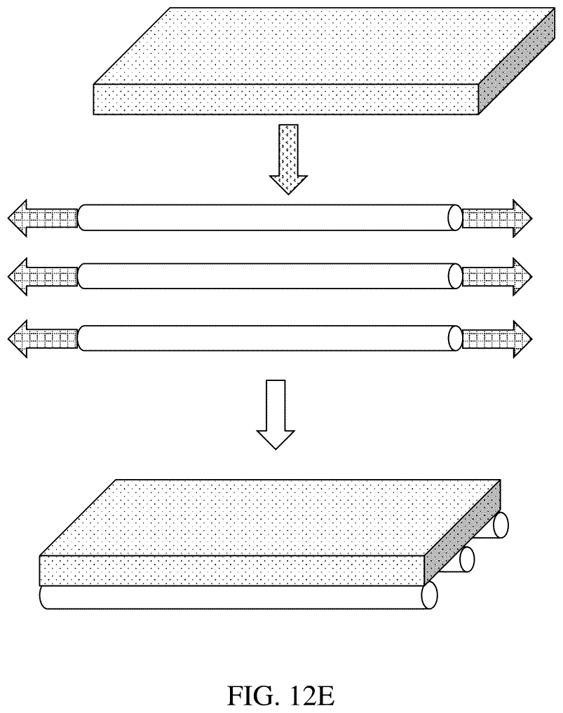

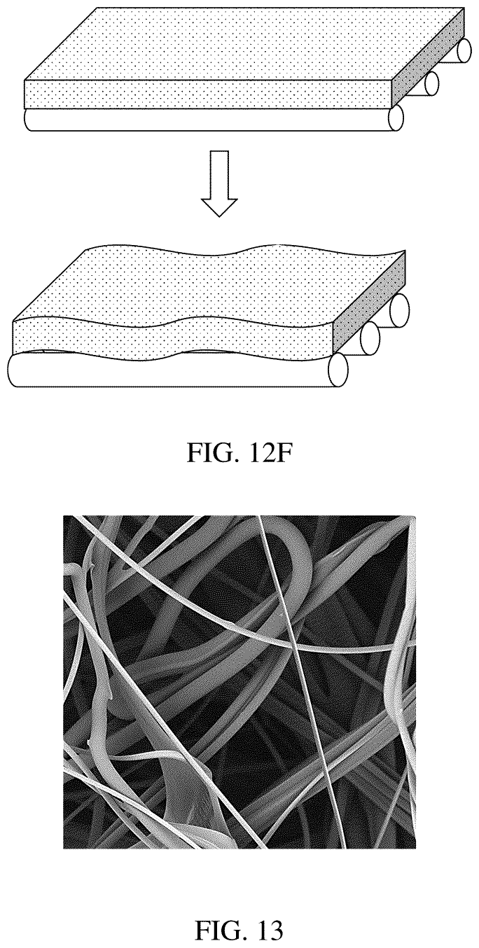

In some embodiments, a layer in the filter media takes the form of a layer for the first time when incorporated into the filter media. In other words, a collection of articles that is not a layer prior to incorporation into the filter media may be considered to form a layer of the filter media after incorporation thereinto. One specific example of such a layer is a plurality of elastically extensible fibers. The plurality of fibers may, prior to incorporation into the filter media, be separate, mechanically-uncoupled fibers. Upon incorporation into the filter media, the elastically extensible fibers may have a common function (e.g., serving as a scrim) and/or may separate two layers (e.g., an efficiency layer and a support layer). FIG. 10 shows one example of a plurality of elastically extensible fibers that form the layer 1004 positioned between the layers 1000 and 1018. Non-limiting examples of suitable layers include non-woven fiber webs, meshes, pluralities of fibers not in direct contact with each other and/or not mechanically coupled to each other, and adhesives adhering together two layers between which it is positioned. For instance, by way of reference to FIG. 6, a filter media 602 may be a single layer filter media. As another example, also by way of reference to FIG. 6, filter media 602 may be a filter media comprising two or more layers. FIG. 11A shows one non-limiting embodiment of a filter media 1102 comprising a first layer 1100 and a second layer 1104. In some embodiments, the filter media may comprise one or more layers comprising an irregular structure. The irregular structure may include an irregular spatial conformation of the layer. For instance, a layer, or portion thereof, may have a non-planar spatial conformation that has one or more irregular characteristics. In some embodiments, the full thickness of the layer, or the full thickness of a portion thereof, may be arranged into three-dimensional peaks and troughs. In such cases, each non-terminal peak is adjacent to a trough and each non-terminal trough is adjacent to a peak. In other words, a layer may have a structure such that each peak on a first side of the layer has a corresponding trough on the opposite side of the layer and each trough on the first side of the layer has a corresponding peak on the opposite side of the layer. A plurality of troughs may be similar in one or more ways to a plurality of peaks to which it corresponds and/or a plurality of peaks may be similar in one or more ways to a plurality of troughs to which it corresponds. For instance, a corresponding pair of troughs and peaks may be positioned in substantially the same location, may have substantially the same peak height, may have substantially the same peak width, may have substantially the same peak shape, and/or may have substantially the same nearest neighbor spacing(s). A layer that that is arranged such that its full thickness is arranged into three-dimensional peaks and troughs may be referred to as a layer comprising a plurality of peaks that extends through the full thickness of the layer and/or as an undulated layer.

One example of an undulated layer is the layer 1100 in FIG. 11A. The layer 1100 in FIG. 11A comprises a plurality of peaks 1112 comprising peaks 1112A, 1112B, 1112C, 1112D, and 1112E separated by troughs 1114A, 1114B, 1114C, and 1114C. The troughs 1114A, 1114B, 1114C, and 1114C together form a plurality of troughs 1114 (not shown). These peaks and troughs are present at the upper side of the layer 1100 (and of the filter media 1102). The plurality of peaks 1112 has a corresponding plurality of troughs 11120 (not shown) comprising troughs 1112AO, 1112BO, 1112CO, 1112DO, and 1112EO on the bottom side of the layer 1110 and the plurality of troughs 1114T (not shown) has a corresponding plurality of peaks 1114TO (not shown) comprising peaks 1114AO, 1114BO, 1114CO, and 1114DO. In some embodiments, when viewed in cross-section, the outline of the top surface of an undulated layer (e.g., the layer 1100) may be substantially the same as the outline of the bottom surface of the undulated layer.

In some embodiments, an undulated layer has a structure indicative of a layer that was not undulated at some point in time and that underwent a process in which it was undulated. Layers that are undulated may comprise portions that are in tension (e.g., upper surfaces of peaks, lower surfaces of troughs positioned between peaks) and/or portions that are in compression (e.g., lower surfaces of peaks, upper surfaces of troughs positioned between peaks). Layers may be undulated by a variety of suitable processes, such as folding, crinkling, gathering, and the like. In some embodiments, thermal shrinkage may be performed to undulate one or more layers. For instance, one or more layers may be disposed on a layer with high thermal shrinkage, and the layer with high thermal shrinkage may be heated, causing it to shrink and causing the one or more layers disposed thereon to become undulated.

In some embodiments, a filter media comprises a layer that does not include an irregular structure. The layer not including the irregular structure may not include any peaks (e.g., it may be relatively flat), or it may include a plurality of peaks that is regular. For instance, like the filter media shown in FIG. 11A, a filter media may comprise one layer including an irregular structure (e.g. plurality of peaks) and one layer that does not include an irregular structure (e.g., peaks). For example, filter media 1102 shown in FIG. 11A comprises a layer 1100 that includes a plurality of peaks (e.g., 1112A, 1112B, 1112C, 1112D, and 1112E) and also comprises a layer 1104 that does not include any peaks. In embodiments in which a layer, such as the layer 1100 shown in FIG. 11A, includes a plurality of peaks, the peaks may have one or more irregular characteristics as described herein.

In some embodiments, a filter media comprises two or more layers comprising an irregular structure (e.g., two or more layers comprising pluralities of peaks irregular in one or more ways) and two or more layers that do not include an irregular structure (e.g., two or more layers lacking peaks or comprising a plurality of peaks with a regular structure). For such embodiments, the layers may be arranged with respect to each other in a variety of suitable manners. For example, two layers that each comprise a plurality of peaks irregular in one or more ways are positioned on opposite sides of a layer that lacks a plurality of peaks irregular in one or more ways. A filter media with this structure may be fabricated by gathering two layers on opposite sides of a reversibly stretchable layer. As another example, two layers that each lack a plurality of peaks irregular in one or more ways may be positioned on opposite sides of a layer comprising a plurality of peaks irregular in one or more ways. For instance, one or more layers comprising a plurality of peaks may be positioned between two outer layers that lack peaks entirely and/or are relatively flat.

In some embodiments, a filter media exclusively comprises layers comprising pluralities of peaks irregular in one or more ways.

Some filter media, like that shown in FIG. 11A, include a single layer that comprises a plurality of peaks. Some filter media include two or more layers that each comprise a plurality of peaks. FIG. 11B shows one non-limiting embodiment of a filter media comprising two layers that each comprise pluralities of peaks. In FIG. 11B, a filter media 1102 comprises a first layer 1100, a second layer 1104, and a third layer 1118. The first layer 1100 and the third layer 1118 each comprise two opposing surfaces. In both the first layer 1100 and the third layer 1118, the first surface comprises a plurality of peaks separated by a plurality of troughs. The surface opposing the first surface in each of these layers comprises a plurality of troughs corresponding to the peaks present in the first surface of the layer and a plurality of peaks corresponding to the troughs present in the first surface of the layer.

In some embodiments, a filter media comprises two or more layers that are undulated together. For instance, in FIG. 11B, the first layer and the third layer are also both undulated layers that are undulated together. In other words, both the first layer and the third layer are undulated, and the first layer comprises a first plurality of peaks that is substantially similar to a second plurality of peaks present in the third layer. With reference to FIG. 11B, the plurality of peaks present in the upper surface of the layer 1100 is substantially similar to the plurality of peaks present in the upper surface of the layer 1118. In some cases in which a first layer and a third layer are undulated together, the plurality of peaks and troughs in the first layer is substantially the same as the third layer. In some embodiments, a filter media comprises two or more layers that are undulated, but which are not undulated together. For instance, a filter media may comprise two layers that are undulated on opposite sides of a layer that is not undulated. As another example, a filter media may comprise a first layer and a second layer that are both undulated and comprise undulations substantially similar in position, but for which the undulations have a substantially different amplitude (e.g., substantially different average peak heights). Some filter media may comprise some layers that are undulated together and some layers that are undulated separately.

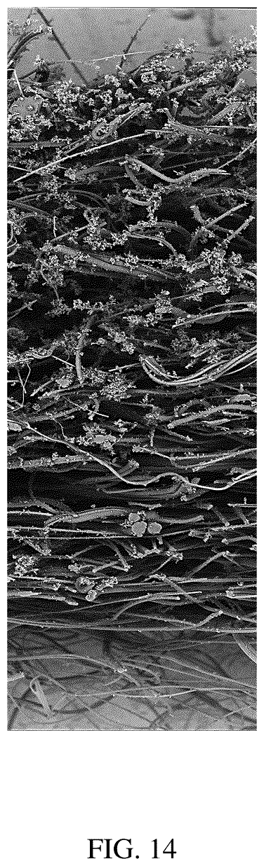

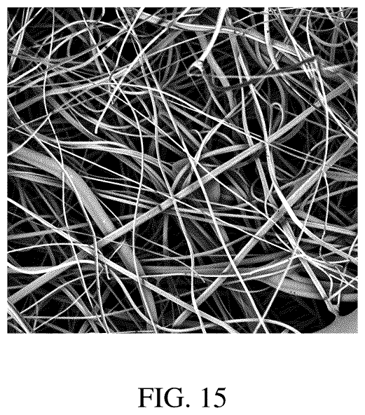

The filter media described herein may be manufactured in a variety of suitable manners. One method of manufacturing filter media that may be particularly advantageous is shown in FIGS. 12A-12C. In this method, a layer with relatively low stiffness is gathered to form a layer that is undulated using a layer capable of undergoing a reversible stretch. The layer capable of undergoing a reversible stretch is stretched, and the layer with the relatively low stiffness is deposited onto the layer capable of undergoing a reversible stretch when in the stretched state (i.e., when it is in the form of a reversibly stretched layer). Then, when the reversibly stretched layer recovers, it pulls the layer with the relatively low stiffness back with it, gathering the layer with the relatively low stiffness. The reversibly stretched layer may recover fully (i.e., to its initial dimensions prior to being stretched) or partially (i.e., to dimensions between its initial dimensions prior to being stretched and its dimensions when in the stretched state). In other words, a layer capable of undergoing a reversible stretch may be stretched in a manner that is entirely reversible or in a manner that is partially reversible and partially irreversible. FIG. 12A shows a possible first step of reversibly stretching a layer capable of undergoing a reversible stretch, such as a scrim, to a stretched state. FIG. 12B shows a possible second step of depositing a layer, such as an efficiency layer, onto the reversibly stretched layer. FIG. 6C shows the recovery of the reversibly stretched layer. During the recovery process, the layer with the relatively low stiffness gathers and forms a plurality of peaks that are irregular in height, spacing, width, and/or shape. The reversibly stretched layer may hold the peaks in position.

In some embodiments, like the embodiment shown in FIGS. 12A-12C, the reversibly stretched layer may be a layer that is topologically connected throughout the layer. Similarly, and also like the embodiment shown in FIGS. 12A-12C, the reversibly stretched layer may take the form of a layer prior to the deposition of any layers thereon. It is also possible for a reversibly stretched layer to comprise portions that are topologically disconnected from each other and/or to not be a layer until one or more further layers are deposited thereon (e.g., like the layer 904 depicted in FIGS. 9A-9B). As one example, in some embodiments, a reversibly stretched layer comprises a plurality of elastically extensible fibers that do not initially form a layer. The elastically extensible fibers may be reversibly stretched (e.g., along their axes). Deposition of one or more layers thereon may cause the elastically extensible fibers to take the form of a scrim that holds the layers deposited thereon in an undulated configuration, transforming the elastically extensible fibers into a layer in the filter media. FIGS. 12D-12F show a schematic depiction of such a process.

In general, any suitable number of layers may be undulated (e.g., by gathering) using a layer capable of undergoing a reversible stretch. In some embodiments, not shown in FIGS. 12A-12C, one or more further layers may be deposited onto the reversibly stretched layer after deposition of a layer with relatively low stiffness thereon. In some embodiments, one or more further layers may be deposited onto the reversibly stretched layer together with a layer having a relatively low stiffness. The further layer or layers may be deposited prior to recovery of the reversibly stretched layer. For instance, a non-woven fiber web comprising nanofibers may be deposited onto a non-woven fiber web having high performance deposited on a reversibly stretched scrim. Then, as shown in FIG. 12C, the reversibly stretched layer may be allowed to recover. Layers deposited on the reversibly stretched layer (e.g., on the layer with the relatively low stiffness and/or together with the layer with the relatively low stiffness) may become undulated (e.g., by gathering) during this step. In some embodiments, like the embodiment shown in FIG. 11B, the layers may be undulated and/or gathered together. After being undulated and/or gathered, the layers may be retained in an undulated and/or gathered configuration by the reversibly stretched layer. The further layer or layers deposited onto the reversibly stretched layer in addition to the layer with the relatively low stiffness may also have a relatively low stiffness, which may promote this advantageous gathering. In some embodiments, one or more further layers may be deposited onto the reversibly stretched layer after recovery of the reversibly stretched layer (e.g., a non-woven fiber web having high performance). In some embodiments, such layers may prevent the reversibly stretched layer from undergoing further reversible stretching.

In some embodiments, like the embodiment shown in FIGS. 12A-12C, a layer to be gathered is deposited directly onto a reversibly stretched layer and the resultant gathered layer and recovered layer are directly adjacent.

In some embodiments, a layer to be gathered is deposited onto a layer or material deposited onto the reversibly stretched layer, and the resultant gathered layer and recovered layer are adjacent but not directly adjacent. For example, a layer to be gathered may be deposited on an adhesive deposited on the reversibly stretched layer, such that the adhesive is positioned between the resultant gathered layer and the recovered layer. In some embodiments in which an adhesive is positioned between the layer to be gathered and the reversibly stretched layer, the adhesive may be deposited onto the reversibly stretched layer prior to stretching and/or after stretching.

For example, an adhesive may be deposited onto a scrim, the scrim may be stretched, and then a further layer may be deposited onto the stretched scrim. In this case, the adhesive is stretched along with the scrim along the direction that the scrim is stretched. The further layer may bond less well to the scrim along the direction the scrim is stretched, and so may detach from the scrim at certain positions along the opposite direction when the scrim is allowed to recover. In such cases, the further layer may be gathered, and the scrim may comprise undulations (or be undulated) that follow the undulations in the further layer. The undulations in the scrim may be much smaller than those in the further layer (i.e., they may have a much smaller average peak height), and so the scrim may be considered to be relatively, but not perfectly, flat in comparison to the further layer.

In one specific embodiment, the above-described process may be performed with a scrim that takes the form of a plurality of elastically extensible fibers. By way of example, in some embodiments, an adhesive is deposited onto the plurality of elastically extensible fibers such that it coats the elastically extensible fibers fully or partially. The former case may comprise depositing adhesive onto the elastically extensible fibers such that it coats the entirety of the circumference of the elastically extensible fibers along at least a portion of their length. The latter case may comprise depositing the adhesive onto the elastically extensible fibers such that some portions thereof, like portions closer to the source of the adhesive and/or onto which further layers will be subsequently deposited.

It is also possible for a reversibly stretched layer to be bonded to another layer by ultrasonic bonding. The reversibly stretchable layer may be reversibly stretched, optionally allowed to recover, and then laminated to another layer deposited thereon. This process may be formed in conjunction with, or instead of, the processes described in the preceding paragraphs for employing an adhesive to adhere together a reversibly stretched layer and a layer deposited thereon. In some embodiments, a layer to which a reversibly stretched layer is bonded via ultrasonic bonding prevents the reversibly stretched layer from undergoing further reversible stretching after recovery.

The processes described in the preceding paragraphs may be performed in a roll-to-roll manner. By way of example, in some embodiments, a reversibly stretchable layer (or a plurality of elastically extensible fibers that form the reversibly stretchable layer upon incorporation into the filter media) is supplied from a roll, a plurality of spools, or an instrument (e.g., a yarn or filament beam) that supplies a plurality of yarn or filament ends. The reversibly stretchable layer or plurality of elastically extensible fibers that form the reversibly stretchable layer upon incorporation into the filter media may then pass beneath a station that applies adhesive thereto, be stretched, and then serve as a substrate onto which a further layer (e.g., a non-woven fiber web having high performance) is deposited. The further layer may be a pre-existing layer that is wound around a roll and deposited therefrom or may be a layer that is formed on the reversibly stretched layer (e.g., from a solution or melt). The two layers joined together by the adhesive may be joined with further layers (which may, themselves, be supplied from further rolls). These further layers may be deposited when the reversibly stretched layer is in a reversibly stretched state and/or when the reversibly stretched layer is in a recovered state. It is also possible for the two layers joined together by the adhesive to pass through further stations at which further processes are performed. Such processes may include bonding (e.g., via ultrasonic horn and/or calender), lamination (e.g., thermal, chemical, and/or mechanical), pleating, and/or charging. One or more of these processes may cause the reversibly stretched layer to become bonded and/or mechanically coupled to another layer (e.g., a scrim, such as a second scrim) such that it is incapable of undergoing further reversible stretching. After fabrication, the final filter media may be wound around a final roll.

When a reversibly stretched layer is stretched, the direction of stretch may generally be selected as desired. In some embodiments, a reversibly stretched layer may be stretched in a machine direction. In some embodiments, a reversibly stretched layer may be stretched in a cross direction. When stretched, the reversibly stretched layer may be stretched to a variety of suitable lengths. The reversibly stretched layer may be stretched to a length of greater than or equal to 50%, greater than or equal to 75%, greater than or equal to 100%, greater than or equal to 125%, greater than or equal to 150%, greater than or equal to 175%, greater than or equal to 200%, greater than or equal to 225%, greater than or equal to 250%, greater than or equal to 275%, greater than or equal to 300%, greater than or equal to 325%, greater than or equal to 350%, greater than or equal to 375%, greater than or equal to 400%, greater than or equal to 450%, greater than or equal to 500%, greater than or equal to 600%, or greater than or equal to 800% of its initial length. In some embodiments, the reversibly stretched layer is stretched to a length of less than or equal to 1000%, less than or equal to 800%, less than or equal to 600%, less than or equal to 500%, less than or equal to 450%, less than or equal to 400%, less than or equal to 375%, less than or equal to 350%, less than or equal to 325%, less than or equal to 300%, less than or equal to 275%, less than or equal to 250%, less than or equal to 225%, less than or equal to 200%, less than or equal to 175%, less than or equal to 150%, less than or equal to 125%, less than or equal to 100%, or less than or equal to 75% of its initial length. Combinations of the above-referenced ranges are also possible (e.g., greater than or equal to 50% and less than or equal to 1000%, greater than or equal to 100% and less than or equal to 400%, or greater than or equal to 200% and less than or equal to 300%). Other ranges are also possible. Layer(s) deposited on a reversibly stretched layer in a reversibly stretched state may recover with the reversibly stretched layer to a recovered length, undergoing a reduction in length. The reduction in length may be equivalent to the corresponding reduction in length experienced by the reversibly stretched layer upon recovery. When the reversibly stretched layer exhibits substantially complete recovery, the reduction in length of the layer(s) may fall within one or more ranges that may be derived from the ranges above by the following formula:

Percent reduction in length=(1−100/(100+percent stretch))*100%.

For instance, a layer deposited on a reversibly stretched layer stretched to 50% of its initial length that fully recovers would have a corresponding reduction in length of 33% of its initial length. As another example, a layer deposited on a reversibly stretched layer stretched to 1000% of its initial length that fully recovers would have a corresponding reduction in length of 91% of its initial length.

The filter media described herein may be employed in a variety of suitable applications. In some embodiments, a filter media described herein is employed in an air filter, non-limiting examples of which include indoor air filters, cabin air filters, air filters for medical applications, fan coil unit filters, ULPA filters, HEPA filters, cabin air filters, and HVAC filters.

In some embodiments, the filter media described herein is a component of a filter element. That is, the filter media may be incorporated into an article suitable for use by an end user.

Non-limiting examples of suitable filter elements include flat panel filters, wire back panel filters, cartridge filters, pleated panel filters, pocket filters, mini pleat filters, V-bank filters (comprising, e.g., between 1 and 24 Vs), thermally molded filters, cylindrical filters, conical filters, channel flow filters, and radial seal filters. Channel flow filters may comprise alternating rows of flat filter media and corrugated filter media. In some embodiments, these alternating rows may surround a honeycomb network of channels. In some embodiments, a channel flow filter may comprise some channels that are sealed with an adhesive (e.g., the channel flow filter may comprise alternating sealed and unsealed channels). In use, air may flow into open channels in a channel flow filter, through the filter element, and then out an adjacent open channel.

Filter elements may have a variety of suitable shapes, such as round, oval, cubic, and/or prismatic. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein is a component of a filter element and is pleated. As described above, in some embodiments, a filter media described herein may be a component of a filter element and may be pleated. Without wishing to be bound by any particular theory, it is believed that pleating a filter media advantageously increases the surface area thereof in a manner proportional to the number of pleats present. This increased surface area may enhance the filtration efficiency of the filter media. Some pleated filter media may comprise two or more layers that were joined by a co-pleating process. Pleating may be accomplished by forming score lines at appropriately spaced distances apart from one another, allowing the filter media to be folded.

The pleat height and pleat density (number of pleats per unit length of the filter media) may be selected as desired. In some embodiments, the pleat height is greater than or equal to 3 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 15 mm, less than or equal to 10 mm, or less than or equal to 5 mm. Combinations of the above-referenced ranges are also possible (e.g., greater than or equal to 3 mm and less than or equal to 510 mm, greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in.

In some embodiments, pleats are separated by a pleat separator made of, e.g., polymer, glass, aluminum, and/or cotton. In other embodiments, the filter element lacks a pleat separator. When present, the pleat separator may be positioned on an upstream surface of the filter media and/or may be positioned on a downstream surface of the filter media. The pleat separator may comprise portions that separate the pleats and have a width (i.e., in the direction separating the pleats) of greater than or equal to ½ in, greater than or equal to 1 in, greater than or equal to 1.5 in, greater than or equal to 2 in, greater than or equal to 2.5 in, greater than or equal to 3 in, greater than or equal to 3.5 in, or greater than or equal to 4 in. In some embodiments, a pleat separator comprises portions that separate the pleats and have a width of less than or equal to 5 in, less than or equal to 4 in, less than or equal to 3.5 in, less than or equal to 3 in, less than or equal to 2.5 in, less than or equal to 2 in, less than or equal to 1.5 in, or less than or equal to 1 in. Combinations of the above-referenced ranges are also possible (e.g., greater than or equal to 3 in and less than or equal to 2 in, greater than or equal to 2 in and less than or equal to 1 in). In some embodiments, a filter media comprises one or more additional structural elements. For instance, a filter media may further comprise a stiffening element, such as a polymeric mesh and/or a metallic mesh. As another example, a filter media may further comprise a screen backing, which may assist with retaining the filter media in a pleated configuration. Such filter media may be wire-backed (e.g., by an expanded metal wire) and/or comprise an extruded plastic mesh. It is also possible for filter media to be self-supporting.

### Example 1

This Example compares a variety of properties of several charged meltblown non-woven fiber webs comprising polypropylene fibers. Selected features of these non-woven fiber webs are listed below in Tables 5-8. As can be seen from these Tables, many of the non-woven fiber webs exhibited desirable ratios of dust holding capacity to basis weight, ratios of dust holding capacity to initial air resistance, and/or gamma.

TABLE 5

| | Basis | Thick- | Average Fiber | | Mean Flow |
|---|---|---|---|---|---|
| Sample | Weight | ness | Diameter | Solidity | Pore Size |
| No. | (gsm) | (mils) | (microns) | (%) | (microns) |
| 1 | 14 | 6 | 4.6 | 3 | 49 |
| 2 | 15 | 6 | 4.1 | 5.1 | 35 |
| 3 | 18 | 6.7 | 3.9 | 5.5 | 29 |
| 4 | 28 | 9.5 | 3.7 | 5.6 | 29 |
| 5 | 47 | 15.5 | 3.8 | 5 | 28 |
| 6 | 30 | 15 | 7.1 | 3.2 | 75.9 |
| 7 | 40 | 22 | 8.4 | 3.6 | 59.6 |
| 8 | 50 | 25 | 6.4 | 3.7 | 60 |
| 9 | 60 | 27 | 5.9 | 4.2 | 50.3 |
| 10 | 15 | 5 | 2.9 | 6.7 | 15.3 |
| 11 | 23 | 8 | 2.6 | 6.2 | 15 |
| 12 | 42 | 15 | 2.2 | 6.3 | 10.9 |

TABLE 6

| | | | | Ratio of Dust |
|---|---|---|---|---|
| | | Dust | Ratio of Dust | Holding Capacity |
| | Initial Air | Holding | Holding Capacity | to Initial Air |
| Sample | resistance | Capacity | to Basis Weight | Resistance*100 |
| No. | (Pa) | (gsm) | (gsm/gsm) | (gsm/Pa) |
| 1 | 10.2 | 26.3 | 1.88 | 258 |
| 2 | 11.5 | 18.5 | 1.23 | 161 |
| 3 | 29 | 16.7 | 0.93 | 58 |
| 4 | 43.8 | 17.2 | 0.61 | 39 |
| 5 | 61.2 | 21.9 | 0.47 | 36 |
| 6 | 6.2 | 68.6 | 2.29 | 1108 |
| 7 | 11.7 | 67.2 | 1.68 | 574 |
| 8 | 15.4 | 59.1 | 1.18 | 384 |
| 9 | 21.8 | 52.3 | 0.87 | 240 |
| 10 | 53.4 | 12.6 | 0.84 | 24 |
| 11 | 75.3 | 12.2 | 0.53 | 16 |

TABLE 7

| | Initial Air Resistance | Initial Penetration | |
|---|---|---|---|
| Sample | Measured Concurrently | Measured Concurrently | |
| No. | with Gamma (mm H₂O) | with Gamma (%) | Gamma |
| 1 | 0.13 | 28.1 | 367 |
| 2 | 0.32 | 16.9 | 244 |
| 3 | 0.44 | 9.7 | 228 |
| 4 | 0.825 | 1.9 | 209 |
| 5 | 1.28 | 0.2 | 221 |
| 6 | 0.1 | 29.6 | 529 |
| 7 | 0.18 | 16.5 | 435 |
| 8 | 0.33 | 5.7 | 376 |
| 9 | 0.46 | 2.7 | 342 |
| 10 | 1 | 2.8 | 155 |
| 11 | 1.85 | 0.2 | 146 |
| 12 | 4.3 | 0.006 | 98 |

TABLE 8

| | Initial Air | Air | Ratio of Air |
|---|---|---|---|
| | Resistance Measured | Resistance | Resistance after |
| | at Beginning of | after NaCl | NaCl Loading to Air |
| Sample | NaCl Loading Process | Loading | Resistance Prior |
| No. | (mm H₂O) | (mm H₂O) | to NaCl Loading |
| 1 | 0.6 | 1.3 | 2 |
| 2 | 1.1 | 7.1 | 6 |
| 3 | 1.7 | 14.6 | 8 |
| 4 | 2.8 | 21.1 | 7 |
| 5 | 4.3 | 18.8 | 4 |
| 6 | 0.6 | 0.9 | 1.5 |
| 7 | 0.9 | 1.2 | 1.3 |
| 8 | 1.7 | 2.9 | 1.7 |
| 9 | 2.4 | 4.5 | 1.9 |
| 10 | 3.9 | 152.3 | 39 |
| 11 | 5.7 | 125 | 21 |
| 12 | 11.3 | 72.5 | 6.4 |

### Example 2

This Example compares NaCl distribution in Sample Nos. 5 and 12 described in Example 1.

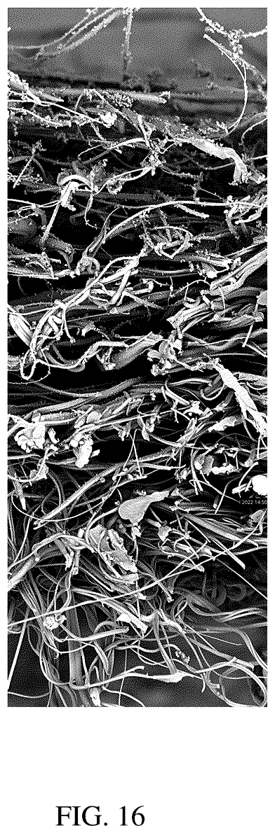

Both non-woven fiber webs were imaged using SEM, underwent an NaCl loading process as described above, and then imaged again using SEM. FIG. 13 shows Sample No. 5 before NaCl loading and FIG. 14 shows this same non-woven fiber web after NaCl loading. As can be appreciated from these Figures, the NaCl was captured throughout the thickness of the web. FIGS. 15 and 16 show SEM images for Sample No. 12 before and after NaCl loading, respectively. These Figures show that the upstream portion of Sample No. 12 captured most of the NaCl and that very little NaCl was captured in the downstream portion.

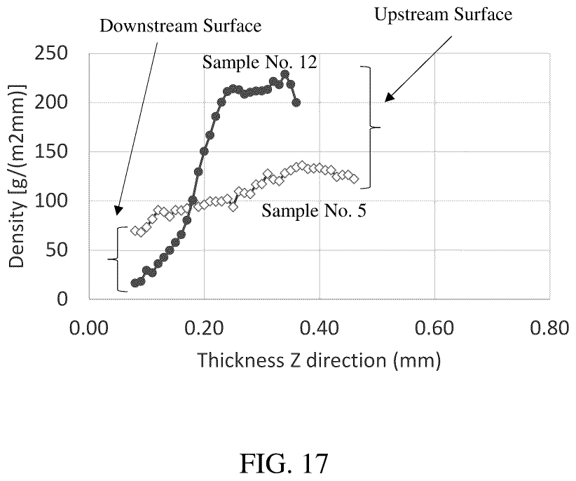

FIG. 17 is a chart showing NaCl density for each of these two non-woven fiber webs after NaCl loading. As can be seen from FIG. 17, the NaCl density was much more uniform in Sample No. 5 than for Sample No. 12.

### Example 3

This Example compares the compaction resistance for exemplary non-woven fiber webs having high performance to the compaction resistance for control non-woven fiber webs having a ratio of dust holding capacity to basis weight of less than 1 gsm/gsm.

Test samples were obtained from three different locations in finished rolls of Sample Nos. 6, 7, 10, and 11 and compared to each other. The finished rolls had been wound around a 3 inch diameter core and had an outer diameter of at least 12 inches. The test samples were obtained from the external surfaces of the finished rolls, portions of the finished rolls midway between its external surface and the core, and portions of the finished roll directly adjacent the core. The test samples interior to the finished rolls were subject to some compressive stress during roll formation and storage, and all samples were allowed to expand until they reached an equilibrium thickness prior to measurement. Tables 9 and 10, below, show the air permeability, air resistance, penetration, gamma, and reduction in air permeability after compaction for both types of non-woven fiber webs. As can be seen from Tables 9 and 10, the non-woven fiber web having high performance exhibited a higher air permeability, lower resistance, higher value of gamma, and lower reduction in air permeability than the control non-woven fiber web.

TABLE 9

| | | | | Air Resistance | | | Air |
|---|---|---|---|---|---|---|---|
| | | | | (mm H₂O; | | | Permeability |
| | | Location | | Measured | | | Decrease |
| | Basis | in | Air | Concurrently | | | Upon |
| Sample | Weight | Finished | permeability | with | Penetration | | Compaction |
| No. | (gsm) | Roll | (CFM) | Penetration) | (%) | Gamma | (%) |
| 10 | 15 | External | 117 | 1.2 | 1.26 | 158 | |
| | | Surface | | | | | |
| | | Middle | 102 | 1.37 | 1.32 | 137 | |
| | | Directly | 88 | 1.63 | 1.37 | 114 | 25 |
| | | Adjacent | | | | | |
| | | Core | | | | | |
| 11 | 23 | External | 71 | 1.91 | 0.23 | 138 | |
| | | Surface | | | | | |
| | | Middle | 61 | 2.18 | 0.24 | 120 | |
| | | Directly | 50 | 2.61 | 0.23 | 101 | 30 |
| | | Adjacent | | | | | |
| | | Core | | | | | |

TABLE 10

| | | | | Air Resistance | | | Air |
|---|---|---|---|---|---|---|---|
| | | | | (mm H₂O; | | | Permeability |
| | | Location | | Measured | | | Decrease |
| | Basis | in | Air | Concurrently | | | Upon |
| Sample | Weight | Finished | permeability | with | Penetration | | Compaction |
| No. | (gsm) | Roll | (CFM) | Penetration) | (%) | Gamma | (%) |
| 6 | 30 | External | 639 | 0.23 | 28.9 | 237 | |
| | | Surface | | | | | |
| | | Middle | 646 | 0.26 | 28.2 | 208 | |
| | | Directly | 655 | 0.28 | 27.7 | 198 | 0 |
| | | Adjacent | | | | | |
| | | Core | | | | | |
| 7 | 40 | External | 413 | 0.34 | 15 | 245 | |
| | | Surface | | | | | |
| | | Middle | 401 | 0.36 | 17 | 215 | |
| | | Directly | 381 | 0.39 | 15.2 | 209 | 8 |
| | | Adjacent | | | | | |
| | | Core | | | | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying.” “having.” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A filter media, comprising:
a non-woven fiber web comprising fibers, wherein:
polypropylene makes up at least 75 wt % of the polymers in the non-woven fiber web;
the fibers in the non-woven fiber web have an average diameter of less than or equal to 15 microns;
the non-woven fiber web has a gamma of greater than or equal to 200;
a ratio of the dust holding capacity of the filter media to a basis weight of the filter media is greater than or equal to 1 gsm/gsm; and
the non-woven fiber web has a thickness of greater than 6 mils.

2. A filter media, comprising:
a non-woven fiber web comprising fibers, wherein:
polypropylene makes up at least 75 wt % of the polymers in the non-woven fiber web;
the fibers in the non-woven fiber web have an average diameter of less than or equal to 15 microns;
the non-woven fiber web has a gamma of greater than or equal to 200; and
the non-woven fiber web is configured such that, after undergoing a NaCl loading process, a density of NaCl at a downstream surface of the non-woven fiber web is greater than or equal to 50% of a density of NaCl at an upstream surface of the non-woven fiber web.

3. A filter media as in claim 1, wherein the filter media further comprises a charged layer comprising non-continuous fibers.

4-9. (canceled)

10. A filter media as in claim 1, wherein the filter media further comprises a non-woven fiber web comprising nanofibers.

11. A filter media as in claim 10, wherein the nanofibers have an average diameter of less than or equal to 300 nm.

12. A filter media as in claim 1, wherein the filter media further comprises a second non-woven fiber web also comprising fibers comprising polypropylene.

13. A filter media as in claim 12, wherein the fibers in the second non-woven fiber web have an average diameter that is less than the average diameter of the fibers in the non-woven fiber web.

14. A filter media as in claim 12, wherein the fibers in the second non-woven fiber web have an average diameter of less than or equal to 5 microns.

15. A filter media as in claim 1, wherein the non-woven fiber web is meltblown.

16. A filter media as in claim 12, wherein the second non-woven fiber web is meltblown.

17. A filter media as in claim 1, wherein the filter media further comprises a backer.

18. A filter media as in claim 17, wherein the backer has an air permeability of greater than or equal to 200 CFM.

19. A filter media as in claim 17, wherein the backer has a stiffness of greater than or equal to 300 mg.

20-23. (canceled)

24. A filter media as in claim 1, wherein the non-woven fiber web has a mean flow pore size of greater than or equal to 20 microns.

25. A filter media as in claim 1, wherein the non-woven fiber web has an air permeability of greater than or equal to 20 CFM and less than or equal to 1300 CFM.

26. (canceled)

27. A filter media as in claim 1, wherein the polypropylene has a melt flow rate of less than or equal to 2000.

28. A filter media as in claim 1, wherein the non-woven fiber web is hydrocharged.

29. A filter media as in claim 1, wherein the fibers in the non-woven fiber web have an average diameter of greater than or equal to 3 microns.

30. A filter media as in claim 1, wherein the non-woven fiber web has a solidity of less than or equal to 6%.

31. A filter media as in claim 1, wherein the non-woven fiber web has a dust holding capacity of greater than or equal to 20 gsm.
